(19) United States
(12) Patent Application Publication
(10) Pub. No.: US 2026/0049518 A1
(43) Pub. Date: Feb. 19, 2026

(54) FENESTRATION UNIT WITH INSTALLATION FEATURES AND ASSOCIATED METHODS

(71) Applicant: Pella Corporation, Pella, IA (US)

(72) Inventors: Todd A. Bernhagen, Pella, IA (US); Jaime P. Ogbourne, Knoxville, IA (US); Jake Baier, Pella, IA (US)

(73) Assignee: Pella Corporation, Pella, IA (US)

(21) Appl. No.: 19/300,190

(22) Filed: Aug. 14, 2025

Related U.S. Application Data
(60) Provisional application No. 63/684,018, filed on Aug. 16, 2024.

(51) Int. Cl. E06B 1/60; E06B 3/46

(52) U.S. Cl. CPC E06B 1/6015; E06B 3/4636

(57) ABSTRACT

Installation systems and methods for fenestration units configured to be set into a rough opening from interior side of a building structure or wall. The fenestration units may include a frame having a perimeter including a first jamb, a second jamb, a frame head defining a first channel along a length of the frame head, a lower rail. The fenestration may further include at least one anchoring clip including a first anchoring clip coupled to the perimeter of the frame at the first channel. The first anchoring clip may include a coupling bracket having a first leg and a second leg, and a carrier bracket configured to receive a portion of the first leg, the coupling bracket defining at least one non-penetrating feature configured to be received by the first channel to couple the first anchoring clip to the perimeter of the frame.

### CROSS-REFERENCE TO RELATED APPLICATION

This application claims the benefit of priority to U.S. Provisional Application No. 63/684,018, filed Aug. 16, 2024, which is hereby incorporated herein by reference in its entirety for all purposes.

### BACKGROUND

Sliding patio doors typically have an exterior nailing flange and are installed from the exterior side of a rough opening of a building. Two or more installers work together on the interior and the exterior of the building to install the sliding patio door into the rough opening. In this process, the installers may need to support at least part of the weight of the sliding patio door to stabilize it within the rough opening framing of the building during installation steps.

### Background Patents

| Patent Number | Title | Filing Date |
|---|---|---|
| U.S. Pat. No. 8,621,795 | Fenestration frame with bonded support | 2011 Apr. 20 |
| | brackets . . . | |
| U.S. Pat. No. 7,162,841 | Spring clip and method of window | 2004 Feb. 13 |
| | installation | |
| DE 2020 16101375 | Supporting and fastening | 2016 Mar. 11 |
| | window . . . to . . . wall opening | |
| WO 2015/142201 | Mounting, sealing and thermal insulation | 2014 Sep. 5 |
| | of windows . . . | |
| U.S. Pat. No. 6,293,061 | System and method for installing a jamb | 1999 Sep. 30 |
| U.S. Pat. No. 11,332,946 | Installation features for fenestration | 2019 Jul. 25 |
| | units . . . | |
| U.S. Pat. No. 8,006,445 | Self-sealing window installation and | 2008 Jan. 15 |
| | method | |
| U.S. 2008/0127564 | Pre-hung door assembly and method of | 2008 Jan. 18 |
| | installation | |
| U.S. Pat. No. 10,895,099 | Support bracket for window | 2016 Aug. 23 |
| | installation . . . | |
| U.S. Pat. No. 10,794,069 | Door Hanger Bracket | 2018 Sep. 21 |
| U.S. RE45,355 | Door Hanger | 2012 Nov. 19 |

### Background Products

Innotech Windows & Doors, Strap Anchors
https://www.innotech-windows.com/blog/in-depth-benefits-of-anchoring-method-window-installation
FrontLine Tru-Loc™ Brackets
https://frontlinebldg.com/all-products/accessories/tru-loc-window-door-installation-anchor/Amesbury
Hinged Fin
https://www.amesburytruth.com/products/extrusions/nailing-fin/hinged/hinged-pp 1,219
EZ-Hang™ Brackets
https://ezhangdoor.com/

### SUMMARY

The fenestration unit includes an anchoring clip system that may be used to hold and stabilize the fenestration unit within a rough opening framing during installation of the fenestration unit. In some embodiments, the anchoring clip system may be adjustable to accommodate a variety of wall construction depths (e.g., accommodating drywall, foam insulation, sheeting, and/or jamb extensions). The anchoring clip system may provide a means to accurately gauge against the rough opening framing during installation of the fenestration unit.

### Anchoring Clip System

According to one embodiment (“Embodiment 1”), a fenestration unit having an interior side and an exterior side that is configured for installation in an opening in a structure defined by a rough opening framing includes a frame having a perimeter including a first jamb, a second jamb, a frame head defining a first channel along a length of the frame head, and a lower rail. The fenestration unit further includes at least one anchoring clip including a first anchoring clip coupled to the perimeter of the frame at the first channel. The first anchoring clip includes a coupling bracket having a first leg and a second leg and a carrier bracket configured to receive a portion of the first leg. The coupling bracket defines at least one non-penetrating feature configured to be received by the first channel to couple the first anchoring clip to the perimeter of the frame.

According to another embodiment (“Embodiment 2”), further to Embodiment

1, the at least one non-penetrating feature is a hook, and optionally the hook includes a first hook and a second hook defined on opposing sides of the carrier bracket, and optionally the hook includes a curved end configured to be received within the first channel.

According to another embodiment (“Embodiment 3”), further to Embodiment

1, the first leg and the second leg extend at an angle to one another and, optionally, substantially orthogonal to one another.

According to another embodiment (“Embodiment 4”), further to Embodiment

1, the frame head defines a second channel along the length of the frame head and the first anchoring clip is configured to receive one or more fasteners to couple the first anchoring clip to the frame at the second channel.

According to another embodiment (“Embodiment 5”), further to Embodiment 4, the second channel is defined by a thermal break formed of a lower thermal conductivity material that is positioned between adjacent frame pieces formed of a relatively higher thermal conductivity material.

According to another embodiment (“Embodiment 6”), further to Embodiment 4, the thermal break defines a body, and the body defines a receiving pocket to engage a portion of the one or more fasteners.

According to another embodiment (“Embodiment 7”), further to Embodiment 4, the one or more fasteners includes a non-penetrating fastener, optionally including a pivotable interlocking cam.

According to another embodiment (“Embodiment 8”), further to Embodiment 1, the first anchoring clip is transitionable between a stowed configuration and an installation configuration. In the installation configuration, the second leg extends outwardly from the perimeter of the frame to engage the rough opening framing.

According to another embodiment (“Embodiment 9”), further to Embodiment 8, the second leg includes at least one aperture configured to receive a fastener for securing the second leg to the rough opening framing when the first anchoring clip is in the installation configuration.

According to another embodiment (“Embodiment 10”), further to Embodiment 9, the second leg is configured to be coupled to an interior face of the rough opening framing.

According to another embodiment (“Embodiment 11”), further to Embodiment 8, the first anchoring clip is configured to be gauged to a wall depth of the rough opening framing that is one of a 2×4 wall depth, a 2×6 wall depth, or a 2×8 wall depth.

According to another embodiment (“Embodiment 12”), further to Embodiment 1, the fenestration unit includes one of a sliding door, a bi-fold door, and a multi-slide door.

According to one embodiment (“Embodiment 13”), a fenestration unit having an interior side and an exterior side that is configured for installation in an opening in a structure defined by a rough opening framing includes a frame having a perimeter including a first jamb, a second jamb, a frame head defining a first accessory groove along a length of the frame head, and a lower rail. The fenestration unit further includes at least one anchoring clip including a coupling bracket, a first leg defining a hook configured to be received by the first accessory groove to couple the coupling bracket to the perimeter of the frame and a second leg angularly offset from the first leg and configured to engage the rough opening framing.

According to another embodiment (“Embodiment 14”), further to Embodiment 13, the frame defines a second accessory groove along the length of the frame head and the coupling bracket is configured to receive one or more fasteners to couple the coupling bracket to the frame at the second accessory groove.

According to another embodiment (“Embodiment 15”), further to Embodiment 14, the coupling bracket defines a first aperture, the first aperture having a first end, a second end, and a relatively wide portion therebetween, and the one or more fasteners is configured to be received within the first aperture.

According to another embodiment (“Embodiment 16”), further to Embodiment 14, the second accessory groove is defined by a thermal break.

According to another embodiment (“Embodiment 17”), further to Embodiment 16, the thermal break defines a body, and the body defines a receiving pocket to cover a portion of the one or more fasteners from view through a glazing of the fenestration unit.

According to another embodiment (“Embodiment 18”), further to Embodiment 17, the frame defines a third accessory groove along the length of the frame head, wherein the coupling bracket defines one or more catches that are configured to be received within a portion of the third accessory groove.

According to one embodiment (“Embodiment 19”), a method of installing an anchoring clip onto a fenestration unit having a frame defining a perimeter and including at least a frame head. The method includes engaging a hook of an anchoring clip with a first accessory groove defined along a length of the frame head of a frame of the fenestration unit; pivoting the anchoring clip downward toward the perimeter of the frame in a cantilever action such that one or more catches of the anchoring clip engage a third accessory groove defined along the length of the frame head of the frame; aligning a first aperture of the anchoring clip with a second accessory groove defined along the length of the frame head; and coupling the anchoring clip to frame at the second accessory groove via one or more fasteners.

According to another embodiment (“Embodiment 20”), further to Embodiment 19, the first aperture of the anchoring clip is defined by a first end, a second end, and a relatively wide portion therebetween and the method further includes inserting the one or more fasteners within the relatively wide portion and sliding the anchoring clip laterally such that the one or more fasteners is received with one of the first end and the second end.

According to another embodiment (“Embodiment 21”), further to Embodiment 20, the method further includes tightening the one or more fasteners.

According to another embodiment (“Embodiment 22”), further to Embodiment 19, the method further includes adjusting a position of the anchoring clip by laterally sliding the anchoring clip along the perimeter of frame.

According to one embodiment (“Embodiment 23”), a method of installing an anchoring clip onto a fenestration unit having a frame including at least a frame head includes engaging a hook of an anchoring clip with a first accessory groove defined along a length of the frame head of a frame; pivoting the anchoring clip downward toward the perimeter of the frame in a cantilever action such that one or more fastener apertures defined by the anchoring clips are aligned with a second accessory groove of the frame; and transitioning the anchoring clip to a locked configuration to couple the anchoring clip to the frame at the second accessory groove.

According to another embodiment (“Embodiment 24”), further to Embodiment 23, the method further includes adjusting a position of the anchoring clip by laterally sliding the anchoring clip along the perimeter of frame.

According to another embodiment (“Embodiment 25”), further to Embodiment 23, the one or more fasteners are non-penetrating fasteners and inserting the one or fasteners includes inserting the one or more fasteners within a portion of the second accessory groove.

### Weather Seal System

According to one embodiment (Embodiment 1), a fenestration unit has an interior side and an exterior side. The fenestration unit includes a frame having a perimeter defining a front and a back opposite the front, a top side, a first side, a second side opposite the first side, the top side and the first side intersecting to define a first corner and the top side and the second side intersecting to define a second corner and a weather seal system secured to the perimeter of the frame.

The weather seal system includes a fin assembly including a top fin coupled to the top side of the frame, the top fin having a first side and a second side, a coupling portion coupled to the top of the frame, a projection portion, and a hinge portion between the coupling portion and the projection portion, the top fin being transitionable from a stowed configuration in which the projection portion projects in a direction of the front of the frame and a deployed configuration in which the projection portion projects outward relative to the frame, the top fin being releasably retained in the stowed configuration, a first corner bridge seal coupled to the projection portion of the top fin at the first side of the top fin and positioned at the first corner, and a second corner bridge seal coupled to the projection portion of the top fin at the second side of the top fin and positioned at the second corner.

According to another embodiment (“Embodiment 2”), further to Embodiment 1, the fin assembly further includes a first side fin coupled to the first side of the frame and a second side fin coupled to the second side of the frame, the first corner bridge seal being coupled to the first side fin and the second corner bridge seal being coupled to the second side fin.

According to another embodiment (“Embodiment 3”), further to Embodiment 2, the first corner bridge seal overlaps with the first side fin and the top fin and the second corner bridge seal overlaps with the second side fin and the top fin to define a continuous water barrier extending about the perimeter of the frame along the first side, the top side, and the second side.

According to another embodiment (“Embodiment 4”), further to Embodiment 1, the first corner bridge seal and the second corner bridge seal are bonded with the top fin to form a single unit.

According to another embodiment (“Embodiment 5”), further to Embodiment 1, the first corner bridge seal includes an elastomer.

According to another embodiment (“Embodiment 6”), further to Embodiment 5, the first corner bridge seal includes a thermoplastic elastomer.

According to another embodiment (“Embodiment 7”), further to Embodiment 1, the first corner bridge seal includes a corner portion and a hood portion formed as a flat web extending in an orthogonal plane from the corner portion.

According to another embodiment (“Embodiment 8”), further to Embodiment 7, the hood portion is substantially flexible and is releasably folded toward the corner portion.

According to another embodiment (“Embodiment 9”), further to Embodiment 8, the first corner bridge seal is folded such that the first corner bridge seal does not project substantially outwardly from the perimeter of the frame.

According to another embodiment (“Embodiment 10”), further to Embodiment 1, the fenestration unit further comprises a retaining assembly releasably securing the fin assembly in the stowed configuration.

According to another embodiment (“Embodiment 11”), further to Embodiment 1, the fin assembly is releasably secured in the stowed configuration via adhesive.

According to another embodiment (“Embodiment 12”), further to Embodiment 1, the coupling portion is coupled to the perimeter of the frame and the projection portion is biased to transition from the first, folded configuration to the second, projecting configuration.

According to another embodiment (“Embodiment 13”), further to Embodiment 1, the top fin is folded at the hinge portion into the first, folded configuration.

According to another embodiment (“Embodiment 14”), further to Embodiment 1, the projection portion is biased to project radially outward from the perimeter of the frame by the hinge portion, and the first corner bridge seal overlaps with the hinge portion, the coupling portion and the projection portion of the top fin.

According to one embodiment (“Embodiment 15”), a fenestration unit has an interior side and an exterior side. The fenestration unit comprises a frame having a perimeter defining a top side, a first side, a second side opposite the first side, a bottom side opposite the top side, a front, and a back opposite the front of the frame, the top side and the first side intersecting to define a first corner and the top side and the second side intersecting to define a second corner and a weather seal system secured to the perimeter of the frame. The weather seal system includes a fin assembly including a top fin coupled to the top side of the frame; a first side fin coupled to the first side of the frame; and a first corner bridge seal coupled to a portion of the top fin, the first corner bridge seal positioned at the first corner. The fin assembly is biased to transition from a folded configuration in which the fin assembly projects in a direction of the front of the frame and an unfolded configuration in which the fin assembly projects outward relative to the frame.

According to another embodiment (“Embodiment 16”), further to Embodiment 15, the fenestration unit further comprises a second side fin coupled to the second side of the frame a second corner bridge seal coupled to another portion of the top fin and positioned at the second corner.

According to another embodiment (“Embodiment 17”), further to Embodiment 16, the first corner bridge seal overlaps with the first side fin and the top fin and the second corner bridge seal overlaps with the second side fin and the top fin to define a continuous water barrier extending about the perimeter of the frame along the first side, the top side, and the second side.

According to another embodiment (“Embodiment 18”), further to Embodiment 15, the first corner bridge seal is folded such that the first corner bridge seal does not project substantially outward from the perimeter of the frame.

According to another embodiment (“Embodiment 19”), further to Embodiment 15, the first corner bridge seal is formed of an elastomer.

According to another embodiment (“Embodiment 20”), further to Embodiment 15, the fenestration unit further comprises a second corner bridge seal coupled to another portion of the top fin and positioned at the second corner.

### Shim Guide System

According to one embodiment (“Embodiment 1”), a fenestration unit has an interior side and an exterior side and includes a frame having a perimeter defining a frame head, a first jamb, a second jamb opposite the first side, a lower side opposite the frame head, a front, and a back opposite the front of the frame and a first shim guide system secured to the perimeter of the frame. The first shim guide system includes a first shim guide secured to the frame head, the first shim guide has a perimeter defining a first outer edge, a second outer edge opposite the first outer edge, a top edge between the first and second outer edges, and a bottom edge opposite the top edge. The first shim guide includes a first ramp portion at the first outer edge, a second ramp portion at the second outer edge, and a guide portion longitudinally between the first and second ramp portions. The guide portion defines a sliding surface that is recessed relative to the first and second ramp portions and the sliding surface is configured to receive one or more shims thereon. The first ramp portion has a tapered thickness having a first larger thickness adjacent to an edge of the guide portion and a second smaller thickness at the first outer edge.

According to another embodiment (“Embodiment 2”), further to Embodiment 1, the first shim guide system further includes a second shim guide secured to the frame head. The first shim guide is secured to the frame head in a first orientation and the second shim guide is secured to the frame head in a second orientation that is opposite to the first orientation.

According to another embodiment (“Embodiment 3”), further to Embodiment 1, the second ramp portion has a tapered thickness having a first larger thickness adjacent to an edge of the guide portion and a second smaller thickness at the second outer edge.

According to another embodiment (“Embodiment 4”), further to Embodiment 1, the first shim guide is substantially oval in shape.

According to another embodiment (“Embodiment 5”), further to Embodiment 1, the frame head defines a first channel along a length of the frame head, and the first shim guide includes one or more catches configured to be received within the first channel to secure the first shim guide to the frame head.

According to another embodiment (“Embodiment 6”), further to Embodiment 1, the fenestration unit further includes a second shim guide system secured to the perimeter of the frame, the second shim guide including a third shim guide secured to the second jamb.

According to another embodiment (“Embodiment 7”), further to Embodiment 6, the fenestration unit includes an interior handle on the front of the frame and an exterior handle of on the back of the frame, and the third shim guide is positioned between the interior handle and the exterior handle.

According to one embodiment (“Embodiment 8”), a fenestration unit has an interior side and an exterior side and includes a frame having a perimeter defining a frame head, a first jamb, a second jamb opposite the first side, a lower side opposite the frame head, a front, and a back opposite the front of the frame and a first shim guide system secured to the perimeter of the frame. The first shim guide system includes a first shim guide secured to the second jamb, the first shim guide having a perimeter defining a first outer edge, a second outer edge opposite the first outer edge, a top edge longitudinally between the first and second outer edges, and a bottom edge opposite the top edge. The first shim guide includes a first ramp of the first outer edge, a second ramp at the second outer edge, a central portion longitudinally between the first ramp and the second ramp, a first guide portion between the first ramp and the central portion, and a second guide portion between the central portion and the second ramp. The first guide portion defines a first sliding surface that is recessed relative to the first ramp and the central portion and the first sliding surface is configured to receive one or more shims thereon. The first ramp portion has a tapered thickness having a first larger thickness adjacent to an edge of the first guide portion and a second smaller thickness at the first outer edge.

According to another embodiment (“Embodiment 9”), further to Embodiment 8, the fenestration unit includes an interior handle on the front of the frame and an exterior handle of on the back of the frame, and the first shim guide is positioned between the interior handle and the exterior handle.

According to another embodiment (“Embodiment 10”), further to Embodiment 9, the fenestration unit further includes a lock strike positioned between the interior handle and the exterior handle, wherein the first shim guide is positioned over at least a portion of the lock strike.

According to another embodiment (“Embodiment 11”), further to Embodiment 10, the fenestration unit further includes a mounting plate positioned between the lock strike and the first shim guide, wherein the mounting plate is configured to couple to first shim guide and the lock strike.

According to another embodiment (“Embodiment 12”), further to Embodiment 8, the second guide portion defines a second sliding surface that is recessed relate to the second ramp and the central portion, and the second guide portion is configured to receive one or more shims thereon.

According to another embodiment (“Embodiment 13”), further to Embodiment 8, the second ramp portion has a tapered thickness having a first larger thickness adjacent to an edge of the second guide portion and a second smaller thickness at the second outer edge.

According to another embodiment (“Embodiment 14”), further to Embodiment 8, the second jamb defines a projection along a length of the second jamb, and the first shim guide is configured to be received onto the projection to secure the first shim guide to the second jamb.

According to another embodiment (“Embodiment 15”), further to Embodiment 8, the fenestration unit includes a second shim guide system secured to the perimeter of the frame, the second shim guide including a second shim guide secured to the frame head.

According to another embodiment (“Embodiment 16”), further to Embodiment 15, the second shim guide system further includes a third shim guide secured to the frame head. The second shim guide is secured to the frame head in a first orientation and the third shim guide is secured to the frame head in a second orientation opposite to the first orientation.

The foregoing embodiments and additional embodiments described herein should not be read to limit or otherwise narrow the scope of any of the inventive concepts otherwise provided by the instant disclosure. While multiple examples are disclosed, still other embodiments will become apparent to those skilled in the art from this specification and its drawings, which show and describe various illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description, serve to explain the principles of the disclosure.

FIG. 1 is a top-oriented perspective view of a sliding fenestration unit from an interior side of a building structure showing an anchoring system in a first, stowed configuration, according to some embodiments.

FIG. 2 is a top-oriented perspective view of the sliding fenestration unit of FIG. 1 from an interior side of a building structure showing the anchoring system in a second, installation configuration, according to some embodiments.

FIG. 3 is a top-oriented perspective view of the sliding fenestration unit of FIG. 1 from an exterior side of a building structure showing the anchoring system in the second, installation configuration, according to some embodiments.

FIG. 4A is a top-oriented perspective view of a frame head of the sliding fenestration unit of FIG. 2, showing the anchoring system in the second, installation configuration, according to some embodiments.

FIG. 4B is a top-oriented perspective view of the frame head of the sliding fenestration unit of FIG. 2, showing the anchoring system in the first, stowed configuration, according to some embodiments.

FIG. 5 is a side-oriented cross-sectional view of an anchoring clip of the anchoring system of FIG. 4A coupled to a thermal break of the sliding fenestration unit, according to some embodiments.

FIG. 6 is a side-oriented cross-sectional view of the anchoring clip coupled to the thermal break of FIG. 5, according to some embodiments.

FIG. 7 is a side view of the thermal break of FIG. 5, according to some embodiments.

FIG. 8A is a side-oriented perspective view of a fastener of the anchoring clip of FIG. 5, according to some embodiments.

FIG. 8B is a top view of the fastener of FIG. 8A, according to some embodiments.

FIG. 9A is a side view of another fastener of the anchoring clip of FIG. 5, according to some embodiments.

FIG. 9B is a top view of the fastener of FIG. 9A, according to some embodiments.

FIG. 9C is a side-oriented cross-sectional view of the anchoring clip of the anchoring system of FIG. 4A coupled to the thermal break of FIG. 7 via the fastener of FIGS. 9A-9B.

FIG. 10 is a top-oriented perspective view of the anchoring clip coupled to the frame head of the sliding fenestration unit of FIG. 3, according to some embodiments.

FIG. 11 is a side-oriented perspective view of the anchoring clip coupled to the frame head of the sliding fenestration unit of FIG. 3, according to some embodiments.

FIG. 12 is a top-oriented perspective view of a first anchoring clip of the anchoring system of FIG. 4A, according to some embodiments.

FIG. 13 is a top view of the first anchoring clip of FIG. 12, according to some embodiments.

FIG. 14 is a side view of the first anchoring clip of FIG. 12, according to some embodiments.

FIG. 15 is a top-oriented perspective view of a carrier bracket of the first anchoring clip of FIG. 12, according to some embodiments.

FIG. 16 is a top-oriented perspective view of a backing plate of the carrier bracket of FIG. 15, according to some embodiments.

FIG. 17 is a top-oriented perspective view of the receiver of the carrier bracket of FIG. 15, according to some embodiments.

FIG. 18 is a top view of the receiver of FIG. 17, according to some embodiments.

FIG. 19 is a side-oriented view of the receiver of FIG. 17, according to some embodiments.

FIG. 20 is a front-oriented cross-sectional view of the receiver of FIG. 17, according to some embodiments.

FIG. 21 is a top-oriented perspective view of the coupling bracket of the first anchoring clip of FIG. 12, according to some embodiments.

FIG. 22 is a bottom view of the coupling bracket of FIG. 21, according to some embodiments.

FIG. 23 is a rear-side view of the coupling bracket of FIG. 21, according to some embodiments.

FIG. 24 is a top-oriented perspective view of another embodiment of a coupling bracket, according to some embodiments.

FIG. 25 is a top-oriented perspective view of another embodiment of a coupling bracket, according to some embodiments.

FIG. 26 is a top-oriented perspective view of another embodiment of a coupling bracket coupled to the frame head of the sliding fenestration unit of FIG. 3, according to some embodiments.

FIG. 27 is a side-oriented cross-sectional view of the coupling bracket of FIG. 26 coupled to the frame head of the sliding fenestration unit of FIG. 3, according to some embodiments.

FIG. 28 is a top-oriented perspective view of the coupling bracket of FIG. 26, according to some embodiments.

FIG. 29 is a bottom view of the coupling bracket of FIG. 28, according to some embodiments.

FIG. 30 is a side view of the coupling bracket of FIG. 28, according to some embodiments.

FIGS. 31 and 32 are views of a retainer of the fenestration unit of FIG. 1, according to some embodiments.

FIG. 31 is an isometric view of the retainer, according to some embodiments.

FIG. 32 is a side view of the retainer, according to some embodiments.

FIG. 33 is a side-oriented cross section view of the retainer of FIG. 31 engaged with the thermal break of FIG. 7, according to some embodiments.

FIG. 34 is a schematic view illustrating engagement of the retainer with a head of rough opening framing as the fenestration unit of FIG. 1 is inserted in a first, exterior direction.

FIG. 35 shows the engagement as the fenestration unit of FIG. 1 is extracted in a second, interior direction, according to some embodiments.

FIG. 36A is a side-oriented perspective view of the fenestration unit of FIG. 1 from an exterior side including a weather seal system in a stowed configuration, according to some embodiments.

FIG. 36B is a side-oriented perspective view of the fenestration unit of FIG. 36b including the weather seal system in a deployed configuration, according to some embodiments.

FIG. 37 is an end view of a fin of the fenestration unit of FIG. 36B, according to some embodiments.

FIG. 38 is an isometric view of the fin of FIG. 37, according to some embodiments.

FIG. 39 is an isometric view of the fin of FIG. 37 from an interior-facing side, according to some embodiments.

FIG. 40 is an end view of the fin of FIG. 36A, according to some embodiments.

FIG. 41 is a closeup view of a corner of the fenestration unit of FIG. 36B, according to some embodiments.

FIG. 42 is an isometric view of a head fin, and first and second corner bridge seals of the fenestration unit of FIG. 36B, according to some embodiments.

FIG. 43A is an isometric view of a first corner bridge seal of the fenestration unit of FIG. 36B, according to some embodiments.

FIG. 43B is an isometric view of a second corner bridge seal of the fenestration unit of FIG. 36B, according to some embodiments.

FIG. 43C is a backside view of an adhesive applied to the first corner bridge seal of FIG. 43A, according to some embodiments.

FIGS. 44A, 44B, and 44C are isometric views of the second corner bridge seal of the fenestration unit of FIG. 36B transitioning from the folded, stowed configuration to the unfolded, deployed configuration, according to some embodiments.

FIGS. 44D, 44E, 44F, and 44G are isometric views of the second corner bridge seal of the fenestration unit of FIG. 36B transitioning from the unfolded, deployed configuration to the folded, stowed configuration, according to some embodiments.

FIG. 45 is a closeup, isometric view of the fenestration unit of FIG. 36A with a plurality of retaining clips removed and showing the second bridge corner seal in a folded configuration, according to some embodiments.

FIG. 46 is a closeup end view of a first corner of the fenestration unit with a fin assembly of the fenestration unit of FIG. 36B removed, according to some embodiments.

FIG. 47 is a closeup isometric view of the first corner of the fenestration unit of FIG. 36B with the first bridge corner seal removed, according to some embodiments.

FIGS. 48, 49, and 50 illustrate a retaining clip design of the fenestration of FIG. 36A, according to some embodiments.

FIG. 48 is an isometric view of a retaining clip of the fenestration unit of FIG. 36A, according to some embodiments.

FIG. 49 is an end view of the retaining clip of FIG. 48, according to some embodiments.

FIG. 50 is sectional view at a head of the fenestration unit of FIG. 36A, according to some embodiments.

FIGS. 51, 52, and 53 illustrate another retaining clip design of the fenestration unit of FIG. 53, according to some embodiments.

FIG. 51 is an isometric view of a retaining clip of the fenestration unit of FIG. 36A, according to some embodiments.

FIG. 52 is an end view of the retaining clip of FIG. 51, according to some embodiments.

FIG. 53 is sectional view at a head of the fenestration unit of FIG. 36A, according to some embodiments.

FIG. 54 is a top view of the frame head of the fenestration unit of FIG. 1 showing a first shim guide system, according to some embodiments.

FIG. 55 is a side view of the second jamb of the fenestration unit of FIG. 1 showing a second shim guide system, according to some embodiments.

FIGS. 56-60 are views of a first shim guide of the first shim guide system of FIG. 54, according to some embodiments.

FIG. 56 is a perspective view of the first shim guide, according to some embodiments.

FIG. 57 is a front view of the first shim guide of FIG. 56, according to some embodiments.

FIG. 58 is a side view of the first shim guide of FIG. 56, according to some embodiments.

FIG. 59 is a bottom view of the first shim guide of FIG. 56, according to some embodiments.

FIG. 60 is a side-oriented perspective view of the bottom of the first shim guide of FIG. 56, according to some embodiments.

FIG. 61 is a side-oriented cross-sectional view of the first shim guide of FIG. 56 engaged with the thermal break of FIG. 7, according to some embodiments.

FIG. 62 is a side-oriented cross-sectional view of a second shim guide of the first shim guide system of FIG. 54 engaged with the thermal break of FIG. 7, according to some embodiments.

FIGS. 63-66 are views of a third shim guide of the second shim guide system of FIG. 55, according to some embodiments.

FIG. 63 is a perspective view of the third shim guide, according to some embodiments.

FIG. 64 is a side view of the third shim guide of FIG. 63, according to some embodiments.

FIG. 65 is a side view of the third shim guide of FIG. 63, according to some embodiments.

FIG. 66 is a bottom view of the third shim guide of FIG. 63, according to some embodiments.

FIG. 67 is a close-up view of the second shim guide system of FIG. 55, according to some embodiments.

FIG. 68 is a side-oriented perspective view of the third shim guide of FIG. 63 coupled to the thermal break of FIG. 7, according to some embodiments.

FIGS. 69-71 are views of a mounting plate of the second shim guide system of FIG. 55, according to some embodiments.

FIG. 69 is a perspective view of the mounting plate, according to some embodiments.

FIG. 70 is a top view of the mounting plate of FIG. 69, according to some embodiments.

FIG. 71 is a side-view of the mounting plate of FIG. 69, according to some embodiments.

FIG. 72 is a side-oriented cross-sectional view of the second jamb 27 showing the third shim guide of FIG. 63, the mounting plate of FIG. 69, and a lock strike, according to some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement may deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale and may be exaggerated to illustrate various aspects of the present disclosure, and in that regard, the drawing figures should not be construed as limiting.

### Description of Various Embodiments

Various concepts of this patent specification address installation systems and methods for fenestration units, such as windows and doors. Some features of such systems and methods include one or more of the following: the fenestration unit configured to be set into a rough opening (RO) from the interior side of a building structure or wall defined by a rough opening framing; gauging to the interior face of a rough opening framing for more accurate finishing (e.g., drywall and/or trim offsets); the fenestration unit having attached pre-applied (e.g., factory-applied) anchoring clips configured for interior unit installation; and the fenestration unit being configured to be installed by a single person/installer or fewer installers than traditional installation setups. In some examples, based at least in part on a weight of the fenestration unit, installation may require more than one installer, such as two installers, to complete traditional installation steps. In other examples where the fenestration unit is relatively light (e.g., a knock-down door), traditional installation steps may be completed by a single installer. The installation time and labor costs may be decreased for installation of the fenestration unit described herein as compared to traditional installation steps.

In various examples, the fenestration units (e.g., fenestration unit 10) include features that promote installation of the fenestration unit from an interior side of a rough opening (RO). In particular, a fenestration unit according to various examples includes an engagement system coupled to the frame, the engagement system configured to positively engage the interior face of the rough opening framing upon insertion of the fenestration unit in the rough opening (RO) from the interior side of the rough opening (RO). In this manner, one or more individuals may insert a fenestration unit into the rough opening (RO) on the interior side thereof and secure the fenestration unit to the interior side of the rough opening framing without needing another installer to hold the fenestration unit against the rough opening framing from an exterior side thereof. The engagement system, also referred to herein as an anchoring clip system, may hold and stabilize the fenestration unit within a framing of the rough opening (RO) such that shims are not required to hold the fenestration unit in place.

In various embodiments, the fenestration unit is anchored to and stabilized against an interior side of the rough opening framing via the anchoring clip system. Anchoring to the exterior side of the rough opening framing is not required, and in some examples, is not possible. In some examples, the exterior side of the rough opening framing includes insulation (e.g., a foam board), which is relatively soft, and does not provide a solid surface to anchor against, or to drive fasteners therethrough. By providing the anchoring clip system that interfaces with the interior side of the framing, challenges due to exterior insulation may be lessened.

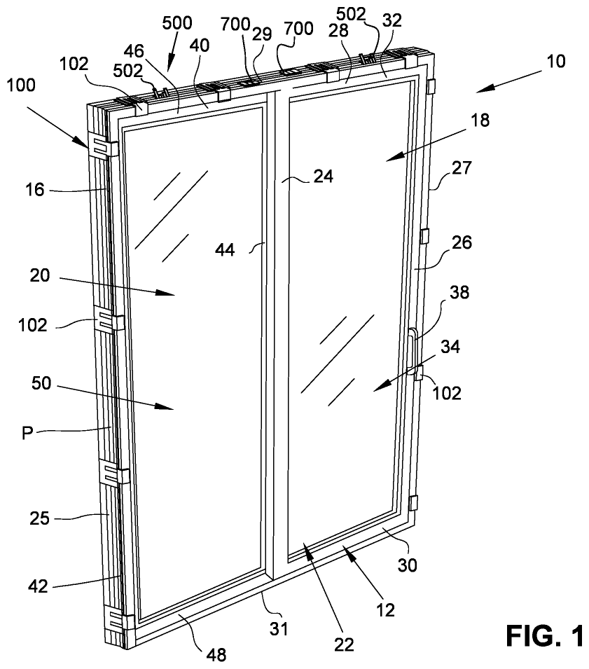

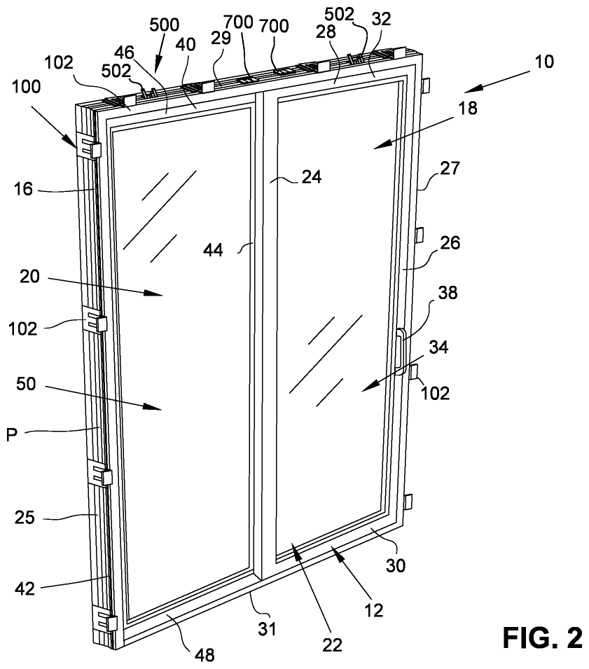

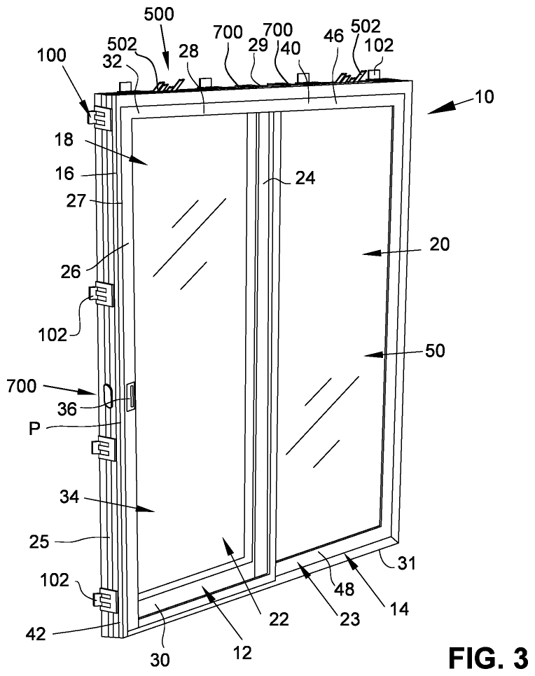

FIGS. 1-3 illustrate a fenestration unit 10 for installation in a building structure (not shown), according to some embodiments. FIGS. 1 and 2 show a top-oriented perspective view of the fenestration unit 10 from an interior side 12 (e.g., as the fenestration unit 10 would appear from an interior of the building structure). FIG. 3 illustrates the fenestration unit 10 from an exterior side 14 (e.g., as the fenestration unit 10 would appear from an exterior of the building structure).

Further referring to FIGS. 1-3, the fenestration unit 10 includes a frame 16, one or more sliding panels (illustratively, a sliding panel 18), and one or more fixed panels (illustratively, a fixed panel 20). For example, the fenestration unit 10 is depicted as a sliding door unit, but it is understood that the term “fenestration unit” as used herein is to be read broadly and “fenestration unit” may also be implemented as sliding window units, fixed, double hung, hinged window or door units, or the like. In other examples, the fenestration unit 10 may be a multi-slide door, a bifold door, or another door without fixed and/or sliding panels.

The frame 16 may be a wood frame (e.g., aluminum clad wood) design. However, vinyl, fiberglass, or other materials may be implemented for the frame 16. As shown, the frame 16 includes an outer perimeter P and has a front face 22, or interior face (FIG. 1) facing the interior side 12, as well as a back face 23, or exterior face (FIG. 3) facing the exterior side 14. The frame 16 is operable to be positioned in a rough opening (RO) of the building structure and supports the fixed panel 20 and the sliding panel 18 therein. The frame 16 generally includes a first jamb 25, a second jamb 27, a frame head 29, and a lower rail 31 (e.g., a sill). The sliding panel 18 is slidably positioned with the frame 16. The sliding panel 18 has a sliding panel frame 32 including a first jamb 24, a second jamb 26, an upper rail 28 (e.g., a head), and a lower rail 30 (e.g., a sill). The sliding panel 18 includes a glazing unit 34 supported by the sliding panel frame 32. The first jamb 24 of the sliding panel 18 is positioned against the second jamb 27 of the frame 16 of the fenestration unit 10.

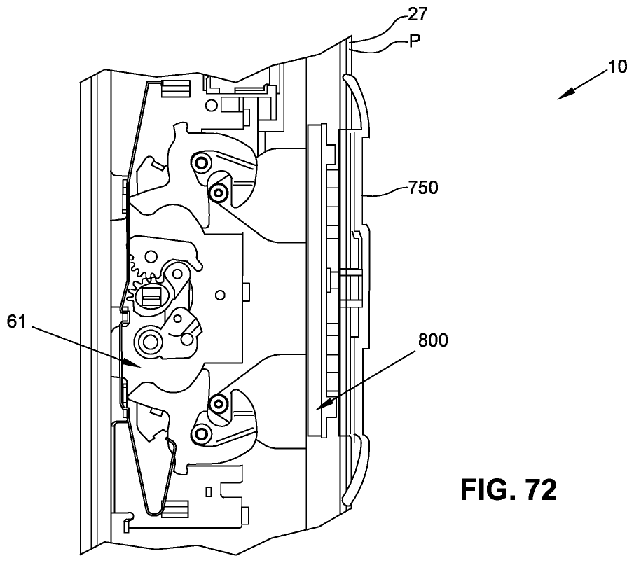

The second jamb 26 of the sliding panel 18 carries an exterior handle 36 (FIG. 3) and an interior handle 38 (FIGS. 1-2), which can be actuated to slide the sliding panel 18 between open and closed positions. The sliding panel 18 may include locking components, such as a lock strike 61 (FIG. 72) for engaging and/or locking the sliding panel 18 in the closed position. For example, the sliding panel 18 may be engaged with the frame 16 of the fenestration unit 10 in the closed position when the locking components engage a corresponding structure on the frame 16, thereby limiting or inhibiting movement of the sliding panel 18.

As shown in FIGS. 1-3, the fixed panel 20 is fixedly positioned with the frame 16. The fixed panel 20 includes a fixed panel frame 40 including a first jamb 42, a second jamb 44, an upper rail or head 46, and a lower rail 48. The fixed panel 20 includes a glazing unit 50 supported by the fixed panel frame 40. The first jamb 42 of the fixed panel 20 is positioned against the first jamb 25 of the frame 16.

Although the sliding panel 18 and the fixed panel 20 may include glazing units 34, 50 as described, in various embodiments the sliding panel 18 and/or the fixed panel 20 may alternatively include screens or opaque, solid, or filled panel designs that are not transparent (e.g., wood, tile, fiberglass, vinyl, or other central paneling). Similarly, although the sliding panel 18 may include a screen, in various embodiments the sliding panel 18 may alternatively include glazing or opaque, solid, or filled panel designs that are not transparent (e.g., wood, tile, fiberglass, vinyl, or other central paneling).

Although the above examples have been discussed relating to fenestration units with both sliding panels and fixed panels, it is understood that the concepts and features discussed herein may be implemented in a variety of fenestration systems, including fixed panel units, hinged units, and so forth.

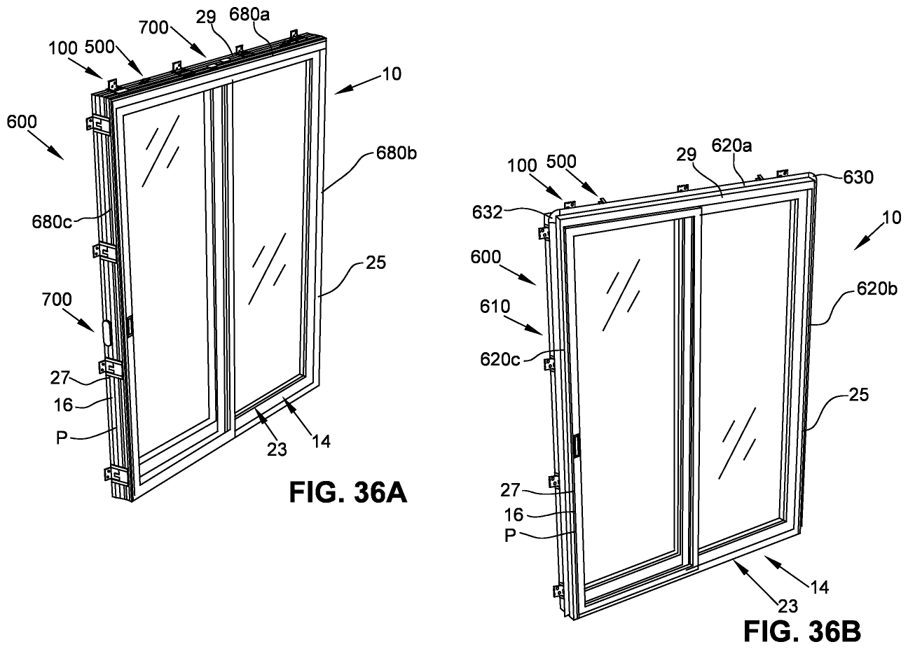

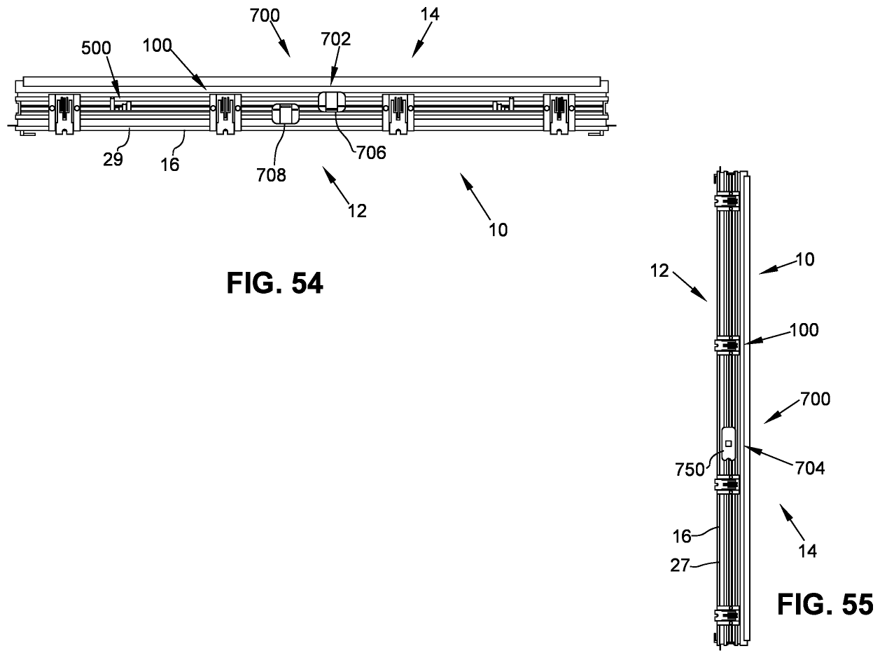

As described herein, the fenestration unit 10 includes one or more installation features for facilitating installation of the fenestration unit 10. For example, as shown, the fenestration unit 10 may include one or more of the following installation features: an anchoring clip system 100 (also described as an engagement system), an installation stabilizer system 500 (FIG. 1), a weather seal system 600 (FIGS. 36A-36B), and a shim guide system 700 (FIGS. 54-55).

### Anchoring Clip System

As shown in FIGS. 1-3, the fenestration unit 10 includes an anchoring clip system 100, also described as an engagement system. FIG. 1 illustrates the fenestration unit 10 with the anchoring clip system 100 in an initial, stowed or pre-installation, stowed configuration (e.g., as initially received by an installer). FIGS. 2-3 illustrates the fenestration unit with the anchoring clip system 100 in a final, installation configuration.

The anchoring clip system 100 includes a plurality of anchoring clips 102 secured to the outer perimeter P of the frame 16. In particular, the anchoring clips 102 are coupled to the frame head 29, the first jamb 25, and the second jamb 27 (e.g., at least three to each). As shown, the anchoring clip system 100 includes eleven (11) anchoring clips 102, although greater (e.g., 12, 14, 16, 18 etc.) or fewer (e.g., 6, 8 or 10) anchoring clips 102 are contemplated. In some examples, eleven (11) anchoring clips 102 are distributed along perimeter P of the frame 16, with four anchoring clips 102 evenly spaced along a length of the first jamb 25, three anchoring clips 102 evenly spaced along a length of the frame head 29, and four anchoring clips 102 evenly spaced along a length of the second jamb 27. As the dimensions of the fenestration unit 10 increase, more anchoring clips 102 may be warranted to help ensure proper anchoring and support of the fenestration unit 10, where that functionality is described in greater detail below.

In use, each of the anchoring clips 102 can be set at an intended depth, or gauged, for installation (e.g., to accommodate wall depth of the rough opening (RO), insulation, and/or exterior sheeting). The anchoring clips 102 can help gauge the fenestration unit 10 from an interior face of the rough opening (RO). This gauging capability helps ensure a proper offset for drywall thickness or other wall features and may help eliminate or reduce such problems as jamb extensions of the fenestration unit 10 being “proud” or “recessed” from an interior face of the finished wall surface (e.g., at an inner face). The resulting installation using the anchoring clips 102 may help ensure flush jamb extensions relative to the interior face of the wall which makes the installation of trim (e.g., casing) of the fenestration unit 10 much more efficient for subsequent detailing steps (e.g., finish carpenters).

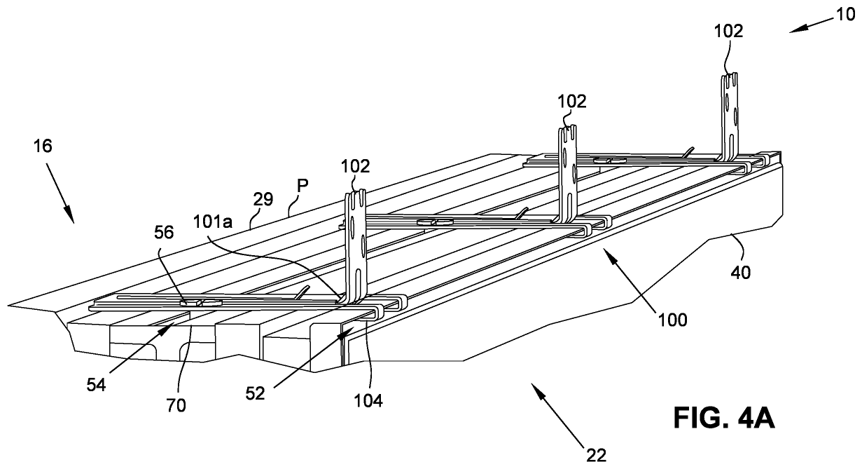

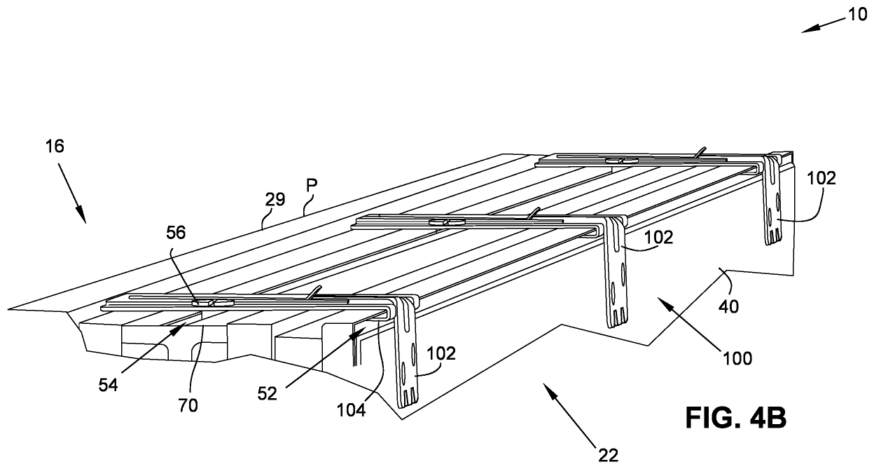

In some implementations, the anchoring clips 102 are initially provided to an installer (e.g., shipped or delivered to the installer) attached to the fenestration unit 10 in a stowed configuration, as shown, for example, in FIGS. 1 and 4B. The installer (not shown) removes, flips (or rotates) a portion of the anchoring clips 102 around and reinserts a portion of the anchoring clip 102 to a desired overall depth by pushing to engage a retention feature (e.g., a slot) of the anchoring clips 102. In various examples, the portion of the anchoring clips 102 may be both removed by the installer and reinserted without the use of tools. As part of the installation process, the installer (not shown) will flip (rotate axially) the anchoring clips 102 around from the position shown in FIG. 1 (first, stowed configuration) to that shown in FIGS. 2-3 (second, installation configuration) as part of installation prep work. In some designs, as discussed herein, the anchoring clips 102 may be adjustable for different installation depths (e.g., to accommodate insulation or exterior sheeting thicknesses). For example, the anchoring clip 102 may be configured to gauge against a standard 2×4, 2×6, or 2×8 wall depth of the rough opening framing, or may be configured to gauge a non-standard wall depth therebetween. The standard wall depth is defined by both a depth of the wall/framing (e.g., a 2×4, a 2×6, or a 2×8 depth) and an exterior sheeting thickness (e.g., a ½-inch or 7/16-inch exterior sheeting thickness). In embodiments where the first anchoring clip 102a is gauged to a non-standard wall depth (e.g., any depth between the 2×4, 2×6, or 2×8 depths with exterior sheeting thickness).

With the foregoing in mind, as shown in FIGS. 1-3, the anchoring clips 102 may each be substantially similar to one another and may be described cumulatively in association with a first anchoring clip 102a of the anchoring clips 102, example designs of which are subsequently described.

FIGS. 4A-4B show a top-oriented perspective view of the plurality of anchoring clips 102 coupled to the perimeter P of the frame 16 from the front face 22, according to some embodiments. The plurality of anchoring clips 102 may be coupled to the frame head 29 along a perimeter P of the frame 16. Although shown and described with respect to the frame head 29, similar concepts are applied to the anchoring clips 102 coupled to the first and second jambs 25, 27 (and, optionally, the sill, e.g., in instances where the fenestration unit 10 is not in the form of a sliding patio door). FIG. 4A illustrates the anchoring clips 102 in a deployed, or installation configuration (FIG. 2). FIG. 4B illustrates the anchoring clips 102 in the stowed configuration (FIG. 1). The plurality of anchoring clips 102 include at least one hook 104 (FIG. 19) extending from a first end 101a of the anchoring clip 102. As shown, the frame head 29 may define a first accessory groove, or a first channel 52, extending along a length of the frame head 29 that is configured to receive a portion of the hook 104 of the anchoring clip 102 therein to couple the frame 16 and the anchoring clip 102.

A non-penetrating feature includes one that does not puncture through portions of the frame 16, or in other words, does not require a threaded hole or through hole for securement to the frame 16. In some examples, features that act as non-penetrating features may engage directly with an accessory groove or T-slot defined by the frame 16 for securement thereon without needing to puncture the frame 16. For example, the hook 104 may engage the frame 16 without penetrating the frame 16, or otherwise creating a hole in the frame 16, such that the hook 104 may be described as a non-penetrating feature. In addition, the anchoring clips 102 may be coupled along the perimeter P of the frame 16 via one or more fasteners 56. In some embodiments, and as described further below, the fenestration unit 10 may define a second accessory groove, or a second channel 54, (FIG. 4A) extending along a length of the frame head 29. The one or more fasteners 56 may be received within the second channel 54 to couple the anchoring clips 102 to the perimeter P of the frame 16. The second channel 54 may be defined by the frame head 29 itself or may be defined by a thermal break 70 (FIG. 4A) coupled to, and extending within, the frame head 29. The thermal break 70 may be formed of a lower thermal conductivity material that is positioned between adjacent frame pieces formed of a relatively higher thermal conductivity material (e.g., aluminum frame pieces). In other embodiments, the anchoring clips 102 may be coupled to the frame 16 via adhesion to the frame 16. However, other attachment methods are contemplated, including adhesives, heat bonding, integral formation, or others.

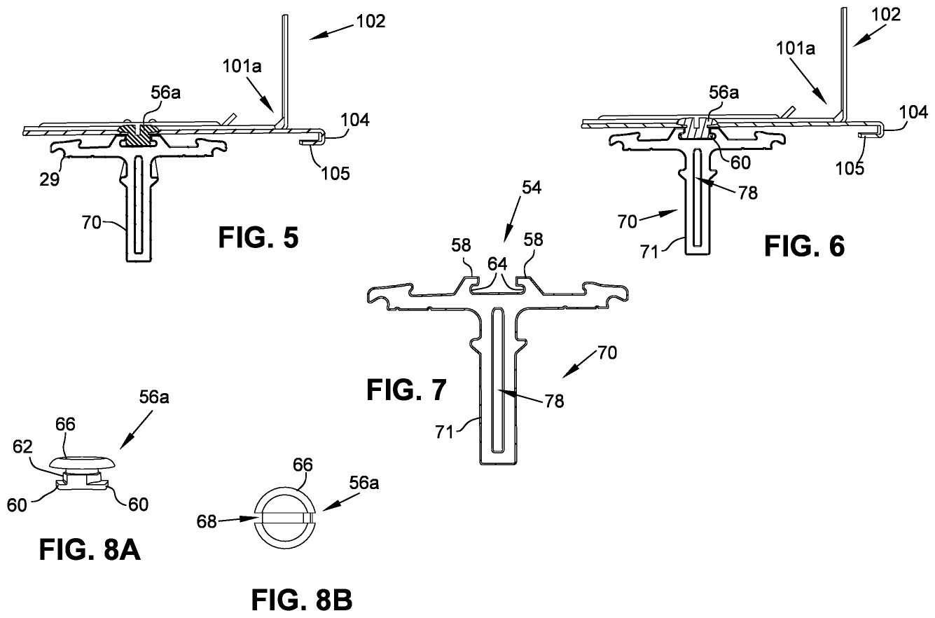

FIG. 5 shows a side-oriented perspective view of the anchoring clip 102 and the thermal break 70 isolated from the fenestration unit 10, according to some embodiments. FIG. 6 shows a side-oriented cross-sectional view of the embodiment of FIG. 5. FIG. 7 shows the thermal break 70 isolated from the anchoring clip 102, according to an embodiment. FIGS. 8A-8B show the cam 56a isolated from the anchoring clip 102, according to an embodiment. As discussed with respect to FIG. 4A, the anchoring clip 102 may be coupled to the second channel 54 of the frame head 29 via one or more fasteners 56. As shown, the thermal break 70 has a body 71 that defines the second channel 54 along the length of the frame head 29.

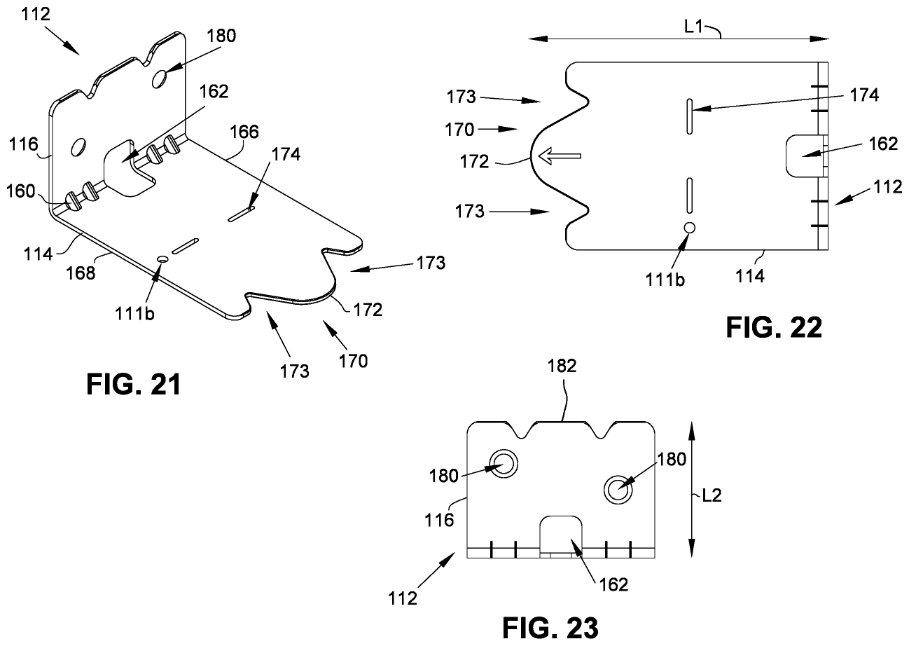

In some embodiments, the one or more fasteners 56 include a pivotable or rotatable interlocking cam 56a that is positionable in the second channel 54, as shown in FIGS. 5-6. For example, each of the one or more fasteners 56 for each of the anchoring clips 102 may be an interlocking cam similar to interlocking cam 56a. In an initial, or unlocked configuration as shown in FIG. 5, the cam 56a is disposed apart from sidewalls 58 (FIG. 7) of the second channel 54 and is thereby insertable in the second channel 54. In particular, the cam 56a includes one or more feet 60 (FIG. 8A) that project outwardly relatively to a generally central waist portion of the 62 of the cam 56a. In the unlocked configuration, the one or more feet 60 extend substantially parallel to a length of the second channel 54 such that the cam 56a can be received therein. The cam 56a is then pivoted to a locked configuration as shown in FIG. 6, such that the one or more feet 60 of the cam 56a are positioned in an undercut portion 64 (e.g., a T-slot) (FIG. 7) of the second channel 54 and behind the sidewalls 58 of the second channel 54. The cam 56a may be pivoted approximately 90 degrees between the unlocked and locked positions. This action secures the cam 56a, and thereby the anchoring clip 102, to the thermal break 70 and to the frame 16. In some embodiments, and as illustrated, the cam 56a includes a head 66 defining a slot 68 for receiving a tool (for example, a flat-head screwdriver, a Phillips-head screwdriver, a star-head screwdriver driver, or the like) to facilitate pivoting the cam 56a between the unlocked (FIG. 5) and locked (FIG. 6) configurations. In some embodiments, the cam 56a lacks a slot and is shaped or otherwise configured to be pivoted by a different tool, such as a wrench or the like. In other examples, portions of the anchoring clip 102 may be utilized to rotate the cam 56a. For example, the slot 68 may be configured such that a leg 114, 116 (FIG. 21) of the anchoring 102 can be inserted into the slot 68 to rotate the cam 56a between the unlocked (FIG. 5) and locked configuration (FIG. 6). In some embodiments, the cam 56a may be removably coupled to the anchoring clip 102. In other embodiments, the cam 56a may be riveted to a portion of the anchoring clip 102 such that the cam 56a is permanently coupled to the anchoring clip 102.

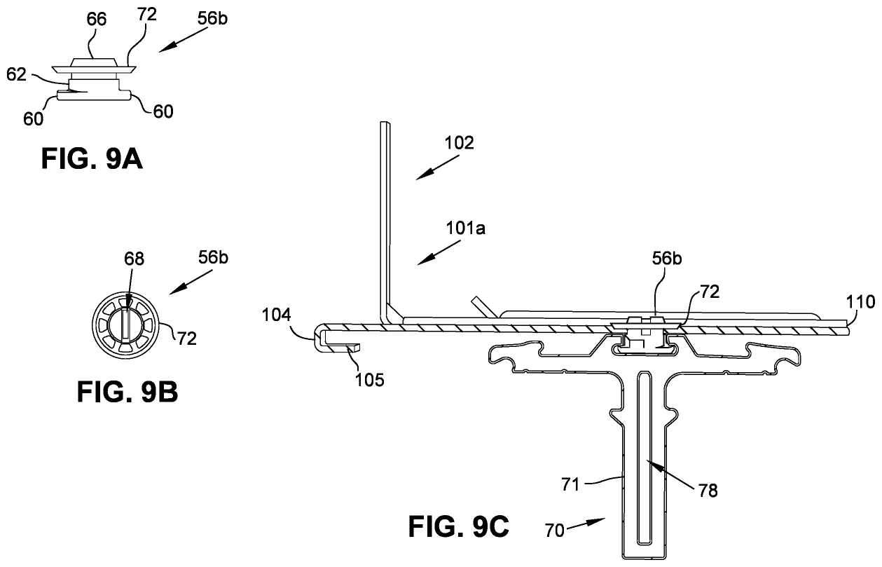

FIGS. 9A-9B illustrate another embodiment of the fastener 56, illustratively cam 56b. The cam 56b may include substantially similar features as cam 56a, including the one or more feet 60, the waist portion 62, the head 66, and/or the slot 68. The cam 56b further includes a retainer 72 positioned about the waist portion 62. The retainer 72 is configured to keep the cam 56b coupled to the anchoring clip 102 and helps to prevent inadvertent removal of the cam 56b. The retainer 72 may include an external retaining ring that is applied onto to the cam 56b via pushing the external retaining ring onto the cam 56b. In some embodiments, the retainer 72 may be applied when the cam 56b is in the locked position and may help prevent inadvertent pivoting to the unlocked position. FIG. 9C illustrates a side-oriented cross-sectional view of the anchoring clip 102 coupled to the thermal break 70 via the cam 56b. FIG. 9C shows the cam 56b in the locked configuration, where the retainer 72 engages a surface of the anchoring clip 102 (e.g., the carrier bracket 110) to hold the cam 56b in the locked configuration. When the cam 56b is transitioned to the locked configuration, the retainer 72 acts to force the one or more feet 60 of the cam 56b against the walls 64 of the thermal break 70. This creates a both a frictional engagement and a mechanical interlock between the one or more feet 60 and the one or more walls 64 to prevent inadvertent rotation of the cam 56b and inadvertent loosening of the cam 56b engagement with the anchoring clip 102.

As shown in at least FIG. 4A, the anchoring clip 102 engages with one or more accessory channels of the frame 16 (e.g., first channel 52 and second channel 54). In some examples, the cam 56a and the cam 56b engage directly with the second channel 54 of the frame 16 and do not penetrate or puncture through the frame 16, or in other words, act as non-penetrating fasteners. Instead, the features of the cam 56a and cam 56b are locked into portions of the second channel 54 to couple to the frame 16. As such, the non-penetrating fasteners may also be used with vinyl frames, or other materials, where penetration of the frame 16 by fasteners is not ideal.

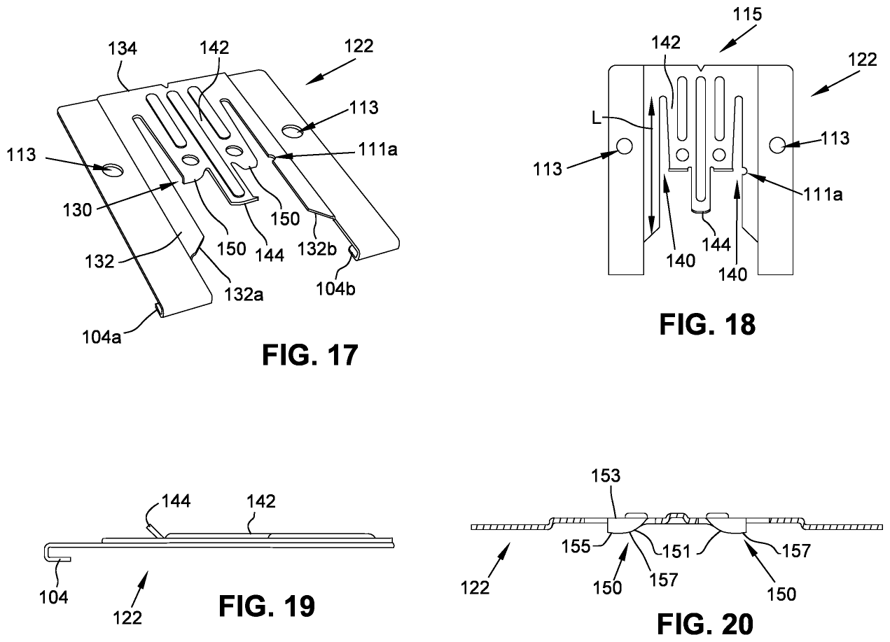

Further, the anchoring clip 102 may include one or more alignment features, such as the hook 104 (FIG. 4A). As shown, the hook 104 may engage the first channel 52 and the installer may rotate or pivot the rest of the anchoring clip 102 toward the perimeter P of the frame 16. The hook 104 defines a fastening clasp 105 (or a curved end) that engages with the first channel 52 and couples the anchoring clip 102 in place along the frame 16. This engagement assists in registration, or alignment of the fastener apertures 113 (FIG. 17) of the anchoring clip 102 along the perimeter P of the frame 16 with the second channel 54 such that the fasteners 56 are properly received within the second channel 54 during installation. As such, the hook 104 is operable to assist in auto-alignment, or proper alignment, of the anchoring clip 102 along the perimeter P of the frame 16 during installation.

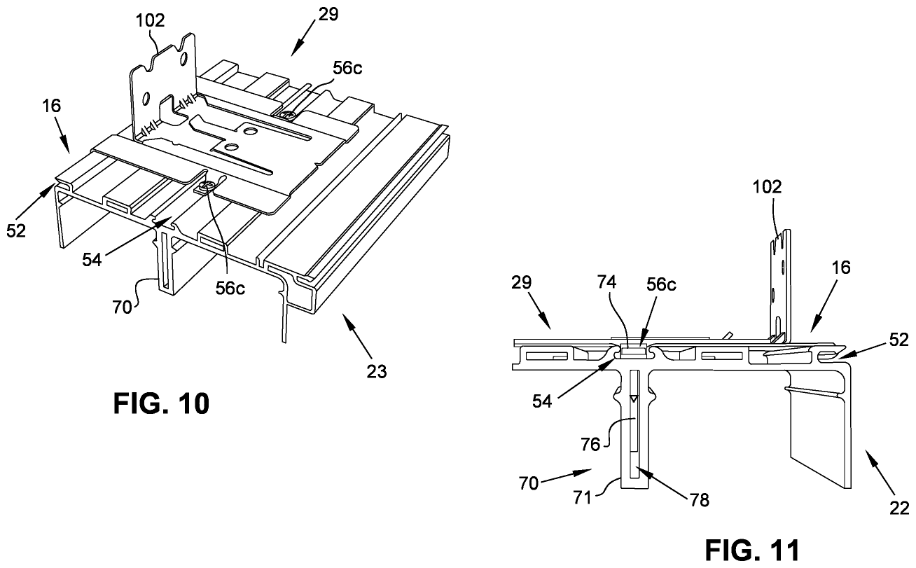

Turning to FIGS. 10-11, in another embodiment, there may be a penetrating fastener 56, such as a screw 56c. The screw 56c has a head portion 74 and a body portion 76, where the body portion 76 extends through the body 71 of the thermal break 70 to couple the anchoring clip 102 to the frame 16. The body 71 of the thermal break 70 defines a receiving pocket 78 therein, and the body portion 76 of the screw 56c is received within the receiving pocket 78. The receiving pocket 78 shields the body portion 76 of the screw 56c such that the body portion 76 is not visible though the frame 16, or through the glazing units 34, 50. Shielding the screw 56c from view through the fenestration unit 10 has aesthetic appeal. In embodiments, body portion 76 of screw 56c includes threading (not shown), and the threading that can bite into the body 71 of the thermal break 70 upon twisting the screw 56c such that the screw 56c becomes embedded into the body 71 of the thermal break 70. This may facilitate tight coupling between the anchoring clip 102 and frame 16.

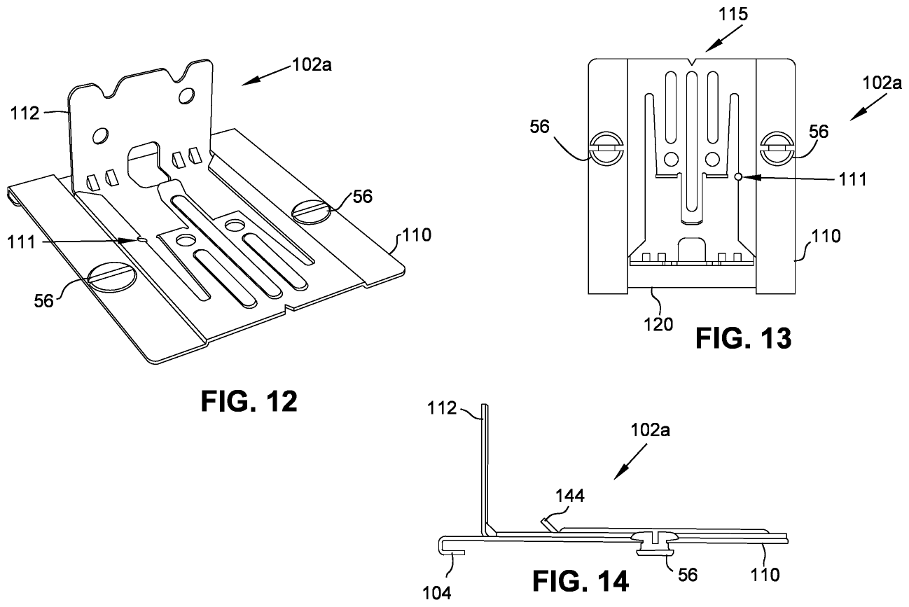

FIGS. 12-14 illustrate a first anchoring clip 102a of the anchoring clips 102 isolated from the fenestration unit 10, according to some embodiments. The first anchoring clip 102a may be substantially similar to the other anchoring clips of the plurality of anchoring clips 102. FIG. 12 illustrates a top-oriented perspective view of the first anchoring clip 102a, FIG. 13 illustrates a top view of the first anchoring clip 102a, and FIG. 14 illustrates a side view of the first anchoring clip 102a.

As shown, the first anchoring clip 102a includes a carrier bracket 110 configured to be coupled to the perimeter P (FIG. 4A) of the frame 16 and a coupling bracket 112 configured to be received within a portion of the carrier bracket 110. The carrier bracket 110 is coupled to the perimeter P of the frame 16 via the one or more fasteners 56, and/or the hook 104, as described above. The first anchoring clip 102a is optionally made from stamped sheet metal (e.g., galvanized steel) or other appropriate material/manufacturing method. Although the carrier bracket 110 is shown as a separate component from the frame 16 (e.g., pre-attached at the factory or other location remote from the installation site), the carrier bracket 110 or features thereof may be integrally formed (e.g., molded, machined, routed, etc.) into the frame 16 as part of a manufacturing process, for example.

The coupling bracket 112 is securable to the carrier bracket 110 such that the coupling bracket 112 can be transitioned between a first stowed configuration (FIGS. 1 and 4B) and a second installation configuration (FIGS. 2-4A). As further described, to transition between the first stowed configuration and the second installation configuration, the coupling bracket 112 may be removed from the carrier bracket 110, rotated, and re-secured to the carrier bracket 110.

As shown in FIGS. 12-13, the first anchoring clip 102a may include an orientation feature 111 that gives the installer a visual indication that the coupling bracket 112 is properly engaged and seated within the carrier bracket 110 in the second, installation configuration, and that the first anchoring clip 102a is gauged to the correct wall depth. The orientation features 111 may be defined by a cutout within the carrier bracket 110 and a corresponding feature in the coupling bracket 112. As shown, the orientation feature 111 can include a first orientation feature 111a defined by the carrier bracket 110 (e.g., as shown in FIGS. 17-18) and a second orientation feature 111b defined by the coupling bracket 112 (e.g., as shown in FIGS. 21-22) that is optionally complementary in shape to the first orientation feature 111a. The first orientation feature 111a may be an edge cutout or recess formed in an edge, or may be a stamp or marking on a surface of the carrier bracket 110, although any of a variety of orientation feature designs are contemplated. In turn, the second orientation feature 111b may be a curved or circular through hole, or aperture, for example, or may be a surface marking on a surface of the coupling bracket 112 (e.g., an etched or stamped fiducial marking), although a variety of orientation feature 111 designs are contemplated. Although the orientation features 111 are shown as curved or rounded features, other shapes such as rectangular, square, and triangular shapes are also contemplated.

As shown in FIG. 13, a notch 115 may be defined along a portion of the anchoring clip 102, such as the carrier bracket 110, to assist with visual location of the anchoring clips 102 upon installation. For example, the notch 115 may be visible along the perimeter P when the fenestration unit 10 is installed within the rough opening (RO). The notch 115 may include an edge cutout or recess formed in an edge, or may be a stamp or marking on a surface of the carrier bracket 110, although any of a variety of notch designs are contemplated. As shown in FIG. 13, the notch 115 may be a triangular cut out.

FIG. 14 shows a side-view of the first anchoring clip 102a, according to some embodiments. As described with respect to FIG. 4A, the first anchoring clip 102a includes the hook 104, wherein the hook 104 is configured to couple to the perimeter P of the frame 16, and retain the first anchoring clip 102a thereon, as described above. The first anchoring clip 102a also includes the one or more fasteners 56 to couple the first anchoring clip 102a to the frame 16, as described above.

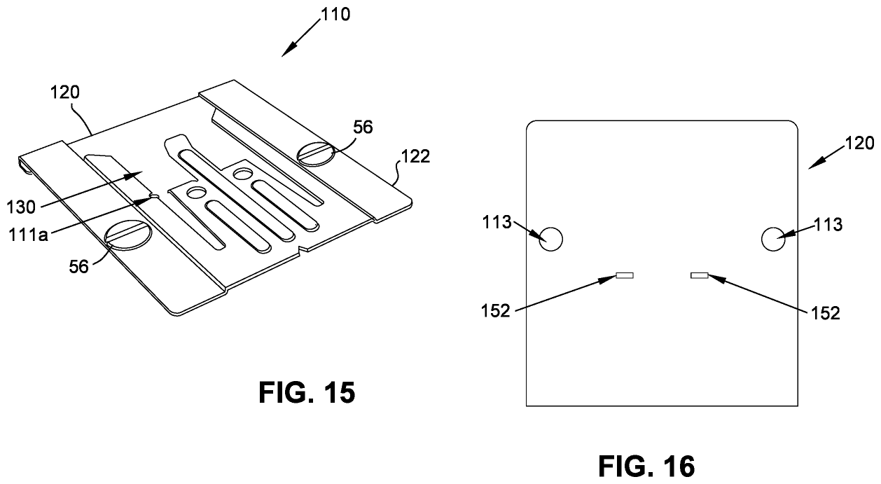

FIG. 15 is an isolated, isometric view of the carrier bracket 110, according to some embodiments. As shown, the carrier bracket 110 includes a backplate 120 and a receiver 122.

FIG. 16 shows a top view of the backplate 120 isolated from the carrier bracket 110, according to some embodiments. The backplate 120 may be sandwiched between the frame 16 and the receiver 122. The backplate 120 is optionally secured to the receiver 122 using the one or more fasteners 56, or using rivets, welding, adhesives, co-casting, overmolding, or other methods. The backplate 120 may comprise a non-conductive material to avoid creation of a thermal bridge between exterior and interior portions of frame 16. The non-conductive material may include, but is not limited to, a plastic such as styrene or polypropylene. As shown, the backplate 120 may be relatively flat and relatively thin to maintain the anchoring clip 102 in a low-profile. In some embodiments, both the receiver 122 and the backplate 120 include one or more fastener apertures 113 that align to receive fasteners 56 therethrough for coupling to the frame 16. If a lower profile is desired, in some embodiments, the backplate 120 may be omitted from the carrier bracket 110. In other lower profile embodiments, the frame 16 may define a recess and the backplate 120 may be received within the recess. In configurations without a backplate 120, surface features of the frame 16 (e.g., grooves or ridges) may interfere with smooth sliding and thus the backplate 120 is typically included notwithstanding the additional thickness.

FIGS. 17-18 show the receiver 122 isolated from the backplate 120, according to some embodiments. FIG. 17 shows a top-oriented perspective view of the receiver 122 and FIG. 18 shows a top view thereof. As discussed with respect to FIG. 4A, the carrier bracket 110 may also define the hook 104 on the first end 101a, wherein a fastening clasp 105 of the hook 104 is configured to be received by the first channel 52 of the frame 16 to couple the anchoring clip 102 to the fenestration unit 10. As shown, the hook 104 may include a first hook 104a and a second hook 104b positioned on opposing sides of the carrier bracket 110. As shown, the carrier bracket 110 defines a retaining pocket 130 for receiving the coupling bracket 112 therein. In particular, the receiver 122 and optional backplate 120 define the retaining pocket 130 space therebetween. Where the backplate 120 or analogous structure is not included, the retaining pocket 130 may be defined by a space between the receiver 122 and the portion of the fenestration unit 10 underlying the first anchoring clip 102a (e.g., a portion of the perimeter P of the frame 16).

The receiver 122 has a retaining lip 132 and a retention member 134. The retaining lip 132 acts as both a guide and a retainer under which the coupling bracket 112 may be slid. The retaining lip 132 may define a first side portion 132a and a second side portion 132b toward the edges of the retaining pocket 130 for securing corresponding portions of the coupling bracket 112 within the retaining pocket 130. The first side portion 132a and the second side portion 132b may be raised relative to an outer perimeter, or outer edge portion, of the receiver 122 to receive a portion of the coupling bracket 112. As referenced above, the first orientation feature 111a may be defined on at least one of the first and second side portions 132a, 132b by a curved cutout. The cutout may be the shape of a half circle, as shown, or take any of a variety of shapes (e.g., triangular, square, or others). The first orientation feature 111a may include a surface feature (e.g., etching, stamping, embossing) or marking (ink, paint, or the like) as desired.

The retention member 134 may be formed by a portion of the retaining lip 132. As shown in FIG. 18, the receiver 122 includes a pair of cutouts 140 forming a flex tab 142 of the retention member 134 therebetween that is resiliently deflectable and spring-loaded. When receiving the coupling bracket 112, the retention member 134 may lift away from the frame 16 to create space within the retaining pocket 130 for the coupling bracket 112. The movement of the retention member 134 may cause stress on the carrier bracket 110, and the pair of cutouts 140 may be shaped to relieve or reduce the amount of stress applied to the retention member 134 when receiving the coupling bracket 112. For example, the pair of cutouts 140 have a length L and width that may be configured to protect the retention member 134 from yielding during insertion of the coupling bracket 112. A size of the cutouts 140 may be selected such that the insertion force required to be applied to the carrier bracket 110 in order to insert the coupling bracket 112 does not exceed 10 lbs, optionally 9 lbs, optionally 8 lbs, optionally 7 lbs, optionally 6 lbs, optionally 5 lbs, optionally 4 lbs, optionally 3 lbs, optionally 2 lbs, or even optionally 1 lb.

Although the insertion force to insert the coupling bracket 112 into the carrier bracket 110 are relatively low, the coupling bracket 112 and the carrier bracket 110 form a strong mechanical interlock with each other. The strong mechanical interlock helps keep the coupling bracket 112 coupled within carrier bracket 110 (e.g., within the retaining pocket 130). When the first anchoring clip 102a is in the second, installation configuration (FIGS. 2-4A), and anchored to the rough opening framing, the first anchoring clip 102a provides wind-load resistance to the fenestration unit 10.

As shown in FIGS. 17 and 20, the retention member 134 further includes one or more catches 150, also described as a tooth 150 or a pawl 150, for engaging with the coupling bracket 112 and reducing drag on the coupling bracket 112 during insertion into the carrier bracket 110. The one or more catches 150 may define a ramp edge 151 on an inner edge portion of the catches 150 that extends between a first end 153 of the catches 150 and a second end 155 of the catches 150. The ramp edge 151 may be sloped, or curved, inward to engage a portion of the coupling bracket 112 during insertion into the carrier bracket 110. For example, the one or more catches 150 may engage an insert guide 172 (FIG. 21) on the coupling bracket 112 to encourage the coupling bracket 112 to correctly seat within the carrier bracket 110 (e.g., self-loading). The insert guide 172 may contact the ramp edge 151 of the one or more catches 150 during insertion, as further described below. The second end 155 of the catches 150 may be sloped or curved and define an engagement edge 157. The curved engagement edge 157 helps reduce friction between the carrier bracket 110 and the coupling bracket 112 during engagement by minimizing contact with an upper surface of the coupling bracket 112 and by reducing instances of sharp corners (e.g., as opposed to an orthogonal extending catch 150) dragging along a surface of the coupling bracket 112 during insertion of the coupling bracket 112 into the carrier bracket 110. This reduction of friction helps keep insertion forces low (e.g., so as to not exceed 8 lbs).

In use, the flex tab 142 may be outwardly deflected to release, or translate, the one or more catches 150 in an outward direction, and once released the flex tab 142 will resiliently flex back into its original position. As shown in FIG. 16, the backplate 120 may include one or more receiving slots 152. To minimize stress forces on the receiver 122, the receiver 122 is kept in a relatively flat configuration relative to a longitudinal axis in both the first, stowed configuration (FIG. 4B) and second, installation configuration (FIG. 4A). The one or more receiving slots 152 may assist in maintaining the receiver 122 in the relatively flat configuration. In some embodiments, the one or more catches 150 may have a length that contacts the backplate 120. In such embodiments, the receiving slots 152 may receive a portion of the ends of the one or more catches 150 to maintain the receiver 122 in a relatively flat orientation. In other embodiments, the one or more catches 150 may be shorter such that they do not contact the backplate 120 and are not received by the receiving slots 152. In general, differences in the length of the one or more catches 150 may be due to machine tolerances, and the receiving slots 152 may correct for the differences in length to keep the receiver 122 relatively flat. These receiving slots 152 may enhance the overall resistance to pullout forces that the retention member 134 may exhibit without being released.

As shown, in FIGS. 17-19, The retention member 134 further includes a release handle 144 that projects relative to the flex tab 142. For example, the release handle 144 may be oriented to project toward the front, or interior side, of the frame 16, the release handle 144 being operable to be lifted away from the frame 16 to actuate, or release, the retention member 134 from one or more of the detents 174 of the coupling bracket 112 (e.g., as shown in FIGS. 21-22). Actuation of the release handle 144 allows the installer to easily transition the first anchoring clip 102a between the stowed configuration (FIGS. 1 and 4B) and the deployed configurations (FIGS. 2-4A).

FIGS. 21-23 show the coupling bracket 112 isolated from the first anchoring clip 102a, according to some embodiments. FIG. 21 illustrates a top-oriented perspective view of the coupling bracket 112, FIG. 22 illustrates a bottom-oriented side view thereof, and FIG. 18 illustrates a rear-oriented side-view thereof. As shown, the coupling bracket 112 includes a first leg 114 and a second leg 116 extending from the first leg 114 and an angular offset (e.g., at an approximately orthogonal angle). The angular offset (e.g., orthogonal offset) of the first leg 114 and second leg 116 may help improve accuracy in gauging a wall depth of the rough opening framing. During installation, because the second leg 116 sits along an interior side of the rough opening framing, the coupling bracket 112 is held flush against the perimeter of the rough opening framing and may act as a datum, or an anchoring point during wall depth gauging. The first leg 114 and the second leg 116 may be pre-bent prior to installation (e.g., by a manufacturer). As shown, the first and second legs 114, 116 may have one or more gussets 160 or other reinforcing features to help reinforce the first and second legs 114, 116 against relative bending and retain the orthogonal angle offset. The one or more gussets 160 may also create a space (e.g., an air space or gap) between the frame 16 and the face of the coupling bracket 112. This space or gap may help prevent damage (e.g., abrasion) to the coupling bracket 112 or the frame 16 when shipped in the stowed configuration (FIGS. 1 and 4B), and/or may make the coupling bracket 112 easier to access for removal from the stowed configuration, or may have other advantages. When the first anchoring clip 102a is in the installation configuration (FIGS. 2 and 4A), a marking 161 created by the one or more gussets 160 may be visible on the perimeter of the frame 30 (e.g., at an edge of the frame 30) that acts as a visual indicator of the location of the first anchoring clip 102a. For example, during assembly in the installation configuration, the gussets 160 may be pressed into the edge of the frame to provide visual indicators as to the anchoring clip location (e.g., vertically) along the frame. The marking 161 may be used by a downstream installer (e.g., a carpenter) for ease of locating the first anchoring clip 102a after the fenestration unit 10 has been installed (e.g., the anchoring clip may be difficult to see after drywall installation or other finishing, and a carpenter may wish to avoid driving nails, screws, or other fasteners into the anchoring clip(s)).

In the second, installation configuration, the first leg 114 is configured to be slidably received by the carrier bracket 110 and the second leg 116 is configured to be secured to framing of the rough opening (RO) in the building structure using one or more fasteners (e.g., nails or screws). The fasteners may be received through the one or more fastener apertures 180 defined through a thickness of the second leg 116. As shown, the fastener apertures 180 may be misaligned or offset from each other along the second leg. The offset helps to prevent damage to the wood of frame 16 during structural loading, or in other words, helps to prevent damage when the fasteners are received by the frame 16. In the second, installation configuration, the second leg 116 may be configured to rest flat against the rough opening framing when the fenestration unit 10 is installed within the rough opening (RO). In the first, stowed configuration (FIGS. 1 and 4B), the first leg 114 is slidably received by the carrier bracket 110 and the second leg 116 may instead extend along a portion of the fenestration unit 10 (e.g., extend in the opposite direction from the second, installation configuration). In some examples, as shown in FIG. 1, the first leg 114 extends toward the glazing units 34, 50 in the first stowed configuration. If desired, the first and second legs 114, 116 may be reversible in function wherein both the first and second legs 114, 116 are configured to be slidably received by the carrier bracket 110 and both are configured to be secured to the framing surrounding the rough opening (RO). In such embodiments, the first and second legs 114, 116 may be gauged to different wall depths.

In various embodiments, the first anchoring clip 102a may be packaged in the first, stowed configuration (FIG. 4B) for shipping. The first, stowed configuration helps to protect the first anchoring clip 102a in shipping and may require less packaging compared to shipping the first anchoring clip 102a in the second, installation configuration. Upon receipt, and prior to or during installation of the fenestration unit 10, the first anchoring clip 102a may be transitioned from the first, stowed configuration (FIG. 4B) to the second, installation configuration (FIG. 4A).

As shown in FIG. 21, the second leg 116 of the coupling bracket 112 optionally includes a release aperture 162 through a thickness of the second leg 116. As can be visualized with reference to FIGS. 4 and 10-11, the release handle 144 is accessible (e.g., using a screwdriver or other tool) through the release aperture 162 from the interior, or front side of the fenestration unit 10. The release aperture 162 may also extend into the first leg 114, as shown. The release aperture 162 is generally positioned at the intersection, or corner between the first and second legs 114, 116.

As shown, the first leg 114 has first and second edges 166, 168 that are opposite one another, a length L1, and a leading end 170 at one end of the length L1 including an insert guide 172 in the form of a rounded projection. The insert guide 172 may assist with aligning and inserting the first leg 114 into the carrier bracket 110 as the leading end 170 is inserted into the carrier bracket 110. As shown, the coupling bracket 112 may be received at a generally central position within the retaining pocket 130. In instances where the coupling bracket 112 is inserted at an angle relative to the generally central position (e.g., off axis-loading) the ramp edge 151 may contact the insert guide 172 and correct alignment between the carrier bracket 110 and the coupling bracket 112. The contact between the ramp edge 151 and insert guide 172 helps guide the coupling bracket 112 to the generally central position within the retaining pocket 130. In some embodiments, upon insertion, the insert guide 172 engages the one or more catches 150 of the carrier bracket 110 to raise the receiver 122 and self-load within the retaining pocket 130. In particular, upon insertion of the coupling bracket 112 within the carrier bracket 110, the insert guide 172 may engage the ramp edge 151 (FIG. 20) of the one or more catches 150 by sliding under opposing edges of the ramp edge 151, which in turn, raises the retention member 134 of the receiver 122 and allows the coupling bracket 112 to self-load within the retaining pocket 130. This action helps to maintain the low insertion force that does not exceed approximately 8 lbs. The insert guide 172 may also define a recessed portion 173 on either side of the insert guide 172 that helps reduce friction upon insertion of the coupling bracket 112 within the carrier bracket 110 by helping ensure the one or more catches 150 minimally contact the coupling bracket 112 prior to the insert guide 172 lifting the carrier bracket 110. Additionally, the lifting of the receiver 122 and the curved engagement edge 157 helps minimize contact and friction between the coupling bracket 112 and the carrier bracket 110. In some embodiments, including embodiments where the first and second legs 114, 116 are reversible in function, both the first leg 114 and the second leg 116 may include the insert guide 172.

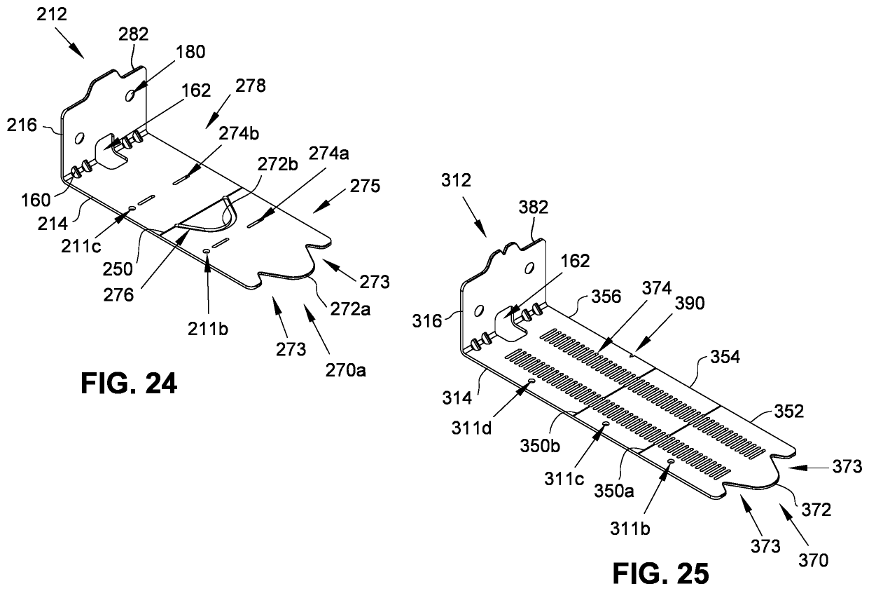

The first leg 114 also has one or more detents 174 (a pair of detents 174, as shown) at one or more longitudinal positions along the length L1 of the first leg 114. The one or more detents 174 may take the form of slots through the thickness of the first leg 114 as shown, but other configurations (e.g., partial depth detents) may also be employed. The one or more detents 174 may receive the one or more catches 150 of the carrier bracket 110 when the first anchoring clip 102a is in the second, installation configuration. The one or more longitudinal positions of the one or more detents 174 are selected according to a desired offset, or pre-selected depth, of the second leg 116 from the front face 22 of the frame 16 when the coupling bracket 112 is in the second, installation configuration. The desired offset, or pre-selected depth may generally correspond to a wall depth of the rough opening framing and a thickness of exterior sheeting and/or insulation. The standard wall depth is defined by both a depth of the wall/framing (e.g., a 2×4, a 2×6, or a 2×8 depth) and an exterior sheeting thickness (e.g., a ½-inch or 7/16-inch exterior sheeting thickness). In the embodiment of FIGS. 13-14, the one or more detents 174 are positioned for gauging against a standard 2×4 wall depth. In other embodiments, such as shown in FIGS. 24-25, multiple pairs of detents 174 may be present along the length L1 of the first leg 114 for adjustability at different wall depths, including non-standard wall depths (e.g., any depth between the 2×4, 2×6, or 2×8 depths with exterior sheeting thickness). In some embodiments, such as shown in FIG. 19, the coupling bracket 112 may include a plurality of detents positioned at increments (e.g., ⅛-inch increments or less) along a portion of the length of the first leg 114.

The second leg 116 defines one or more fastener apertures 180 configured to receive one or more fasteners (not shown), such as screws or nails. The second leg 116 also has a length L2, which may be selected to ensure sufficient overlap with the framing surrounding a rough opening (RO) (not shown) to ensure the fasteners are able to bite into the RO framing. The fastener apertures 180 may be recessed or countersunk in order to allow screw heads to be mounted flush. In this way, the fasteners will not interfere with drywall or other wall treatments installed over the second leg 116.

The coupling bracket 112 may be fastened to the rough opening (RO) and removed from the RO without damaging the components of the coupling bracket 112. The coupling bracket 112 may be removed from the RO using standard tools (e.g., a screwdriver). The one or more fastener apertures 180 may be placed at different lengths along the second leg 116 to account for differences in drywall thickness and lengths of different spaces between the frame 16 and the RO.

The second leg 116 may include a tab 182 on one side of the length L2. In some embodiments, the tab 182 has a different shape than the insert guide 172 of the first leg 114 such that the installer can quickly visualize which end is inserted into the carrier bracket 110. The shape of tab 182 may also be used to distinguish between different coupling bracket embodiments, such as coupling bracket 212 (FIG. 24) and/or coupling bracket 312 (FIG. 25), where the shape of each tab is different. For example, the tab 182 of the coupling bracket 112 may be a different shape than the tab 282 (FIG. 24) of the coupling bracket 212 and may be a different shape than the tab 382 (FIG. 25) of the coupling bracket 312. Using different shapes may allow an installer to quickly distinguish which of the coupling brackets 112, 212, or 312 is installed.

As shown in FIGS. 1-3, the plurality of anchoring clips 102 are secured to the frame 16 at a desired depth from the front face 22 of the frame 16 (e.g., the carrier bracket 110 can be mounted flush or approximately flush to the front face 22 of the frame 16). The plurality of anchoring clips 102 are optionally secured proximate the tops and bottoms of the first and second jambs 25, 27 respectively, with two (2) additional anchoring clips 102 positioned on each of the first and second jambs 25, 27 at an intermediate position, respectively. In some embodiments, the plurality of anchoring clips 102 may be spaced apart at substantially similar intervals along the first and second jambs 25, 27 respectively.

In the second, installation configuration as shown in FIGS. 2-4A, the second legs of each of the coupling brackets, including the second leg 116 of the coupling bracket 112 (FIG. 21), projects away from the center of the frame 16, outwardly from the perimeter P (FIG. 1) of the frame 16. In some embodiments, the second legs 116 extend substantially flush to the rough opening framing in the second, installation configuration. As shown in FIG. 1, when in the stowed configuration, the second leg 116 of each of the anchoring clips 102, including the second leg 116 of the coupling bracket 112 (FIG. 21), projects inwardly away from the perimeter P (FIG. 1) toward the center of the frame 16. In some embodiments, the second leg 116 extends substantially flush to the front face 22 of the frame 16 when the coupling brackets 112 are in the stowed configuration.

FIG. 24 shows another design for the coupling bracket in the form of coupling bracket 212. The coupling bracket 212 may include features similar to the coupling bracket 112 of FIGS. 21-23 and may be compatible for use with carrier bracket 110 (FIG. 15). FIG. 25 shows a top-oriented perspective view of the coupling bracket 212. The coupling bracket 212 includes a first leg 214 and a second leg 216 extending from the first leg 214 and an angular offset (e.g., at an approximately orthogonal angle).

As shown, the coupling bracket 212 includes one or more detents 274a, 274b, or one or more pairs of detents, along a length of the first leg 214. The one or more detents 274 may be substantially similar to the one or more detents 174 of the coupling bracket 112 as described above. As shown, the coupling bracket 112 includes a first pair of detents 274a and a second pair of detents 274b. In some embodiments, multiple pairs of detents 274a, 274b permit the retention member 134 (FIG. 17) of the carrier bracket 110, and more specifically the one or more catches 150 (FIG. 20), to be releasably locked at first and second offset distances from the front of the frame 16 as desired. For example, the coupling bracket 212 may be gauged to a 2×6 wall depth at the first pair of detents 274a to define the second offset distance and may be gauged to a 2×4 wall depth at the second pair of detents 274b to define the first offset distance. As such, the first anchoring clip 102b is configured to accommodate different installation depths, for example to accommodate different thickness wall coverings (e.g., drywall, sheeting, exterior sheeting, and/or foam insulation) or fenestration unit features (e.g., jamb extended fenestration units or handles).

As shown, the coupling bracket 212 may include one or more coin lines or indented lines 250 across at least a portion of the width of the coupling bracket 212. As shown, the indented line 250 is positioned along the width of the first leg 214, but the indented line 250 may be positioned along either of the first leg 214 or the second leg 216. The indented line 250 may allow the installer to shorten the length of the coupling bracket 212. For example, after the installer reinserts the coupling bracket 212 into the carrier bracket 110, the coupling bracket 212 may extend too far away from the frame 16, which may affect the installation of features around the fenestration unit 10 such as drywall or paint. To shorten the coupling bracket 212, the installer may bend the first leg 214 back-and-forth along the indented line 250 such that a first portion 275 of first leg 214 is broken off and removed. When the first portion 275 is removed, a second portion 278 remains for coupling to the carrier bracket 110. Shortening the coupling bracket 212 may increase adjustability of the first anchoring clip 102a to accommodate various wall depths as desired. For example, shorting the coupling bracket 212 may allow the coupling bracket to gauge against a shorter 2×4 wall depth instead of a longer 2×6 wall depth.

Similar to the coupling bracket 112, the coupling bracket 212 may include at least one orientation feature 211 that gives the installer a visual indication that the coupling bracket 212 is properly engaged and seated within the carrier bracket 110 when the first anchoring clip 102b is in the second, installation configuration, and that the first anchoring clip 102b is gauged to the correct wall depth. The coupling bracket 212 may define a second orientation feature 211b defined by the first portion 275 of the first leg 214 and a third orientation feature 211c defined by the second portion 278 of the first leg 214, both of which are complementary in shape to the first orientation feature 111a of the carrier bracket 110. The second and third orientation features 211b and 211c may be defined through a thickness of the first leg 214 and may be rounded, though other shapes are contemplated. In embodiments in which the coupling bracket 212 is gauged to the 2×6 wall depth, the first orientation feature 111a of the carrier bracket 110 aligns with the second orientation feature 211b of the coupling bracket 212. In embodiments in which the first anchoring clip 102b is gauged to the 2×4 wall depth, the first orientation feature 111a aligns with the third orientation feature 211c of the coupling bracket 212.

FIG. 25 shows another design for the coupling bracket in the form of coupling bracket 312. The coupling bracket 312 may include features similar to the coupling bracket 112 of FIGS. 21-23 and coupling bracket 212 of FIG. 24. The coupling bracket 312 may be compatible for use with carrier bracket 110 (FIG. 15). FIG. 25 shows a top-oriented perspective view of the coupling bracket 212. The coupling bracket 312 includes a first leg 314 and a second leg 316 extending from the first leg 314 and an angular offset (e.g., at an approximately orthogonal angle).

As shown, the coupling bracket 312 has a plurality of pairs of detents 374 along the length of the first leg 314. In some examples, the plurality of pairs of detents 374 permit the retention member 134 (FIG. 17) of the carrier bracket 110, and more specifically the one or more catches 150 (FIG. 20), to be releasably locked at first and second offset distances from the front of the frame 16 as desired. For example, the second offset distance may be approximately 0.125 inches greater than the first offset distance, such that the first anchoring clip 102c is configured to accommodate different installation depths, for example to accommodate different thickness wall coverings (e.g., exterior sheeting and/or insulation) or fenestration unit features (e.g., jamb extended fenestration units or handles). The pairs of detents 374 may be substantially similar to the detents 174 (FIGS. 21-22) described with respect to the first anchoring clip 102a. For example, the plurality of pairs of detents 374 permit even further adjustability, across a plurality of depths at any desired increment (e.g., 0.0625 inches, 0.125 inches or other). In other embodiments, the number of plurality of pairs of detents 374 may be minimized to reduce error in installation.

As shown, the first anchoring clip 102c may be adjustable between a 2×8 wall depth, a 2×6 wall depth, a 2×4 wall depth, and non-standard wall depths therebetween, as described above. The first anchoring clip 102c may optionally include one or more coin lines, or indented lines 350a, 350b, similar to the indented lines 250 of the first anchoring clip 102b, described above. As shown, the first anchoring clip 102c includes a first indented line 350a and a second indented line 350b, where both the first and second indented lines 350a and 350b are positioned along a width of the first leg 314. The first indented line 350a may be positioned between a first portion 352 of the first anchoring clip 102c and a second portion 354 of the first anchoring clip 102c. In embodiments where the installer bends the first indented line 350a, the first portion 352 may be removed and the length of the first anchoring clip 102c is shortened. In some embodiments, this allows the first anchoring clip 102c to be shortened to gauge against a 2×6 wall depth instead of a 2×8 wall depth, or a non-standard wall depth less than the 2×6 wall depth. The second indented line 350b may be positioned between the second portion 354 of the first anchoring clip 102c and a third portion 356 of the first anchoring clip 102c. In embodiments where the installer bends the second indented line 350b, the second portion 354 (and the first portion 352 if not previously removed) may be removed and the length of the first anchoring clip 102c is further shortened. In some embodiments, this allows the first anchoring clip 102c to be shortened to gauge against a 2×4 wall depth instead of a 2×6 wall depth, or a non-standard wall depth less than the 2×4 wall depth. Shortening the coupling bracket 312 may further permit the adjustability of the first anchoring clip 102c. The first anchoring clip 102c may further define a notch, or a slot 390, along a portion of the length of the first leg 314 to assist with gauging to the wall depth.

Similar to the coupling brackets 112, 212 the coupling bracket 312 may include at least one orientation feature 311 that gives the installer a visual indication that the coupling bracket 312 is properly engaged and seated within the carrier bracket 110 in the second installation configuration, and that the first anchoring clip 102a is gauged to the correct wall depth. The carrier bracket 110 may include the first orientation feature 111a (FIG. 15) and the coupling bracket 312 may define a second orientation feature 311b defined through a thickness of the first portion 352 of the first leg 314, a third orientation feature 311c defined through a thickness of the second portion 354 of the first leg 314, and/or a fourth orientation feature 311d defined through a thickness of the third portion 356 of the first leg 314, all of which are complementary in shape to the first orientation feature 111a of the carrier bracket 110. The second, third, and fourth orientation features 311b, 311c, and 311d may be rounded, though other shapes are contemplated. In embodiments in which the coupling bracket 312 is gauged to the 2×8 wall depth, the first orientation feature 111a of the carrier bracket 110 aligns with the second orientation feature 311b of the coupling bracket 312. In embodiments in which the first anchoring clip 102c is gauged to the 2×6 wall depth, the first orientation feature aligns with the third orientation feature 311c. In embodiments in which the first anchoring clip 102c is gauged to the 2×4 wall depth, the first orientation feature 111a of the carrier bracket 110 aligns with the fourth orientation feature 311d. In embodiments where the first anchoring clip 102c is gauged to a non-standard wall depth (e.g., between any of the 2×4, 2×6, and 2×8 wall depths), the orientation feature 311 may not be aligned. In such embodiments, the installer may listen for an audible cue, or a click, when the coupling bracket 312 engages the carrier bracket 110. The click may also indicate to the installer that the components of the first anchoring clip 102a are properly engaged and gauged to the rough opening framing. Further details on the audible cue are included below.

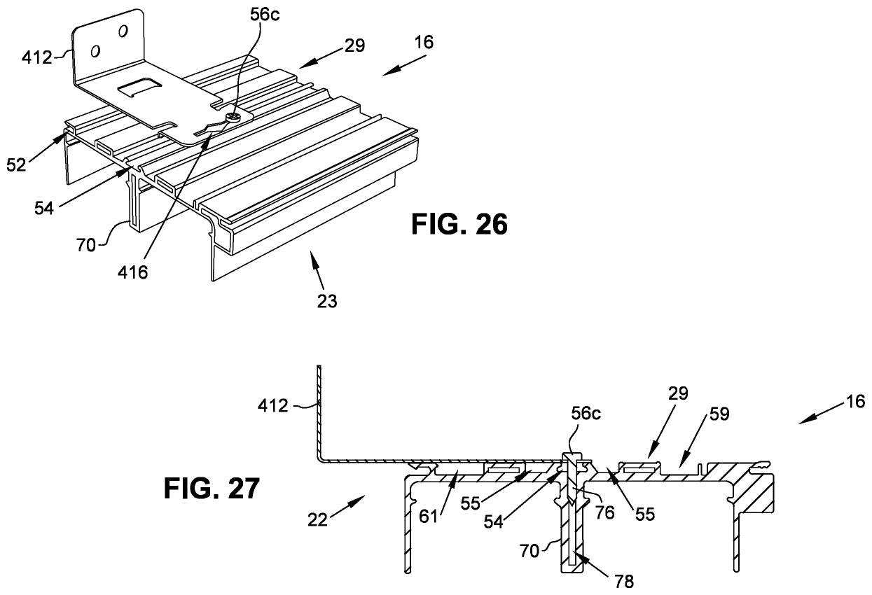

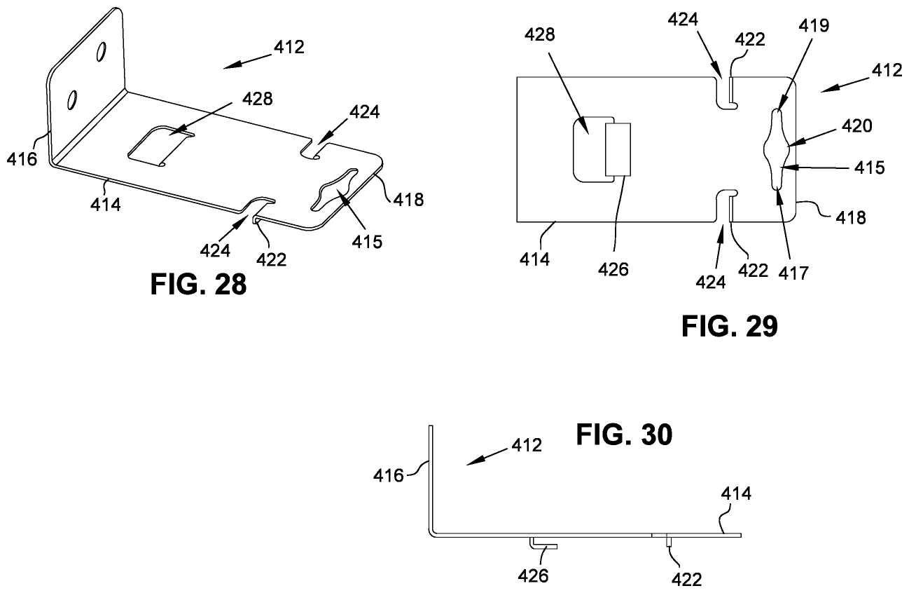

FIGS. 26-30 show another design for the coupling bracket in the form of coupling bracket 412. The coupling bracket 412 may include features similar to each of the coupling bracket 112 of FIGS. 21-23, the coupling bracket 212 of FIG. 24, and the coupling bracket 312 of FIG. 25. The coupling bracket 412 may also include one or more features of the carrier bracket 110 of FIG. 15. FIGS. 26-27 show the coupling bracket 412 coupled to the frame 16, and in particular coupled to the thermal break 70. As shown, the coupling bracket 412 may be coupled directly to the frame 16 without use of the carrier bracket 110. FIG. 28 shows a top-oriented perspective view of the coupling bracket 412, FIG. 29 shows a bottom-oriented side view thereof, and FIG. 30 shows a side-view thereof.

The coupling bracket 412 includes a first leg 414 and a second leg 416 extending from the first leg 414 at an angular offset (e.g., at an approximately orthogonal angle). The coupling bracket 412 may be transitioned between a fastened configuration and an unfastened configuration. The first leg 414 defines a first aperture 415 positioned near an end 418 of the first leg. The first aperture 415 is defined by a bowtie shape including first and second ends 417, 419 and a relatively wide portion 420 therebetween. A fastener 56 (e.g., screw 56c) may be received within the relatively wide portion 420 of the first aperture 415 in the unfastened configuration. In the unfastened configuration, the fastener 56 may loosely couple the coupling bracket 412 to the frame 16. When the fastener 56 is received within the first aperture 415, the coupling bracket 412 may be slid laterally about fastener 56 such that fastener 56 is received into one of the first and second ends 417, 419 of the first aperture 415 defining an intermediate configuration. When the fastener 56 is positioned through the first or second ends 417, 419, the fastener 56 may then be tightened (e.g., using a screwdriver or other tool) to secure the coupling bracket 412 to the frame 16 in the fastened configuration. In other embodiments, tightening the fasteners with the screwdriver is not required. Although one fastener 56 is shown, two fasteners 56 may be used to secure the coupling bracket 412 in the fastened configuration (e.g., a first fastener received in the first end 417 and a second fastener received in the second end 419). As described with respect to FIGS. 5-6, a body portion 76 of the fastener 56 may be received with the receiving pocket 78 of the thermal break 70 to hide the fastener 56 from view through either glazing units 34, 50. Although screw 56c is shown in FIGS. 27-28, other fasteners including cams 56a, 56b or rivets may be used.

The first leg 414 defines one or more catches 422, which may be similar to the one or more catches 150 of the carrier bracket 110 (FIG. 15). The one or more catches 422 are configured to contact a feature of the frame 16, such as a groove 55 (FIG. 27), to assist in positioning the coupling bracket 412 to the frame 16. The one or more catches 422 may be received within and rest against the groove 55 of the frame 16 to couple the coupling bracket 412 and frame 16.

The first leg 414 may define one or more cut outs 424 through the thickness of the first leg 414, where the one or more cut outs 424 are positioned adjacent the one or more catches 422. The one or more cut outs 424 may be formed as a bi-product of a manufacturing process (e.g., a stamping process).

The first leg 414 may define a hook 426, similar to the hook 104 of the carrier bracket 110 (FIG. 19). The hook 426 may extend outwardly from the first leg 414 and be configured to engage with the frame 16 to couple the coupling bracket 412 to the frame 16. As such, the hook 426 is configured to retain the carrier bracket 110 on the frame 16 and is configured to carry the structural load of the fenestration unit 10 that is supported by the anchoring clip 102. For example, the hook 426 may engage the first channel 52 of the frame 16 (FIG. 4A). The hook 426 and the one or more catches 422 may be positioned along the first leg 414 such that they align with one or more features of the frame 16 to facilitate coupling thereto. The catches 422 are configured to carry the structural load of the anchoring clip such that the structural load is at least partially taken off the fastener (e.g., cam 56a, 56b, or fastener 56c).

The first leg 414 also defines a second aperture 428 through a thickness of the first leg 414. The second aperture 428 may a feature from the manufacturing process (e.g., stamping process). The hook 426 is positioned adjacent to second aperture 428. The second aperture 428 may allow the installer to access the hook 426 using a tool to assist with either installation or removal of the coupling bracket 412 from the frame 16.

The coupling bracket 412 may be shipped in a stowed configuration (FIG. 4B), similar to the configuration shown in FIGS. 1 and FIG. 4B. In the stowed configuration, the coupling bracket 412 may be coupled to the frame 16 such that the second leg 416 extends inward toward a center of the frame 16. One or more protective elements (not shown) may be used to cover the hook 426 and the one or more catches 422 for protection in shipping. The one or more fasteners 56 may secure the coupling bracket 412 in the stowed configuration against the frame 16. In other embodiments, the coupling bracket 412 may be shipped separately from the frame 16 and coupled to the frame 16 on-site.

### Installation Stabilizer System

As shown in FIG. 1, the installation stabilizer system 500 includes at least one retainer 502, also described as a stabilizer clip 502. The retainer 502 is optionally applied to frame 16 prior to any installation steps being undertaken, and at a location remote from the installation site (e.g., at a manufacturing facility). As shown, one or more of the retainers 502 are located on the frame head 29 of the fenestration unit 10. In some embodiments, two retainers 502 are located on the frame head 29 of the fenestration unit 10, though more retainers 502 are contemplated. One or more retainers 502 may also be optionally coupled to the first and second jambs 25, 27.

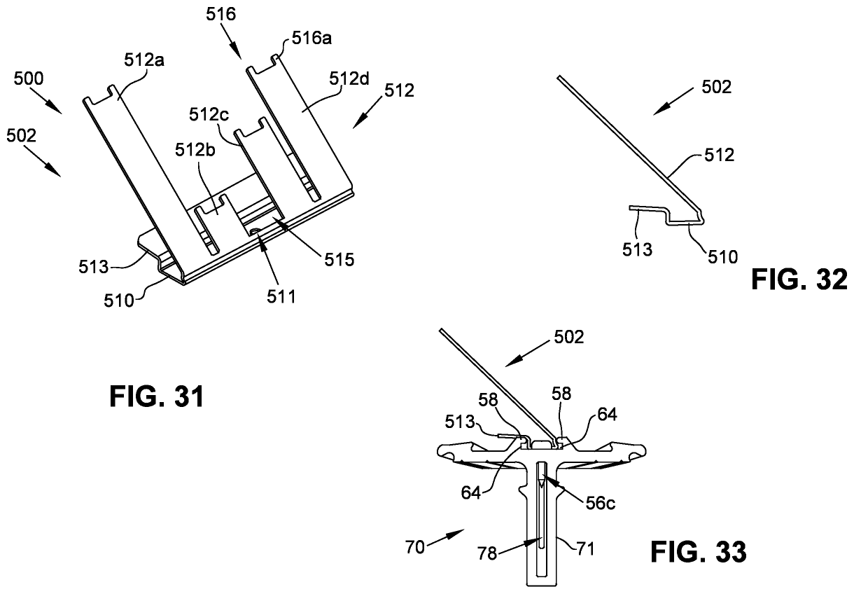

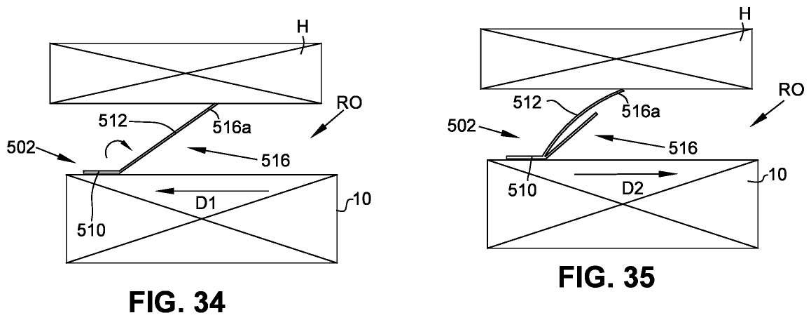

FIG. 31 is an isometric, or perspective view and FIG. 32 is a side view of one design for the retainer 502, according to some embodiments. FIGS. 31-32 show the retainer 502 in a natural, unbiased state. FIG. 33 is a side-oriented cross-sectional view of the retainer 502 coupled to the frame head 29 (e.g., a thermal break 70) of the fenestration unit 10. Generally, the retainer 502 is configured to permit insertion of the frame 16 within the rough opening (RO) in the structure (not shown) in a first insert direction D1 (FIG. 33) and resist extraction of the frame 30 from the opening in a second extraction direction D2 (FIG. 34).

As shown in FIGS. 31-32, the retainer 502 includes a base 510 configured to be secured to the frame 16 (FIG. 1). In some examples, as shown in FIG. 33, the base 510 may be engaged with and nest within a second channel 54 of the thermal break 16 of frame 16. The base 510 may define an aperture 511 configured to receive fastener 56c (e.g., a screw) to couple the retainer 502 and the frame 16. As shown in FIG. 33, similar to the fasteners 56c described with respect to the anchoring clip 102 (FIG. 11), portions of the thermal break 70 are configured to hide portions of the fastener 56c (e.g., a body portion 76) from view through portions of the frame 16. However, other attachment methods, such as adhesion, are contemplated.

In some embodiments, the base 510 also defines an extension portion 513 extending laterally from a remainder of the base 510. The base 510 may be recessed relative to the extension portion 513. As shown in FIG. 33, the extension portion 513 may abut against an upper surface of the sidewalls 58 of the thermal break 70. The extension portion 513 may offer additional support and counterweight to the retainer 502 when the retainer 502 is biased during installation.

As shown in FIG. 31, the retainer 502 may also include a plurality of flex arms 512 include first through fourth flex arms 512a-512d, although any number of flex arms (one, two, three, five, etc.) are contemplated. As shown, the plurality of flex arms 512a-512d may be of different lengths to accommodate different spaces, or a range of space sizes, between the frame 16 and the header of the rough opening (RO) (FIG. 34). As shown in FIG. 31, the retainer 502 may define a space 515 between the middle flex arms 512b, 512c. This allows an installer to access the aperture 511 and/or fastener 56c.

As shown in FIG. 31, the engagement features 516 of the plurality of flex arms 512 each include an engagement edge 516a including one or more sharpened edges, projections, or teeth for biting into (e.g., two projecting teeth), or frictionally engaging the header H of the framing of the rough opening (RO) (FIG. 34). In different terms, the engagement feature 516 includes one or more teeth configured to bite into the material defining the rough opening (RO) upon movement of the frame in the interior direction (e.g., D2 of FIG. 35). In some embodiments, the sharpened edges or teeth are cut edges of material (e.g., metallic material) that may be sharp with or without additional mechanical sharpening.

As shown in FIGS. 34-35, in various embodiments, during insertion of the frame 16 in the first insert direction D1 one or more of the flex arms 512 (e.g., the first of the flex arm 512a if a large gap is present or all four flex arms 512 if a smaller gap is present between the header H and the frame 16) of the retainer 502 bends or is deflected in a first flex direction and upon movement of the frame 16 in the second extraction direction D2 such that the flex arm 512 bends in a second flex direction to resist movement of the frame 16 in the second direction D2 (e.g., toward the interior side).

In some embodiments, the retainer 502 is configured to be secured in a constrained state (compressed downward) such that the retainer 502 is compressed flat against the frame 16. The retainer 502 may be held in the constrained state using a securement member (e.g., tape). The securement member may be removed to release the retainer 502 to a deployed state such that the retainer 502 projects outwardly from the frame 16 (e.g., in a similar manner to that shown in FIG. 1).

FIG. 34 is a schematic representation of the retainer 502 engaged with a header H of the framing of a rough opening (RO). As shown FIG. 34, the fenestration unit 10 is configured such that as the fenestration unit 10 is slid in the exterior direction, or the first insert direction D1, and is being inserted from an interior side of the rough opening RO, the retainer 502, and specifically the flex arm 512 serves as a spring body that deflects to compress in height as the engagement edge 516a of the engagement feature 516 bites into the header H. The retainer 502 may self-deploy against the header H of the framing of the rough opening (RO) during installation without action or intervention by the installer. As shown in FIG. 34, during compression, the engagement feature 516 slides against the header H. This compression and sliding action permits the retainer 502, and thus the fenestration unit 10, to be inserted in the exterior direction, or the first insert direction D1, with a first, relatively lower resistance to insertion. In various embodiments, the engagement edge 516a does not bite into, or otherwise prevent sliding of the engagement edge 516a as it is slid across the header H. This may be due to the angle of the engagement edge 516a. The insertion force, or force required to move in the first direction D1 may be 1 lb or less, more than 1 lb, more than 10 lbs, or more than 15 lbs, for example. Generally, the fenestration unit 10 is tipped, or tilted back in the exterior direction and into place for final seating during insertion in the first direction D1.

FIG. 35 shows the retainer 502 deforming, and resisting movement, as the fenestration unit 10 and the retainer 502 are moved in the interior direction, or the second extraction direction D2. As shown, the flex arm(s) 512 rotate back, or kick up (or kick down, not shown) as the engagement edge(s) 516a of the engagement feature 516 bites into the head H and inhibits sliding of the engagement feature(s) 516 against the header H. In some examples, the flex arm(s) 512 bend or flex as a result of the movement. The extraction or tipping force, or force required to move in the second direction D2 after seating may be 1 lb or less, more than 1 lb, 10 lbs or more, at least 15 lbs, or 15 lbs or more, for example. In some examples, the extraction force is 80 lbs or more, or approximately 88 lbs. Generally, a higher required extraction or tipping force (e.g., as compared to the insertion force) helps ensure the fenestration unit 10 remains in place after being inserted into the rough opening (RO) to permit subsequent levelling and/or securement procedures. The retainer's 502 ability to resist movement in the second extraction direction D2 may help prevent the fenestration 10 from falling out of the rough opening (RO) toward the interior.

In embodiments, any of the insertion force, extraction force, or retention force is determinable using a force gauge placed perpendicular to a vertical plane of the fenestration unit 10 on the exterior side of the fenestration unit 10 approximately eight inches from the top of the fenestration unit 10 along a vertical centerline of the fenestration unit 10. For the retention force, the force gauge may be pushed in an interior direction until the fenestration unit 10 is pressed out of the rough opening (RO) such that the force gauge obtains a maximum force for retention.

With insertion of the fenestration unit 10 into the rough opening (RO) the retainer 502 compresses and engages (e.g., bites) into the header H of the rough opening (RO) and optionally applies some degree of downward force on the fenestration unit 10. The function of the retainer 502 may be to help stabilize the fenestration unit 10 in the rough opening (RO) to help ensure the fenestration unit 10 does not fall back toward the interior (i.e., resists extraction in the second extraction direction D2). This self-retaining, or stabilizing feature helps allow a single installer (not shown) to complete leveling and centering tasks without having to hold the fenestration unit 10 in the rough opening (RO). As shown, the retainer 502 is compressible, and thus adjusts and adapts to a range of typical gap sizes between the frame head 29 and header H of the rough opening (RO). Additionally, the retainer 502 is flexible laterally, made from a spring like material, which permits side-to-side adjustment of the fenestration unit 10 within the rough opening (RO) as well as levelling of the fenestration unit 10 without substantially impeding those processes.

In some embodiments, the fenestration unit 10 may be extracted from the rough opening (RO) without damaging the retainer 502. In some embodiments, a tool (e.g., a flat metal plate) may be inserted between the rough opening (RO) framing and the fenestration unit 10 and the retainer 502 may be released from the rough opening framing and the fenestration unit 10 may be removed from the rough opening (RO). More specifically, one or more flex arms 512 or one or more engagement edges 516 of the retainer 502 may be removed from the rough opening framing using the tool such that the retainer 502 no longer bites into the rough opening framing. This removal method allows controlled release of the fenestration unit 10 from the rough opening (RO) without damaging to the retainer 502, or to the fenestration unit 10. The retainer 302 may be used again when re-installing the fenestration unit 10 within the rough opening (RO).

Although, in various examples, one or more retainers 502 are secured to one or more portions of the fenestration unit 10 (e.g., frame 16), in other examples, similarly designed retainers 502 are optionally secured to framing surrounding the rough opening (RO) and engage the fenestration unit 10 upon positioning of the fenestration unit 10 in the rough opening (RO).

### Weather Seal System

FIGS. 36A-36B illustrate a weather seal system 600 of the fenestration unit 10, according to some embodiments. The fenestration unit 10 of FIGS. 36A-36B may be substantially similar to the fenestration unit 10 of FIGS. 1-3, and may include similar features such as the anchoring clip system 100 and the installation stabilizer system 500 (FIG. 1). FIG. 36A shows a top-oriented perspective view of the fenestration unit 10 from the exterior side 14, with the weather seal system 600 in a stowed configuration. FIG. 36B illustrates the fenestration unit 10 from the exterior side 14, with the weather seal system 600 in a deployed configuration.

The weather seal system 600 may be remotely applied (e.g., at a manufacturing location) and act as an exterior water barrier. The weather seal system 600 may be biased to a deployed state or may be otherwise described as a “pop-up” fin. In various examples, the weather seal system 600 is initially provided (e.g., shipped or transported to the installation site) in a stowed, or flattened configuration (FIG. 35) against the frame 16 of the fenestration unit 10. This flattened, or stowed position can be described as a “180° position”. The weather seal system 600 may be held in the stowed position with a retaining assembly, as described below. After the fenestration unit 10 is installed and anchored (e.g., using one or more fasteners, such as screws or nails) the original installer (not shown) or another installer may separately proceed to the exterior side of the rough opening (RO) to remove the retaining assembly and transition the weather seal system 600 to the deployed state (FIG. 36B). In some examples, upon removal of the retaining assembly, the weather seal system 600 automatically pops-up, or projects outwardly from the frame 16 (e.g., at approximately 90° degrees) to rest against the exterior surface of the wall in which the rough opening (RO) is formed. As described below, the weather seal system 600 may include three-dimensional corner seals (e.g., factory applied and welded, adhered, or otherwise attached) to a head pop-up fin to provide protection against water infiltration, as described below.

In various examples, no fasteners (e.g., screws or nails) are used on the exterior side of the fenestration unit 10 (e.g., the fenestration unit 10 is secured entirely from the interior side of the rough opening (RO)). Flashing tape or other treatments may be applied around the perimeter of the fenestration unit 10, over the weather seal system 600 to seal the fenestration unit 10 to the exterior surface of the wall in which the rough opening (RO) is formed. In various examples, the exterior surface of the wall may include a weather resistant barrier (e.g., Tyvek® home wrap available from DuPont de Nemours, Inc.).

As shown in FIG. 36B, the weather seal system 600 includes a fin assembly 610 that is outwardly biased to project radially outward from the perimeter P of the frame 16 when unconstrained. FIG. 36A shows the fenestration unit 10 with various installation features in a stowed configuration. As shown in FIG. 36A, the weather seal system 600 also includes a retaining assembly 612 releasably securing the fin assembly 610 in a constrained state such that the fin assembly 610 is compressed toward the frame 16 in a stowed configuration.

As shown in FIG. 36B, the fin assembly 610 includes a plurality of fins 620, including a head fin 620a (also described as a top fin 620a), a first jamb fin 620b, and a second jamb fin 620c. As shown in FIG. 36B, the fin assembly 610 also optionally includes a first corner bridge seal 630 and a second corner bridge seal 632.

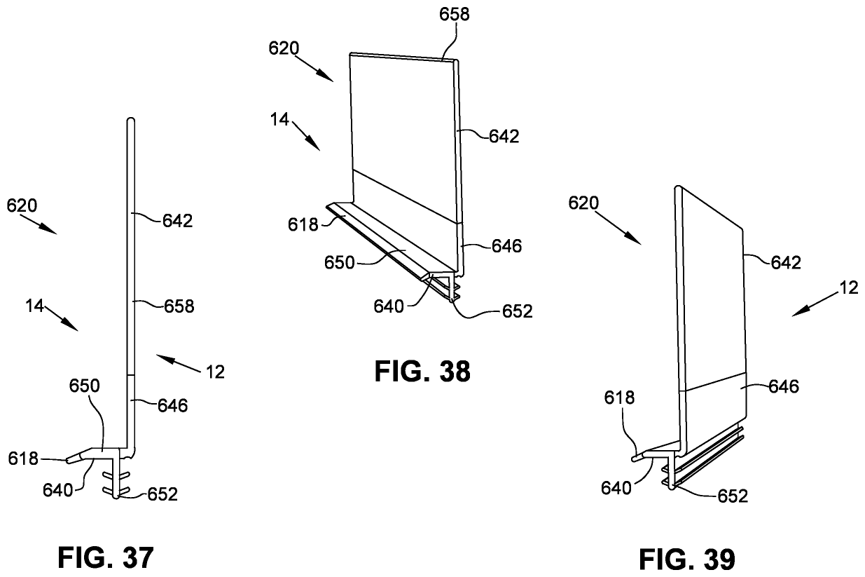

FIGS. 37-39 illustrate one embodiment of the plurality of fins 620 in a deployed configuration (FIG. 36B). FIG. 37 is an end view and FIGS. 38-39 are isometric views of one fin of the plurality of fins 620 (each fin of the plurality of fins 620 may have a substantially similar construction, with differences in length to correspond to the portion of the frame 16 to which they are attached). FIG. 38 illustrates the fin 620 from an exterior-facing side (e.g., exterior side 14 of the fenestration unit 10) and FIG. 39 illustrates the fin 620 from an interior-facing side (e.g., interior side 12 of the fenestration unit 10). As shown in FIGS. 37-39, each of the plurality of fins 620 has a coupling portion 640 and a projection portion 642, with a hinge portion 646 between the coupling portion 640 and the projection portion 642. The coupling portion 640 is coupled to the outer perimeter P (FIG. 36A) of the frame 16 (e.g., within an accessory groove of the frame 16) and the projection portion 642 is biased by the hinge portion 646 to project radially outward from the outer perimeter P of the frame 16 by the hinge portion 646. As shown in FIGS. 37-39, when in the deployed configuration, the hinge portion 642 may be biased in a substantially linear configuration such that the projection portion 642 extends substantially perpendicular (e.g., approximately 90° degrees) radially outward relative to the frame 16. In some embodiments, the coupling portion 640 may be coupled to the frame 16 via adhesion to the frame 16. However, other attachment methods are contemplated, including any of those previously described. In some embodiments, the hinge portion 646 is formed of a first material and the projection portion 642 is formed of a second material different than the first material. The first material of the hinge portion 646 may be a first polymeric material and the second material may be a second polymeric material that is different than the first polymeric material. Generally, the first material may be more flexible than the second polymeric material (e.g., the first material being elastic in nature and the second material being generally less elastic, or inelastic). In terms of manufacture, the coupling portion 640, the projection portion 642, and the hinge portion 646 may be co-extruded or co-molded parts.

In some embodiments, the first material is a Nitrile Thermoplastic Elastomer (TPE), such as that sold under the tradename Auroraflex™ by Aurora Plastics, for example, although a variety of materials are contemplated. In some embodiments, the second material is an inelastic material, such as a glass or mineral filled polypropylene, or a thermoplastic polyolefin, such as that sold under the tradename RAVATUF® 400X by Ravago Manufacturing Americas, for example, although a variety of materials are contemplated.

As shown, the coupling portion 640 includes an elongate, relatively planar, thin rectangular base 650 and an attachment feature 652 extending (e.g., perpendicularly) from the base 650. The attachment feature 652 is configured to be inserted into a complementary feature (e.g., an accessory channel, or kerf) of the frame 16 to secure the fin 620 to the frame 16. The attachment feature 652 may be a barbed projection that is flexible and allows the attachment feature 652 to be inserted into the complementary feature of the frame 16 but resist removal therefrom. The attachment feature 652 may be described as a “Christmas tree” configuration and may be formed of the first and second materials, with the second material forming the base or trunk of the attachment feature 652 and the first material forming the flexible branches of the attachment feature 652.

The projection portion 642 also includes an elongate, relatively planar, thin body 658. As shown, the projection portion 642 may be substantially free of any apertures or openings suitable for receiving a fastener, such as a nail or screw, to attach the projection portion 642 to the framing of the rough opening (RO) or wall of the building in which the fenestration unit 10 is to be installed. In various examples, the projection portion 642 need not include such features, as the plurality of fins 620 do not provide substantial structural support, but instead are designed primarily to provide exterior water barrier functionality.

The hinge portion 646 is located between the coupling portion 640 and the projection portion 642, being coupled to each respectively. The hinge portion 646 is configured to flex between a folded state with the projection portion 642 folded against the coupling portion 640 and an extended state with the projection portion 642 extending away from the coupling portion 640 at an angle between the coupling portion 640 and the projection portion 642, such as that shown in FIGS. 37 and 38 (e.g., 90 degrees, or greater than 90 degrees, such as 100 degrees). The hinge portion 646 has a width that is selected to allow the projection portion 642 and the coupling portion to not only be angularly displaced relative to one another, but also to be laterally displaced to smaller and greater lateral offsets.

For example, by having a small portion of the hinge portion 646 projecting vertically in the 90-degree position, the edges of the coupling portion 640 and projection portion 642 define a relatively small lateral offset (in the interior-exterior direction as installed) from one another. And, by extending a larger portion of the hinge portion 646 width in the lateral direction (in the interior-exterior direction as installed) the edges of the coupling portion 640 and the projection portion 642 are at a greater lateral offset from another. In this manner, the hinge portion 646 provides functionality of the fin 620 to accommodate variations in wall thickness when the fenestration unit 10 is installed in a rough opening (RO). In some embodiments, the hinge portion 646 is at least ⅛-inch, ¼-inch, ⅜-inch, or ½-inch wide to facilitate sufficient depth adaptability to the fin 620 to accommodate and adapt to different wall depths of the building structure into which the fenestration unit 10 is installed.

As shown in FIGS. 37-39, the fin of the plurality of fins 620 may include a tip 618 positioned on the exterior-facing side of the fin assembly 620 (e.g., corresponding to the exterior side 14 of the fenestration unit 10) that extends continuously or discontinuously along a length of the frame 16. The tip 618 may extend outwardly, and optionally at an angle, relative to the exterior side of the frame 16 and abut the exterior side of frame 16. The tip 618 may be configured to prevent water/moisture movement along the length of the frame 16 such that water is prevented or substantially impeded from transferring across the attachment point of the fin assembly 620 (e.g., attachment feature 652) and the frame 16.

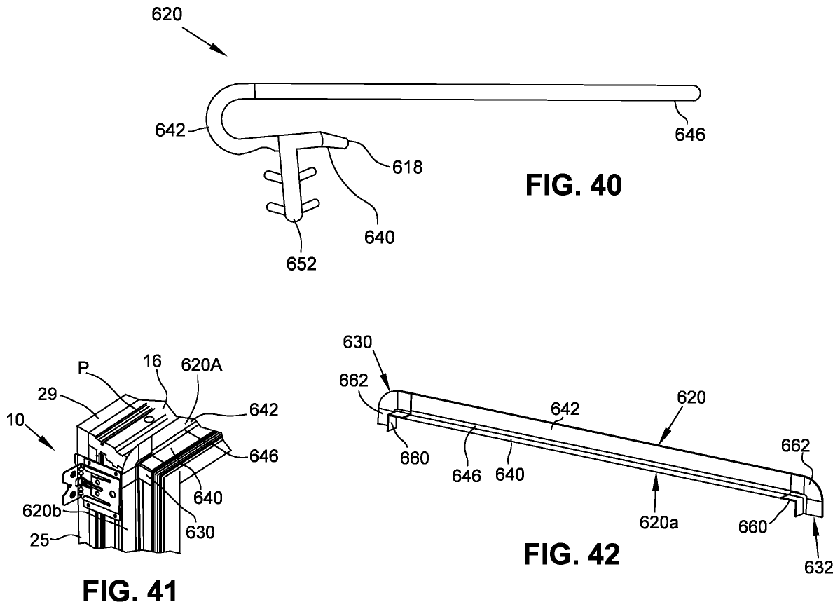

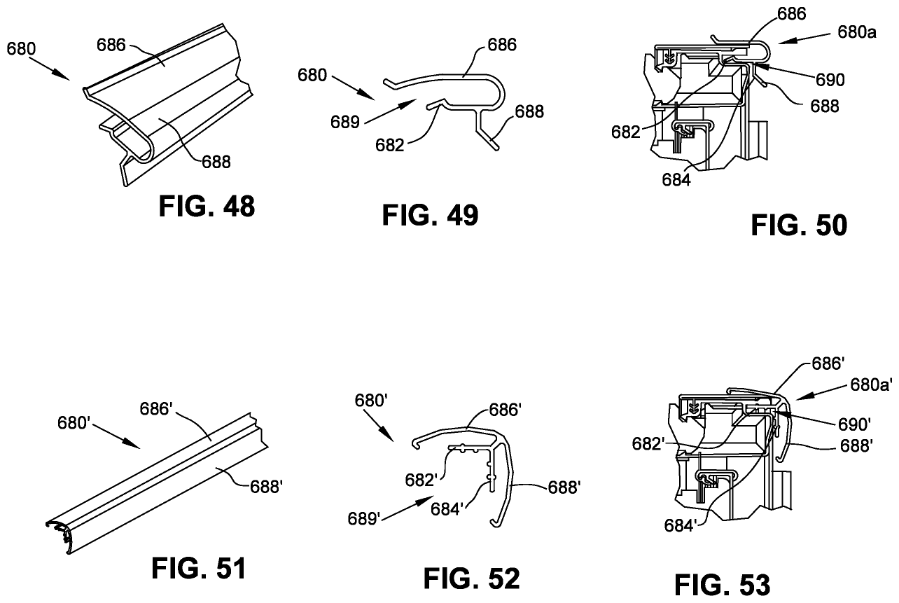

FIG. 40 illustrates one embodiment of the plurality of fins 620 in a stowed configuration (FIG. 36A). As shown, in the stowed configuration, the hinge portion 646 may be biased in a curved, or non-linear, configuration such that the 642 projection portion is extended along the perimeter P of the frame 16. In the stowed configuration, as further described below, the fin 620 may be secured in the stowed configuration using one or more retainers 680 (e.g., FIG. 48). In some examples, the hinge portion 646 is biased toward the deployed configuration (FIG. 37) such that one or more retainers 680 may be needed to maintain the fin 620 in the stowed configuration (FIG. 40). The hinge portion 646 may be sufficiently flexible to transition between the linear (FIG. 37) and non-linear (FIG. 40) configurations upon removal of the one or more retainers 680.

In some embodiments, the coupling portion 640 may act as an edge seal in the form of a more flexible, or soft (e.g., elastomeric) material configured to help ensure water does not penetrate between the fin 620 and the frame 16 of the fenestration unit 10. The edge seal generally extends along the length of the base 650 and may be used in addition to the tip 618 (FIG. 39) for water management.

FIG. 41 shows a closeup view of a first corner of the frame 16 of FIG. 35 defined at an intersection of the frame head 29 and the first jamb 25 of the frame 16 (the frame 16 also defines a second corner at the intersection of the frame head 29 and the second jamb 27 of the frame 16). As shown, the first corner bridge seal 630 is located at the first corner and provides a transition between the head fin 620a and the first jamb fin 620b (the second corner bridge seal 632 is similarly located at the second corner and similarly provides a transition between the head fin 620a and the second jamb fin 620c).

FIG. 42 shows the first and second corner bridge seals 630, 632 assembled to the head fin 620a. In some embodiments, one or both of the first and second corner bridge seals 630, 632 are bonded to the head fin 620a, and optionally the first and second jamb fins 620b, 620c. One or both of the first and second corner bridge seals 630, 632 may be bonded to the projection portion 642 of the head fin 620a and may be positioned on opposing ends of the projection portion 642 (e.g., along a longitudinal axis). In use, unfolding of the fins, or deployment of the fins, may be carried out with the first and corner bridge seals 630, 632 deploying at essentially the same time, according to some embodiments.

As shown, the corner portion 660 of the first corner bridge seal 630 is coupled to the coupling portion 640 and the hinge portion 646 of the head fin 620a. In some examples, the hood portion 662 is also secured to the projection portion 442 of the head fin 620a. The second corner bridge seal 632 is optionally similarly secured to the head fin 620a at an opposite end of the head fin 620a from the first corner bridge seal 630. In at least this manner, water flowing onto the head fin 620a will be directed over the first and second corner bridge seals 630, 632 along the first and second jamb fins 620b, 620c, respectively. Along those lines the first corner bridge seal 630 is optionally secured to the first jamb fin 620b. For example, the hood portion 662 is optionally secured to the projection portion of the first jamb fin 620b. Optionally, the corner portion 660 may be secured to the coupling portion of the first jamb fin 620b. The second corner bridge seal 632 may be similarly secured to the second jamb fin 620c.

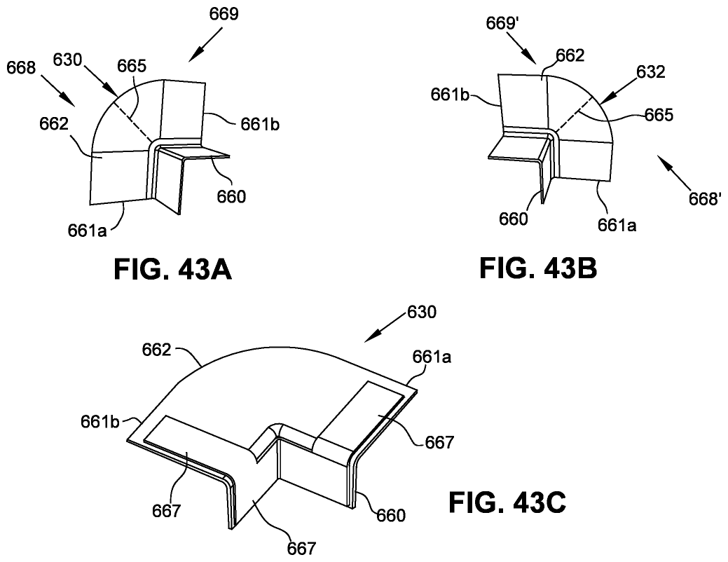

FIG. 43A is an isometric view of the first corner bridge seal 630 and FIG. 43B is an isometric view of the second corner bridge seal 632, the second corner bridge seal 632 being substantially similar to the first corner bridge seal 630, in various embodiments. The second corner bridge seal 632 may mirror the first corner bridge seal 630. As shown, the first corner bridge seal 630 includes a corner portion 660 in the form of an L-shaped flange formed by two flat webs of material and a hood portion 662 in the form of a flat web of material extending in an orthogonal plane from the corner portion 660. The hood portion 662 may have an arcuate, or curved shape. The hood portion 662 of the first corner bridge seal 630 may define a first end 661a positioned along the first jamb fin 620b and a second end 661b positioned along the head fin 620a.

The first corner bridge seal 630 may be formed of a substantially flexible (e.g., elastomeric material) so that it can be folded similarly to the fins 620. For example, both the hood portion 662 and/or the corner portion 660 may be substantially flexible (e.g., elastomeric) and able to be resiliently deformed. The hood portion 662 may include one or more seams to facilitate folding and unfolding the first corner bridge seal 630 between the stowed and deployed configurations. For example, a seam 665 may be positioned in an approximate center of the hood portion 662 to facilitate folding and unfolding of first corner bridge seal 630. The seam(s) may be pre-formed (e.g., via a molding or other forming process) or formed as part of a folding process (e.g., mechanically formed due to the folding procedure itself, which may be manual or automated).

The first corner bridge seal 630 may define a first half 668 of the hood portion 662, which may be extend approximately between the first end 661a of the hood portion 662 and the seam 665. The first corner bridge seal 630 may also define a second half 669 of the hood portion 662, which may extend approximately between the second end 661b and the seam 665. Similarly, the second corner bridge seal 632 may define a first half 668′ of the hood portion 662, which may extend between the first end 661a and the seam 665 and a second half 669′, which may extend between the second end 661b and the seam 665.

Although corner portion 660 is shown as having an approximately 90-degree angle, other angles are contemplated. The corner portion 660 may couple with one or more portions of frame 16, such as a corner of the frame 16, and in some embodiments, the first and second corner bridge seals 630, 632 may be modified to interact with frames of different shapes, including but not limited to triangular frames, trapezoidal frames, rounded frames, and the like, as desired. In such embodiments, the corner portion 660 may have a shape complimentary to the corners, such as a triangular shape, a trapezoidal shape, or a rounded shape. In other embodiments, the corners of frame 16 may be at angles greater than or smaller than 90 degrees to accommodate different corners, and corner portion 660 may be modified to complement the corner angle. As such, the corner portion 660 may be between approximately 45 degrees and approximately 60 degrees, between approximately 60 degrees and approximately 75 degrees, between approximately 75 degrees and approximately 90 degrees, between approximately 90 degrees and approximately 105 degrees, between approximately 105 degrees and approximately 120 degrees, between approximately 120 degrees and approximately 135 degrees.

As shown in FIGS. 43A-45, the hood portion 662 may be substantially flexible and folded into a stowed, folded configuration or a non-deployed configuration. Generally, the first corner bridge seal 630 is flexible, while being sufficiently tough and resilient to avoid tearing or failure while being flexed as part of a fin deployment process. In some embodiments, the first corner bridge seal 630 is formed of an elastomer, including but not limited to a thermoplastic elastomer. The thermoplastic elastomer may include, but is not limited to, Versaflex® CL40 Thermoplastic Elastomer (TPE) available from GLS Corp. Generally, Versaflex® CL40 Thermoplastic Elastomer (TPE) has high toughness and flexibility which may allow the first corner bridge seal 630 to exhibit desired flexibility while resisting failure (e.g., tearing).

In some embodiments, the first corner bridge seal 630 may be manufactured via injection molding, or other methods such as an additive manufacturing process. The first corner bridge seal 630 may define a net, or web (e.g., as shown in at least FIG. 43A) that can be folded and unfolded between the stowed and deployed configurations. By manufacturing the first corner bridge seal 630 to be flexible and/or foldable, there is a reduced need for additional processing or conditioning for folding, unfolding, and deployment (e.g., stretching, or other manipulation of a shape of the first corner bridge seal 630 to facilitate deployment of the fin assembly 610). The elasticity and attachment of the bridge corner seal 630 to the fin assembly 610 in an installation configuration with the fins projecting radially outward, with subsequent folding of the bridge corner seal 630 to the stowed configuration, helps ensure the bridge corner seal 630 does not tear or detach in use when transitioning from the stowed configuration to deployed, or installation configuration. In contrast, fin systems that have a corner element that requires further manipulation or stretching upon deployment (e.g., that require deformation in order to fold a fin system outward) may lead to tearing, hole formation, or other defects in the corner element.

In some embodiments, as shown in FIG. 43C, one or both of the first corner bridge seal 630 and the second corner bridge seal 632 include an adhesive 667. The adhesive 667 may be pre-applied prior to shipping. The adhesive 667 may facilitate adhesion of the first corner bridge 630 to one or more of the fins 620 and/or the frame 16 (e.g., at the corner of the frame 16). In some embodiments, the first corner bridge seal 630 may be a separate component from the fin assembly 620 and may be coupled to a portion of the fin assembly 620 via the adhesive 667. As shown, the adhesive 667 may be positioned onto a portion of hood portion 662, and along one or both of the first end 661a and the second end 661b, to facilitate attachment to the first jamb fin 620b and the head fin 620a. In addition, or alternatively, the adhesive 667 may also be positioned on the corner portion 660 to facilitate attachment to a portion of the frame 16 (e.g., a corner). The adhesive 667 may include, but is not limited to, a pressure-sensitive tape or coating that may be employed temporarily and removed after transitioning to the deployed configuration. In other embodiments, the adhesive 667 may be a permanently applied tape or coating that remains adhered to the first corner bridge seal 630 after deployment. The adhesive 667 may include, but is not limited to, Sealing and Holding Tape 8069 available from 3M Company. The adhesive 667 may have a liner attached thereto that is removed prior to or during installation of the first corner bridge seal 630 to the fin assembly 620. In some embodiments, the liner may be oversized relative to the adhesive 667 to facilitate quick removal.

FIG. 36A shows the fenestration unit 10 in the stowed configuration with the plurality of fins 620 folded in an exterior direction with retaining assembly 612 retaining the plurality of fins in the stowed configuration. According to some embodiments, the retaining assembly 612 includes a plurality of retaining clips 680, such as a head clip 680a, a first jamb clip 680b, and/or a second jamb clip 680c. FIG. 36B shows the fenestration unit 10 after the retaining assembly 612 has been removed, allowing the plurality of fins 620 to unfold and transition to the active, or installation configuration. Although the retaining clips 680 are optionally employed, in other embodiments, such as shown in FIG. 43C, adhesives (e.g., tape or coatings) may additionally or alternatively be employed to temporarily secure the plurality of fins 620 in the folded configuration. For example, a pressure sensitive adhesive set may be applied. In such examples, the adhesive may be removed from the plurality of fins 620 without damaging the plurality of fins 620. As another alternative, cardboard, paperboard, or other material shaped in a “C” or “F” shape may be implemented to replace one or more of the retaining clips 680.

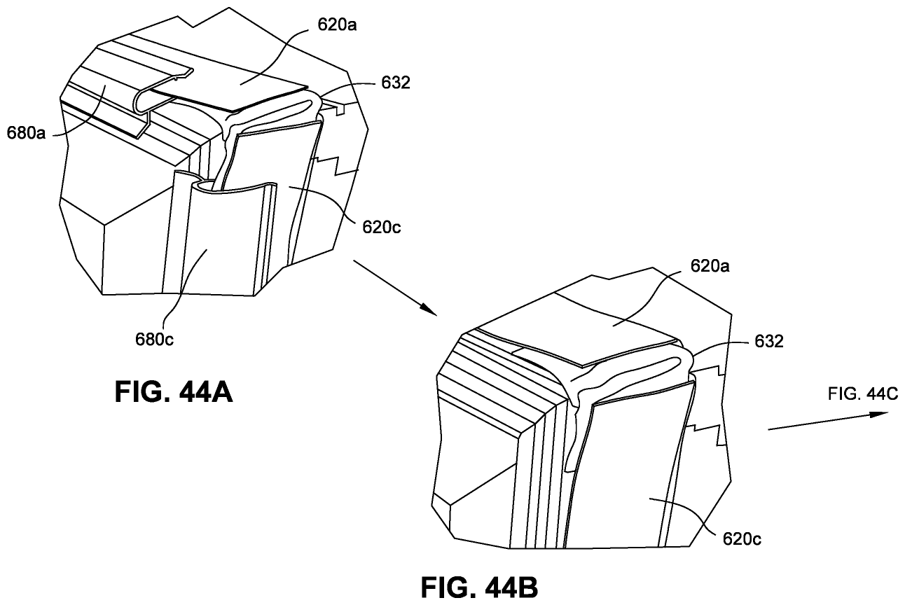

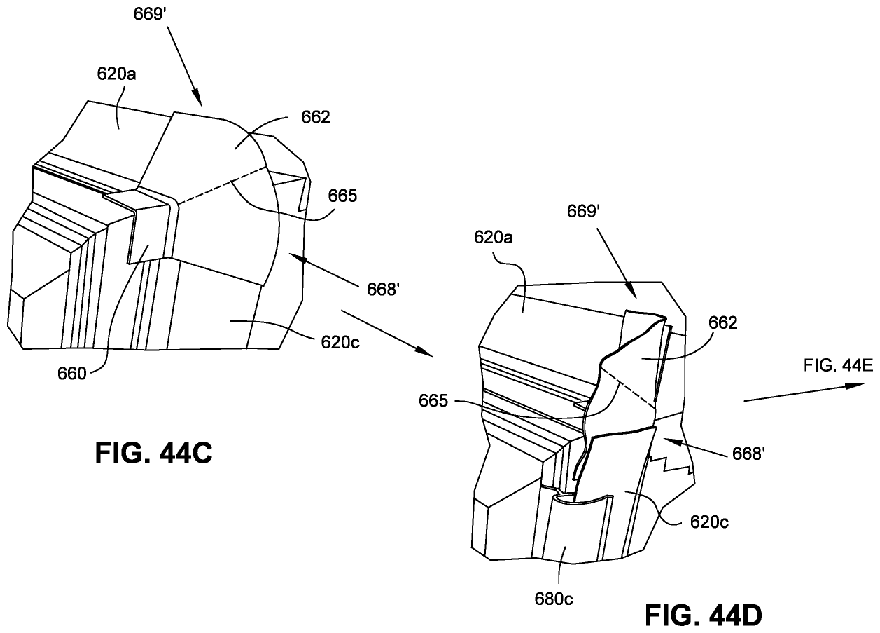

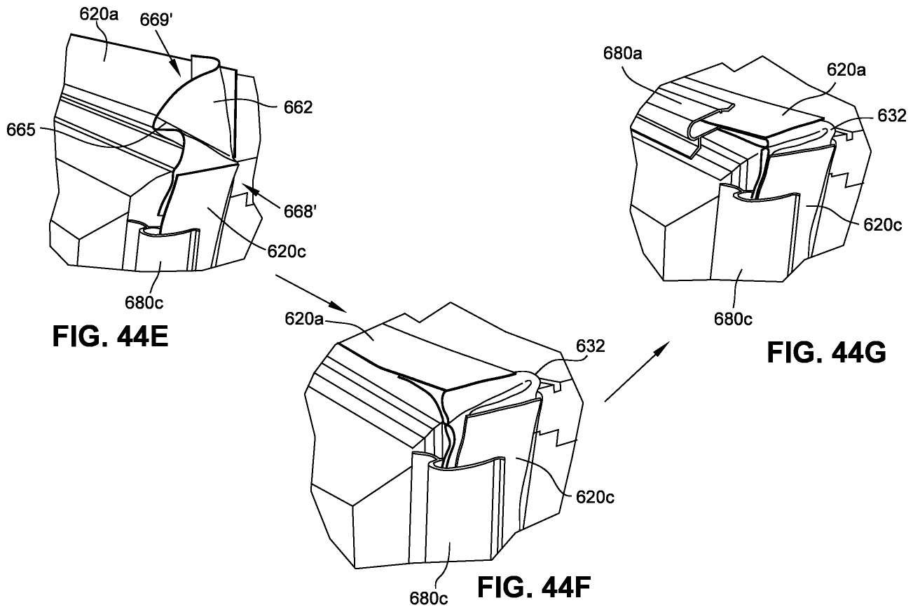

FIGS. 44A-44C illustrates the second corner bridge seal 632 being deployed from the folded, stowed configuration (e.g., FIG. 44A), to the unfolded, deployed configuration (e.g., FIG. 44C). Although the second corner bridge seal 632 is shown, the first corner bridge seal 630, or any other corner bridge seal, may be deployed in a similar manner. The second corner bridge seal 632 may include the adhesive 667 applied thereto, as described above, and may be coupled to the fin assembly 620 via the adhesive either prior to or during deployment of the fin assembly 620. As shown in FIG. 44A, the second corner bridge seal 632 may be retained in the folded, stowed configuration by at least one of the retaining clips 680 (e.g., the head clip 680a and/or the second jamb clip 680c). One or more of the retaining clips 680 may be attached to the frame 16 such that at least a portion of the second corner bridge seal 632, such as substantially all of the corner bridge seal, is covered and protected by the one or more retaining clips 680.

Although the retaining clips 680 may be implemented, in other embodiments the second corner bridge seal 632 (or any other bridge seal) may additionally or alternatively be retained in the folded, stowed configuration by an adhesive (e.g., a pressure sensitive and/or releasable adhesive). As shown in FIGS. 44B-44C, in some embodiments, when the retaining clips 680 are removed, the second corner bridge seal 632 may remain in the folded, stowed configuration until the plurality of fins 620 are manually unfolded, or deployed, such that the plurality of fins 620 project substantially outwardly relative to the perimeter P of frame 16.

As the plurality of fins 620 are unfolded, the second corner bridge seal 632 may also unfold, or deploy, such that the second corner bridge seal 632 also projects substantially outwardly relative to the perimeter P of frame 16. The first and second portions 668′, 669′ may deploy at substantially the same time. In other embodiments, the plurality of fins 620 and the second corner bridge seal 632 may automatically deploy to the unfolded, deployed configuration upon removal of the retaining clips 680. In some embodiments, the second corner bridge seal 632 includes an adhesive applied to the hood portion 662. When the second corner bridge seal 632 is in the deployed configuration, a release liner may be removed from the adhesive and the hood portion 662 may be adhered to the exterior of the building surrounding the rough opening (RO). In such embodiments, the arcuate or curved portion of the hood portion 662 may be substantially free of adhesive, or may include adhesive as desired.

FIGS. 44D-44G shows the second corner bridge seal 632 transitioning from the unfolded, deployed configuration (e.g., as shown in FIG. 44C), to the folded, stowed configuration (e.g., as shown in FIG. 44G). Although the second corner bridge seal 632 is shown, the first corner bridge seal 630, or any other corner bridge seal, may be stowed in a similar manner. As shown in FIG. 44D, one of the plurality of fins 620 (e.g., second jamb fin 620c) may be folded to the stowed configuration and in folding the fin 620, the first portion 668′ of the hood portion 662 may also fold such that the first portion 668′ is substantially flat against frame 16 or is no longer projecting relative to the frame 16. The first portion 668′ may be folded onto the corner portion 660 of the second corner bridge seal 632. After the first portion 668′ of the hood portion 662 is folded against the frame 16, the retaining clip 680 (e.g., second jamb clip 680c) may be attached to the frame 16 to retain the first portion 668′ in the folded configuration.

Then, as shown in FIG. 44E, the hood portion 662 may be manually folded along seam 665, such that the hood portion 662 is folded inwardly relative to the frame 16. Folding seam 665 may cause the hood portion 662 to fold onto itself. In such embodiments, an arcuate portion of second portion 669′ of the hood portion 662 may fold onto an arcuate portion of the first portion 668′ such that the seam 665 lays substantially flat along frame 16. In this configuration, the second portion 669′ may at least partially overlap the first portion 668′.

Then, as shown in FIG. 44F, the other of the plurality of fins 620 (e.g., the head fin 620a) may be folded to the stowed configuration and in folding the fin, the second portion 669′ of the hood portion 662 may also fold such that the second portion 669′ is substantially flat against frame 16. When the second portion 669′ of the hood portion 662 is folded against the frame 16, the retaining clip 680 (e.g., head clip 680a) may be attached to the frame 16 to retain the second portion 669′ in the folded configuration. The first portion 668′ of the hood portion 662 and the second portion 669′ of the hood portion 662 may at least partially overlap each other in the stowed configuration. In other embodiments, a reverse configuration is contemplated in which the second portion 669′ of the hood portion 662 may be folded first. In such embodiments, the first portion 668′ may at least partially overlap the second portion 669′ in the folded, stowed configuration.

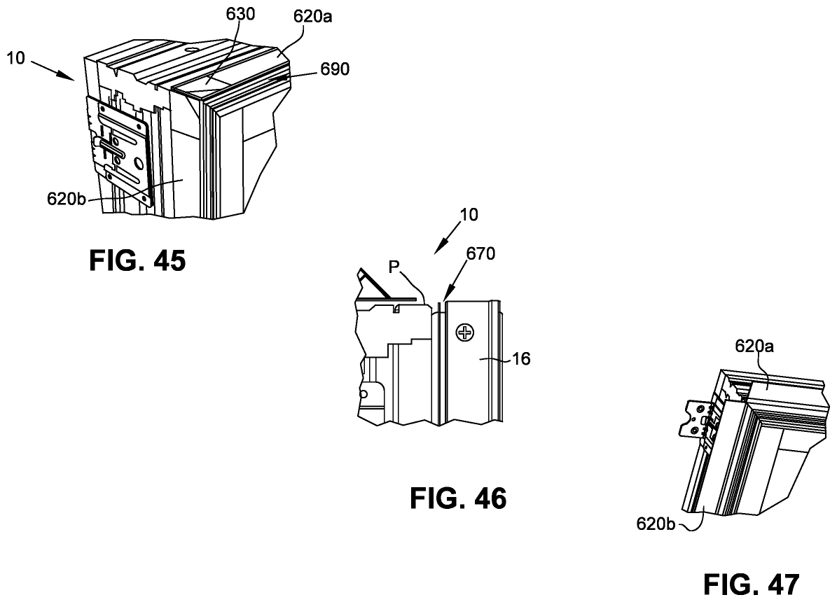

FIG. 45 is a closeup view of the first corner with the head fin 620a and the first jamb fin 620b, as well as the first corner bridge seal 630 folded over into the stowed configuration. As shown, the first corner bridge seal 630 may be folded onto itself so that the first corner bridge seal 630 does not protrude or project substantially from the outer perimeter P of the frame 16. By folding onto itself, the first corner bridge seal 630 may be protected prior to deployment of the fins 620 and/or during shipping of the fenestration unit 10. Additionally, at least a portion of the folded first corner bridge seal 630 may be protected under one of the retaining clips 680 (e.g., head clip 680a) in the folded or stowed configuration.

FIG. 46 shows a closeup view of the first corner of the frame 16 of FIG. 35 showing a complementary edge feature 670 (e.g., accessory channel or kerf) extending around the outer perimeter P of the frame 16 formed into the outer edges of the frame 16. As previously referenced, the coupling portions of the plurality of fins 620 are coupled to (inserted into) the complementary edge feature 670 in order to secure the plurality of fins 620 about the outer perimeter P of the frame 16.

FIG. 47 is a closeup view of the first corner showing the head fin 620a and the first jamb fin 620b secured in the complementary edge feature 670 (FIG. 46) with the first corner bridge seal 630 not shown.

In sum, as shown in FIG. 36B, the fin assembly 610 includes the head fin 620a secured or coupled to the frame head 29 of the frame 16, a first jamb fin 620b coupled, or secured to the first jamb 25 of the frame, and a second jamb fin 620c coupled to the second jamb 27 of the frame 16. And, as shown in FIG. 36B, the first corner bridge seal 630 overlaps the first side fin 620b and the top fin 620a and the second corner bridge seal 632 overlaps with the second side fin 620c and the top fin 620a to define a continuous water barrier extending about the outer perimeter P of the frame 16 along the first jamb 25, the frame head 29, and the second jamb 27.

FIG. 48 is a partial view of a length of one of the retaining clips 680, according to a first design, where each of the retaining clips 680 (e.g., the head clip 680a, the first jamb clip 680b, and the second jamb clip 680c) can be of a substantially similar design (apart from having a length suitable for retaining each of the respective plurality of fins 620 in the stowed configuration). FIG. 49 is a transverse sectional view of the retaining clip 680 shown in FIG. 48. As shown in FIG. 50, the retaining clip 680 includes a first channel insert 682, a first retaining lip 686, and a second retaining lip 688. As shown, the first channel insert 682 is substantially parallel to the first retaining lip 686 and interconnected therewith (e.g., defining a “C” shape in transverse cross-section). The retaining clips 680 may extend for a length approximating the portion of the frame 16 to which it is installed (e.g., the frame head 29, the first jamb 25, and/or the second jamb 27). In such embodiments, the retaining clips 680 may extend along a substantial portion of a length of the portion of the frame 16 to which it is installed (e.g., a retaining clip 680 installed on the frame head 29 may extend over all, or substantially all, of a length of the frame head 29). In this embodiment, when the retaining clips 680 are removed from their respective frame member (e.g., the frame head 29, the first jamb 25, and/or the second jamb 27), the retaining clips 680 are each removed as a single piece (e.g., the retaining clip 680 extending along the frame head 29 is removed as a whole, maintaining the length). Alternatively, the length of each retaining clip 680 may be broken down into one or more smaller, individual clips rather than a single, long clip.

The retaining clips 680 are resiliently deformable such that they can be attached to the frame 16 in a friction fit, for example. In some embodiments, the retaining clips 680 are formed of a polymeric material, such as polyvinyl chloride (PVC), for example. The channel insert 682 may include barbs, prongs, or projections to help assist with mechanical engagement with a complementary face feature (e.g., accessory channel or kerf) formed in the frame 16. The retaining lips 686 may include a rounded curved, or hooked end to help provide a positive bias against portions of the frame 16. The second retaining lip 688 may extend or project substantially orthogonally relative to the channel insert 682 and the first retaining lip 686. The retaining lip 686 extends substantially parallel to the channel insert 682, the first retaining lip 686 and the channel insert 682 defining a receiving channel 689 therebetween. The second retaining lip 688 optionally acts as an insertion stop extending substantially perpendicular to the first retaining lip 686 and the first channel insert 682, which can optionally be configured to abut the back face (or exterior face) of the frame 16 when the retaining clip 680 is assembled to the frame 16.

For example, FIG. 50 is a sectional view at the frame head 29 of the frame 16 showing one of the retaining clips 680 according to the design of FIG. 48, the head retaining clip 680a, releasably engaged with a complementary face feature 690 (e.g., accessory channel or kerf) formed in the back face 23, or exterior face 23 of the frame 16 toward the outer perimeter P, and specifically in the frame head 29. For reference, the complementary face feature 690 is optionally formed in each of the frame head 29, first jamb 25, and/or second jamb 27 of the frame 16. As shown, the first channel insert 682 is releasably engaged in the complementary face feature 690 with the second channel insert 684 arranged along the exterior face 23 and engaged therewith. In turn the first retaining lip 686 extends over the head fin 620a, and specifically over the projection portion 642 to hold the projection portion 642 folded against the coupling portion 640. The second retaining lip 688 extends along the back face 23. Generally, the first retaining lip 686 extends along the side of the frame 16 with the fin 620 of the fin assembly 612 received between the retaining lip 686 and the side, or outer perimeter P of the frame 16.

Each of the retaining clips 680 may be similarly secured about the frame 16 to retain the plurality of fins 620 in the stowed state. In different terms, the channel inserts of the retaining clips 684 are releasably secured into the complementary features 690 (e.g., accessory channels) of the frame 16 with the retaining lips 686, 688 received over the fin assembly 610 to releasably secure the fins 620 in the constrained state, or stowed configuration.

Each of the retaining clips 680 may be reusable such that the retaining clips 680 may be removed and re-installed about the frame 16 without damaging the retaining clips 680. The retaining clips 680 may also be installed and removed without damaging the plurality of fins 620 or the corner bridge seals 630, 632. The retaining clips 680 may be removed and re-installed manually and without the use of specialized tools.

FIG. 51 is a partial view of a length of one of the retaining clips 680 according to another design, shown as retaining clips 680′, according to some embodiments, where each of the retaining clips 680′ (e.g., the head clip 680a′, the first jamb clip 680b′, and/or the second jamb clip 680c′) can be substantially similar to each other (apart from having a length suitable for retaining each of the respective plurality of fins 620 in the stowed configuration). FIG. 52 is a transverse sectional view of the retaining clip 680′ shown in FIG. 51. As shown in FIG. 53, the retaining clip 680a′ includes a first channel insert 682′, a second channel insert 684′, a first retaining lip 686′, and a second retaining lip 688′. As shown, the first and second channel inserts 682′, 684′ are substantially orthogonal and the first and second retaining lips 686′, 688′ are similarly orthogonally offset. The retaining clips 680′ may extend for a length approximating the portion of the frame 16 to which it is installed (frame head 29, first jamb 25, and/or second jamb 27). Alternatively, the length of each retaining clip 680′ may be broken down into one or more smaller, individual clips rather than a single, long clip.

The retaining clips 680′ are resiliently deformable such that they can be attached to the frame 16 in a friction fit, for example. In some embodiments, the retaining clips 680′ are formed of a polymeric material, such as polyvinyl chloride (PVC), for example. The channel inserts 682′, 684′ may include barbs, prongs, or projections to help assist with mechanical engagement with a complementary face feature (e.g., accessory channel or kerf) formed in the frame 16. The retaining lips 686′, 688′ may include rounded curved, or hooked ends to help provide a positive bias against portions of the frame 16. The first retaining lip 686′ extends substantially parallel to the first channel insert 682′, the first retaining lip 686′ and the first channel insert 682′ defining a receiving channel 689′ therebetween. The second retaining lip 688′ optionally acts as an insertion stop extending substantially perpendicular to the first retaining lip 686′ and the first channel insert 682′, which can optionally be configured to abut the back face of the frame 16 when the retaining clip 680′ is assembled to the frame 16.

For example, FIG. 53 is a sectional view at the frame head 29 of the frame 16 showing one of the retaining clips 680′, the head retaining clip 680a′, releasably engaged with a complementary face feature 690′ (e.g., accessory channel or kerf) formed in the back face 23, or exterior face 23 of the frame 16 toward the outer perimeter P, and specifically in the frame head 29. For reference, the complementary face feature 690′ is optionally formed in each of the frame head 29, first jamb 25, and/or second jamb 27 of the frame 16. As shown, the first channel insert 682′ is releasably engaged in the complementary face feature 690′ with the second channel insert 684′ arranged along the exterior face 23 and engaged therewith. In turn, the first retaining lip 686′ extends over the head fin 620a, and specifically over the projection portion 642 to hold the projection portion 642 folded against the coupling portion 640. The second retaining lip 688′ extends along the back face 23. Generally, the first retaining lip 686′ extends along the side of the frame 16 with the fin 620 of the fin assembly 612 received between the retaining lip 686′ and the side, or outer perimeter P of the frame 16.

Each of the retaining clips 680′ may be similarly secured about the frame 16 to retain the plurality of fins 620 in the stowed state. In different terms, the channel inserts of the retaining clips 682′, 684′ are releasably secured into the complementary features 690′ (e.g., accessory channels) of the frame 16 with the retaining lips 686′, 688′ received over the fin assembly 610 to releasably secure the fins 620 in the constrained state, or stowed configuration.

### Shim Guide System

FIGS. 54-55 illustrate a shim guide system 700 of fenestration unit 10, according to some embodiments. The fenestration unit 10 of FIGS. 54-55 may be substantially similar to the fenestration unit 10 of FIGS. 1-3 and 36A-36B and may include similar features such as the anchoring clip system 100 (FIG. 1), the installation stabilizer system 500 (FIG. 1) and/or the weather seal system 600 (FIGS. 36A-36B). FIG. 54 illustrates a top view of a frame head 29 of the frame 16 showing a first shim guide system 702. FIG. 55 illustrates a side view of the second jamb 27 of frame 16 showing a second shim guide system 704.

The shim guide system 700 may serve to help straighten the frame head 29 and/or the jambs 25, 27 of frame 16 by facilitating shimming of one or more portions of the frame 16. In various examples, by performing this function, the shim guide system 700 may help to improve the overall installation of the fenestration unit, which can have a variety of positive effects, including improved securement, improved weather sealing ability of the fenestration unit 10 by creating more uniform contact, and others. As described below, the shim guide system 700 may be configured to receive one or more shims (not shown) during installation. The shim guide system 700 helps to ensure that the shims are driven between the frame 16 and rough opening framing have proper support to reduce loading and/or bending of the frame 16. The shim guide system 700 also ensures the shims are positioned at a location along the frame 16 that reduces additional load on any screws or other fasteners of the frame 16.

As shown in FIG. 54, the first shim guide system 702 includes a first shim guide 706 and a second shim guide 708. The first and second shim guides 706, 708 may be substantially similar in design. Though two shim guides are shown, any number of shim guides are contemplated. The first and second shim guides 706, 708 may be coupled to the frame head 29 of the frame 16, the details of which are further described below. As shown, the first and second shim guides 706, 708 may be positioned in a relative center of the frame head 29, though any number of positions along the frame head 29 are contemplated. The first and second shim guides 706, 708 may comprise a polymeric material, a metallic material, or a combination thereof. In some examples, the first and second shim guides 706, 708 may have relatively smooth outer surfaces to avoid snagging on, or otherwise damaging, the rough opening framing during installation of the fenestration unit 10.

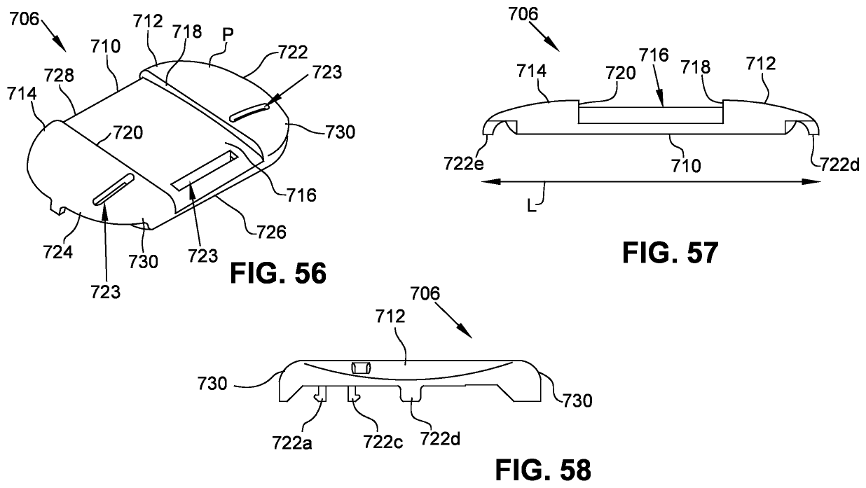

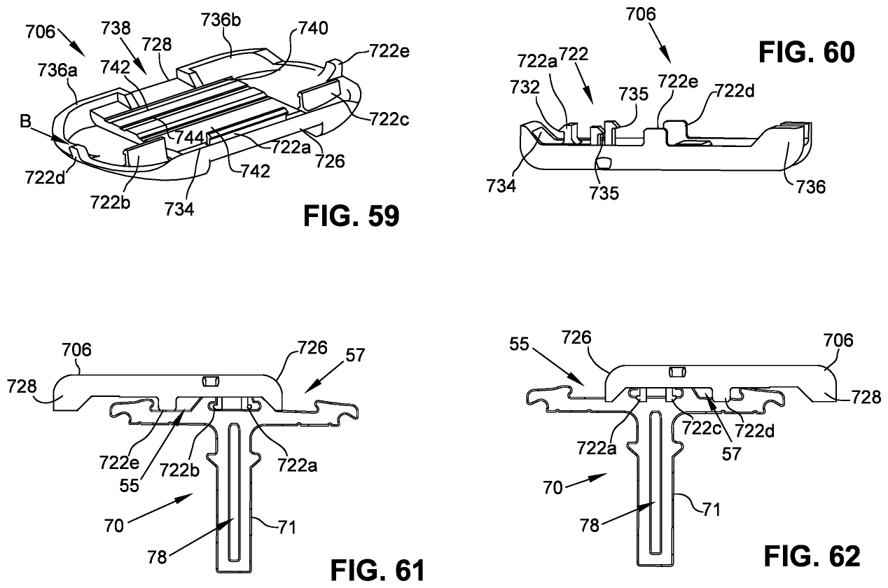

FIGS. 56-59 show the first shim guide 706 of the first shim guide system 704 isolated from the fenestration unit 10. FIG. 56 shows a perspective view, FIG. 57 shows a front view, FIG. 58 shows a side view, and FIG. 59 shows a bottom view. Though not shown, the second shim guide 708 may include substantially similar features as the first shim guide 706. The first shim guide 706 may define an outer perimeter P and be shaped as an oval, though other shapes are contemplated. The outer perimeter P defines a first outer edge 722, a second outer edge 724 opposing the first outer edge 722, a top edge 726 between the first and second outer edges 722, 724, and a bottom edge 728 opposing the top edge 726. As shown, the first shim guide 706 includes a guide portion 710, a first ramp portion 712, and a second ramp portion 714. The first shim guide 706 defines a longitudinal axis L extending between the first and second ramp portions 712, 714. The guide portion 710 is positioned between the first and second ramp portions 712, 714 and defines a sliding surface 716, a first guide edge 718, and a second guide edge 720. The sliding surface 716 is recessed relative to the first and second ramp portions 712, 714 to define the first and second guide edges 718, 720. The first and second guide edges 718, 720 are optionally spaced apart a distance corresponding to a standard wooden, composite, or polymeric shim width (e.g., approximately 1.5 inches). Though not shown, the guide portion 710 may optionally define a fastener aperture though a thickness of the guide portion 710 configured to receive a fastener (e.g., a screw or a bolt).

One or both of the first and second ramp portions 712, 714 taper in thickness, going from a first, larger thickness to a second, smaller thickness in a direction away from the guide portion 710. Said differently, for example, a thickness of the first shim guide 706 at the first outer edge 722 is less than a thickness of the first shim guide 706 at the first guide edge 718. Similarly, a thickness of the first shim guide 706 at the second outer edge 724 is less than a thickness of the first shim guide 706 at the second guide edge 720. In some embodiments, the first and second ramp portions 712, 714 are substantially similar in shape and mirror each other.

In use, the first shim guide 706 is coupled to the frame head 29 with the longitudinal axis L extending along the frame head 29. When the fenestration unit 10 is received within the rough opening (RO), a shim (not shown) is slid between a gap between the frame 16 and the rough opening framing. When the shim contacts the first shim guide 706, the shim may slide in an upward or downward direction over the first or second ramp portions 712, 714, respectively, until the shim enters the guide portion 710. The first and second outer edges 722, 724 may be rounded, or include rounded corners 730 to facilitate receiving one or more shims within the guide portion 710. In some examples, the installer (not shown) feels a tactile response to the shim sliding into place into the guide portion 710. At that point, the shim can be driven into a gap between the first shim guide 706 and the rough opening framing. One or more shims may be positioned between the gap between the first shim guide 706 and the rough opening framing. To stabilize the first shim guide 706 and the one or more shims, the installer may drive a screw through all of the first shim guide 706, the one more shims, and the rough opening framing. The screw may be driven through the fastener aperture (not shown) of the guide portion 710. This action may be repeated with the second shim guide 708, or with more than two shim guides. Features of the screw may be hidden by the thermal break 70 of the frame 16, similar to the fastener 56c of the anchoring clip 102 (FIG. 11) and/or the fastener 56c of the retainer 502 (FIG. 33).

FIG. 59 shows a bottom view of the first shim guide 706. The first shim guide 706 defines one or catches 722 (e.g., catches 722a-722e) configured to contact a feature of the frame 16 to assist in positioning the first shim guide 706 to the frame 16. The one or more catches 722 may include features similar to the one or more catches 422 of the coupling bracket 412 (FIG. 28) and/or the one or more catches 150 of the carrier bracket 110 (FIG. 20).

As shown in FIG. 59, the one or more catches 722 includes catches 722a, 722b, and 722c. The plurality of catches 722a, 722b, 722c may be defined closer to the top edge 726 than the bottom edge 728. The catch 722a may be positioned between the catches 722b, 722c. The catch 722a may have a longer longitudinal length and a shorter height than either catch 722b, 722c, though the longitudinal length and height of the catches 722a, 722b, and/or 722c may vary to match complementary features of the frame 16. The catches 722b, 722c may be substantially the same longitudinal length and height.

Each of the plurality of catches 722a, 722b, and 722c are configured to engage and/or abut portions of the frame 16 including, for example one or more portions of the thermal break 70. As shown in FIG. 60, the catch 722a may define a hooked edge 732 sized and configured to engage a feature of the frame 16, optionally including a portion of the thermal break 70. As shown in FIG. 61, the catch 722a (e.g., the hooked edge 732) engages one wall 64 (FIG. 7) defined by the thermal break body 71 to facilitate coupling thereto. As shown in FIG. 60, the catches 722b, 722c may each define a hooked edge 735 sized and configured to engage another one of the walls 64 of the thermal break body 71. The engagement of the thermal break 70 and the catches 722a, 722b, and 722c creates a mechanical engagement that may also help maintain a position of the first shim guide 706 against the frame 16 during shimming. Other features of the first shim guide 706 may abut and/or engage other features of the frame 16 to maintain stability of the first shim guide 706 and/or maintain mechanical engagement between the frame 16 and the first shim guide 706.

As shown in FIG. 56, the first shim guide 706 may define one or more cut outs 723 through the thickness of the first shim guide 706, where the one or more cut outs 723 are positioned adjacent the one or more catches 722 (e.g., catches 722a, 722b, and/or 722c). The one or more cut outs 723 may be formed as a bi-product of a manufacturing process of the first shim guide 706 (e.g., a stamping process or an injection molding process).

As shown in FIGS. 57-60, the first shim guide 706 may also define catches 722d, 722e, which are positioned proximate the first and second outer edges 722, 724. The catches 722d, 722e may be substantially similar to each other, and may be positioned such that they oppose each other. The catches 722d, 722e may also be configured to engage and/or abut features of the frame 16. For example, and as shown in FIGS. 61-62, the catches 722d, 722e engage a groove 55 of the frame 16 (e.g., a T-slot). As shown in FIG. 61 (and in FIG. 27 with respect to the anchoring clip 412), the groove 55 may be defined by the thermal break body 71. This engagement of the thermal break 70 and the first shim guide 706 assists in registration, or alignment of the first shim guide 706 along the perimeter P of the frame 16 such that the shims are properly received during installation.

The first shim guide 706 may also define lips 734, 736 positioned at the top and bottom edges 726, 728, respectively. The lips 734, 736 may be raised relative to the first and second outer edges 722, 724. The lip 734 may extend relatively continuously along the top edge 726 and may be received within another groove 57. As shown in FIG. 61 (and in FIG. 27 with respect to the anchoring clip 412), the groove 57 may be defined by the thermal break body 71. This engagement of the thermal break 70 and the first shim guide 706 assists in registration, or alignment of the first shim guide 706 along the perimeter P of the frame 16 such that the shims are properly received during installation.

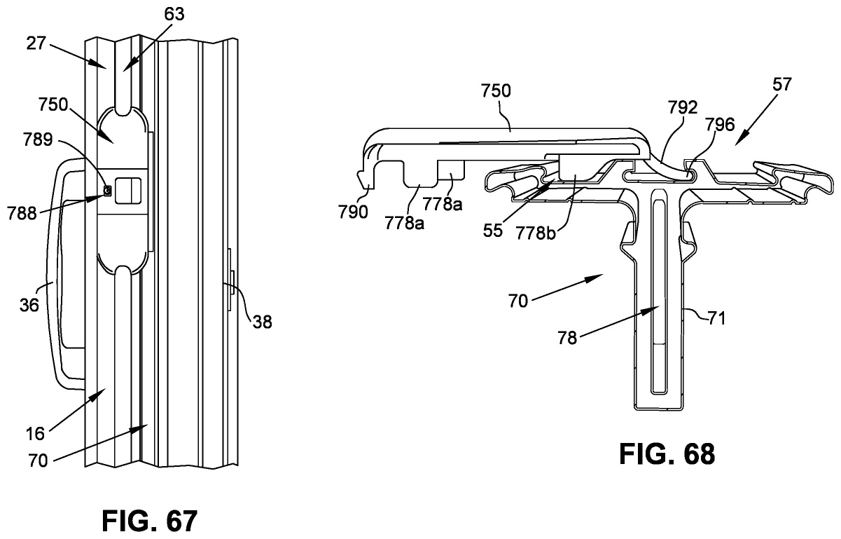

The lip 736 may extend discontinuously along the bottom edge 728 such that the lip 736 defines a first lip portion 736a and a second lip portion 736b. The first and second lip portions 736a, 736b may be raised relative to the first and second outer edges. A gap 738 may be defined longitudinally between the first and second lip portions 736a, 736b. In some examples, at least one feature of the frame 16 (e.g., a screw) may be positioned between the first and second lip portions 736a, 736b and the at least one feature 789 (FIG. 67) (e.g., a hole or a screw head) may be visible through the gap 738. In some examples, and as further described with respect to FIG. 67, visibility of the at least one feature may help properly align and position the first shim guide 706 along the frame 16 such that the first shim guide 706 is installed with the gap 738 positioned above, or straddling, the at least one feature. The lip 736 may be received within other features of the frame 16 such as T-slot 59 (FIG. 27) or T-slot 61 (FIG. 27). T-slots 59 and 61 may be defined along the outer perimeter of the frame 16. This engagement of the thermal break 70 and the first shim guide 706 assists in registration, or alignment of the first shim guide 706 along the perimeter P of the frame 16 such that the shims are properly received during installation. During shimming, once the first shim guide 706 is aligned and the one or more shims are received by the first shim guide 706, an installer can drive one or more installation screws through portions of the first shim guide 706. The installation screw may be driven through the first shim guide 706, the frame 16, and also through the one or more shims. This secures the one or more shims within the first shim guide 706 and to the frame 16.

As shown in FIG. 59, the first shim guide 706 may define a channel 740 extending longitudinally along a bottom side B of the first shim guide 706, where the bottom side B contacts the frame 16. The channel 740 may define walls 742, 744 extending substantially linearly outwardly from the first shim guide 706. The channel 740 may be configured to engage a fastener (not shown) on the frame 16 during installation of the first shim guide 706. The fastener may indicate to the installer (not shown) a position where the first shim guide 706 should be coupled to the frame 16.

As shown in FIG. 54, the second shim guide 708 may be coupled to the frame 16 longitudinally offset from the first shim guide 706. The second shim guide 708 may also be coupled to the frame 16 in an opposite orientation to the first shim guide 706. For example, as shown in FIG. 54, the second shim guide 708 may be rotated approximately 180° relative to the first shim guide 706. As shown in FIG. 54, the bottom edge 729 of the first shim guide 706 extends toward the exterior side 14 of the fenestration unit 10 and the bottom edge 728 of the second shim guide 708 extends toward the interior side 12 of the fenestration unit 10. The coupling between the second shim guide 708 and frame 16 is shown in FIG. 62. As shown, the lip 734 of the second shim guide 708 may be received within groove 55 and the catches 722d, 722e may be received within groove 57 (e.g., opposite of the first shim guide 706 of FIG. 61).

In some examples, one or both of the first shim guide 706 and the second shim guide 708 are coupled to the frame 16 at a remote location (e.g., at a manufacturer) prior to installation of the fenestration unit 10. A feature of the frame 16 (e.g., a screw) may indicate the installation location for the first shim guide 706 and/or the second shim guide 708 along the frame 16. The manufacturer (or installer) may couple the first shim guide 706 in a stepwise process. A process similar to the process described with respect to the coupling bracket 412 (FIG. 27) may be used for the first shim guide 706. For example, the lip 734 may first be received within the groove 57. Then, the first shim guide 706 may be pivoted downward toward the frame 16 such that catches 722a-722c engage the walls 64 and the catches 722d-722e are received within groove 55. Although not shown, the first shim guide 706 may be slid longitudinally along the frame head 29 and over the feature in the frame 16 (e.g., the screw) such that the channel 740 captures a portion of the feature (e.g., a screw head) between walls 742 and 744. This action may couple the first shim guide 706 to the frame 16 in the desired position prior to shipping to the installer. Though the above installation steps are described with respect to the first shim guide 706, the second shim guide 708 may be installed in a substantially similar manner.

FIG. 55 illustrates a side view of the second jamb 27 frame 16 showing a second shim guide system 704. The second shim guide system 704 may be positioned adjacent to, and between the interior handle 38 (FIG. 67) and exterior handle 36 (FIG. 67) of the fenestration unit 10. The second shim guide system 704 includes a third shim guide 750. The third shim guide 750 may include features similar to the first shim guide 706 as described above. The third shim guide 750 may comprise a single component (as shown) or may comprise two or more components. As shown, the third shim guide 750 is coupled to the frame 16 along the second jamb 27.

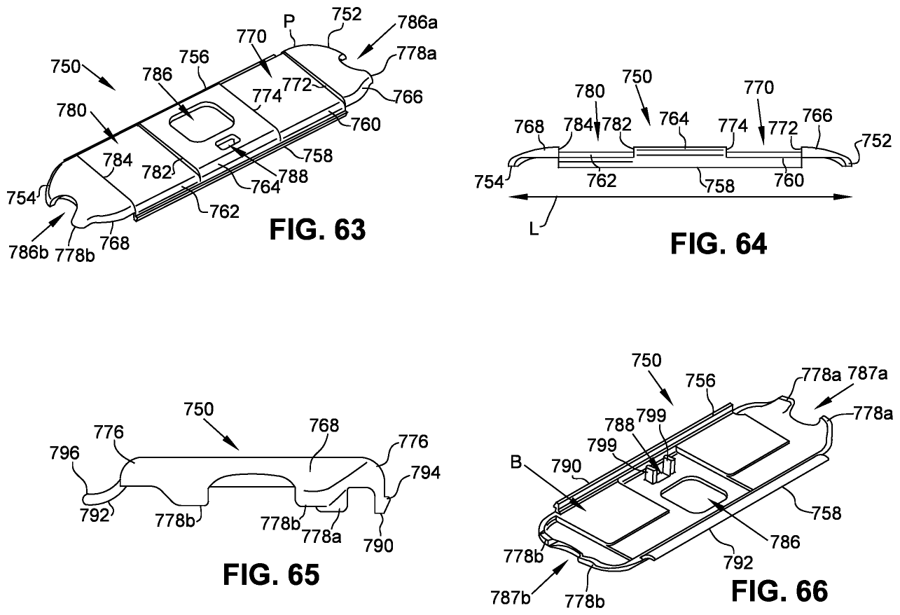

FIGS. 63-66 show the third shim guide 750 isolated from the fenestration unit 10. FIG. 63 shows a perspective view, FIG. 64 shows a front view, FIG. 65 shows a side view, and FIG. 66 shows a bottom view. The third shim guide 750 defines an outer perimeter P and may be shaped as an oval, though other shapes are contemplated. The outer perimeter P defines a first outer edge 752, a second outer edge 754 opposing the first outer edge 752, a top edge 756 between the first and second outer edges 752, 754, and a bottom edge 758 opposing the top edge 756. As shown, the third shim guide 750 defines a first guide portion 760, a second guide portion 762, a central portion 764 longitudinally between the first and second guide portions 760, 762, a first ramp portion 766, and a second ramp portion 768. The third shim guide 750 defines a longitudinal axis L extending between the first and second ramp portions 766, 768.

The first guide portion 760 may be substantially similar to the guide portion 710 of the first shim guide 706 (FIG. 56). The first guide portion 760 is positioned between the first ramp portion 766 and the central portion 764. The first guide portion 760 defines a first sliding surface 770, a first guide edge 772, and a second guide edge 774. The first sliding surface 770 is recessed relative to the first ramp portion 766 and the central portion 764 to define the first and second guide edges 772, 774. The first and second guide edges 772, 774 are optionally spaced apart a distance corresponding to a standard wooden, composite, or polymeric shim width (e.g., approximately 1.5 inches). Though not shown, the first guide portion 760 may optionally define a fastener aperture though a thickness of the first guide portion 760 and may be configured to receive a fastener therein (e.g., a screw or a bolt).

The second guide portion 762 may be substantially similar to the first guide portion 760. The second guide portion 762 is positioned between the second ramp portion 768 and the central portion 764. The first and second guide portions 760, 762 are spaced apart from each other by the central portion 764. The second guide portion 762 defines a second sliding surface 780, a third guide edge 782, and a fourth guide edge 784. The second sliding surface 780 is recessed relative to the second ramp portion 768 and the central portion 764 to define the third and fourth guide edges 782, 784. The third and fourth guide edges 782, 784 are optionally spaced apart a distance corresponding to a standard wooden, composite, or polymeric shim width (e.g., approximately 1.5 inches). Though not shown, the second guide portion 762 may optionally define a fastener aperture through a thickness of the second guide portion 762 and may be configured to receive a fastener therein (e.g., a screw or a bolt).

The central portion 764 may be raised relative to the first and second guide portions 760, 762. The central portion 764 defines a first recess 786 through a thickness of the central portion 764 configured to reduce an overall weight of the third shim guide 750. The first recess 786 may, in some examples, be configured to receive a portion of a lock mechanism (e.g., the lock strike 61 of FIG. 72) of the fenestration unit 10. The central portion 764 may also define a second recess 788 through a thickness of the central portion configured to assist with alignment of the third shim guide 750 along the frame 16. For example, the frame 16 may define at least one feature (e.g., a screw, not shown) along the perimeter of the frame 16 that indicates a coupling location for the third shim guide 750. The manufacturer (if installation occurs at a manufacturing facility) or the installer (if installation occurs at the fenestration unit installation site) (not shown) may align the third shim guide 750 with the at least one feature of the frame 16 such that the at least one feature is visible through third shim guide 750 (e.g., through at least one of the first recess 786 or the second recess 788). In some examples, as shown in FIG. 66, on a bottom face B of the third shim guide 750, the third shim guide 750 defines one or more projections 799 extending outwardly from the bottom face B. The one or more projections 799 may be received by complementary features of the frame 16 (not shown) to facilitate coupling of the third shim guide 750 to the frame 16. In some examples, the one or more projections 799 are configured to receive a portion of a screw (e.g., a screw head). The one or more projections 799 may be spaced apart to define a gap (e.g., where the gap corresponds to the second recess 788).

One or both of the first and second ramp portions 766, 768 taper in thickness, going from a first, larger thickness to a second, smaller thickness in a direction away from the first and second guide portions 760, 762, respectively. Said differently, for example, a thickness of the third shim guide 750 at the first outer edge 752 is less than a thickness of the third shim guide 750 at the first guide edge 772. Similarly, a thickness of the third shim guide 750 at the second outer edge 754 is less than a thickness of the third shim guide 750 at the fourth guide edge 784. In some embodiments, the first and second ramp portions 766, 768 are substantially similar in shape and mirror each other.

FIG. 67 shows a close-up view of the third shim guide 750 coupled to the frame 16. In use, the third shim guide 750 is coupled to the second jamb 27 with the longitudinal axis L extending along the second jamb 27. When the fenestration unit 10 is received within the rough opening (RO), a shim (not shown) is slid between a gap between the frame 16 and the rough opening framing. When the shim contacts the third shim guide 750, the shim may slide in an upward or downward direction over the first or second ramp portions 766, 768, respectively, until the shim enters either the first or second guide portion 762, 764. The first and second outer edges 752, 754 may be rounded, or include rounded corners 776 to facilitate receiving one or more shims within the first and second guide portions 762, 764. In some examples, the installer (not shown) feels a tactile response to the shim sliding into place into either the first and second guide portions 762, 764. At that point, the shim can be driven into a gap between the third shim guide 706 and the rough opening framing. One or more shims may be positioned between the gap between the third shim guide 750 and the rough opening framing. To stabilize third shim guide 750 and the one or more shims, the installer may drive a screw through the third shim guide 750, the one more shims, and the rough opening framing. The screw may be driven through a fastener aperture (not shown) of the first or second guide portions 762, 764.

FIG. 66 shows a bottom view of the third shim guide 750. The third shim guide defines one or more catches 778 configured to contact a feature of the frame 16 to assist in positioning the third shim guide 750 to the frame 16. As shown, the one or more catches 778 includes a first set of catches 778a positioned at the first outer edge 752 and a second set of catches 778b positioned at the second outer edge 754. The first set of catches 778a may oppose the second set of catches 778b, and the first and second set of catches 778a, 778b may be configured substantially similar to each other. The first set of catches 778a may be spaced apart from each other by a first cut out 787a defined along the first outer edge 752. As shown in FIG. 67, the first set of catches 778a may be receive a projection 63 defined longitudinally along the length of the second jamb 27, where the projection 63 extends within the first cut out 787a. Similarly, the second set of catches 778b may be spaced apart from each other by a second cut out 787b defined along the second outer edge 754. The second set of catches 778b may be receive another portion of the projection 63 of the second jamb 27, where the projection 63 extends within the second cut out 787b. The one or more catches 778a, 778b assist with alignment and stabilization of the third shim guide 750 on the frame 16 during the shimming process.

As shown in FIG. 66, the third shim guide 750 defines outer lips 790, 792 positioned at the top and bottom edges 756, 758, respectively. The outer lips 796, 798 may be raised relative to the first and second outer edges 752, 754. The outer lips 796, 798 may extend relatively continuously along the top and bottom edges 756, 758. The outer lap 790 may define a hooked edge 794 configured to receive by corresponding features of the frame 16. For example, the hooked edge 794 may be received within recesses defined within the perimeter P of the frame 16 (not shown). The outer lip 792 may define a curved edge 796. The curved edge 796 may facilitate coupling the third shim guide 750 to the frame 16. In some examples, the third shim guide 750 is coupled to portions of the thermal break 70. FIG. 68 shows a side-oriented cross-sectional view of the third shim guide 750 coupled to portions of the thermal break 70. In some examples, the curved edge 796 is received within the wall 64 (FIG. 7) of the thermal break body 71. As shown in FIG. 68, the second set of catches 778b may be received within the groove 55 of the thermal break body 71. The engagement of the third shim guide 750 and the frame 16 facilitates coupling of the components and may help stabilize the third shim guide 750 during a shimming process. The engagement may of the frame 16 and the third shim guide 750 also ensures proper positioning of the one or more shims to reduce the bending moment on the frame 16 and/or screws of the fenestration unit 10.

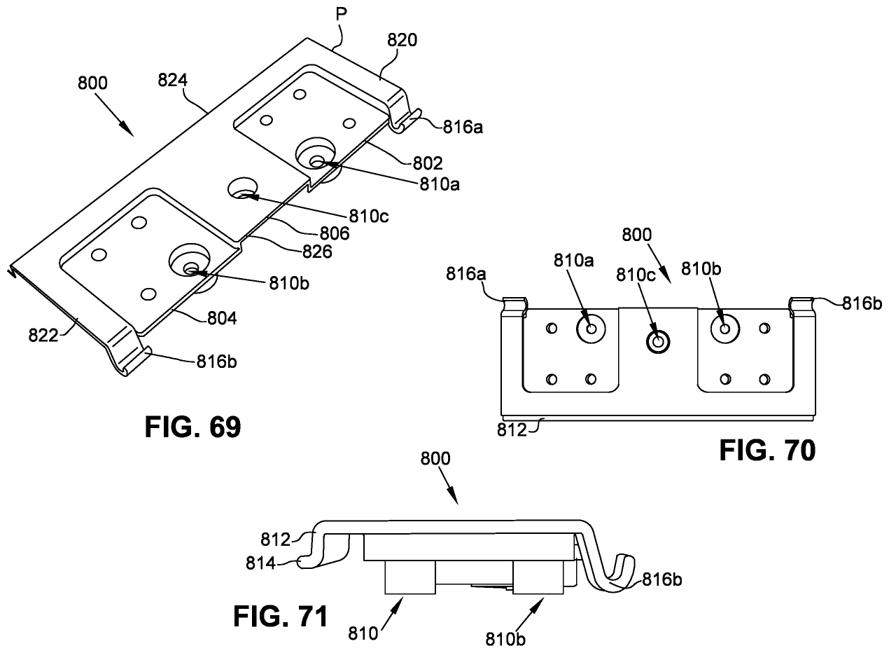

As shown in FIG. 67, the frame 16 may include at least one feature 789 (e.g., a screw) that is visible through the second recess 788. The visibility of at least one feature 789 assists with alignment of the third shim guide 750 along the second jamb 27. In some examples, a mounting plate 800 (FIG. 69) is coupled to an interior side of the second jamb 27 and the at least one feature 789 is a screw that couples the mounting plate 800 to the frame 16 (e.g. though third aperture 810c of FIG. 69). The at least one feature 789 may extend through the frame 16 and show an installer a position of the mounting plate 800 along the second jamb 27. The third shim guide 750 can then be installed such that the second recess 788 is positioned above, or straddling the at least one feature 789, which assists in aligning the third shim guide 750 and the mounting plate 800. Once the third shim guide 750 is coupled to the second jamb 27, one or more shims (not shown) can be received by the first and second sliding surfaces 770 and 780 of the third shim guide 750 such that the one or more shims are positioned between the frame 16 and rough opening framing. Once the second jamb 27 is shimmed, one or more installation screws may be driven through the third shim guide 750, through the frame 16, and optionally through the mounting plate 800 (e.g. though first and second aperture 810a, 810b of the mounting plate 800 of FIG. 69). This couples the one or more shims, the third shim guide 750, the frame 16, and the mounting plate 800 together. Portions of the one or more shims (e.g., portions that extends outwardly from the frame 16) may optionally be broken off after shimming.

Turning to FIGS. 69-71, the frame 16 may include a mounting plate 800 to facilitate coupling the third shim guide 750 to the frame 16. FIG. 69 shows a perspective view, FIG. 70 shows a top view, and FIG. 71 shows a side view. FIG. 72 shows a side-oriented cross-sectional view of the frame 16 showing the interface of the third shim guide 750, the mounting plate 800, and the lock strike 61. The mounting plate 800 may be positioned proximate to the lock strike 61 (FIG. 72) of the fenestration unit 10 and provide support for both the third shim guide 750 and the lock strike 61. The mounting plate 800 defines a perimeter P having a first edge 820, a second edge 822 opposing the first edge 820, a third side 824 extending between the first and second edges 820, 822, and a fourth side 826 opposing the third side 824.

In some embodiments, the mounting plate 800 is complementary in shape to the third shim guide 750. The mounting plate 800 defines a first support portion 802, a second support portion 804, and a central portion 806 positioned longitudinally between the first and second support portions 802, 804. The first and second support portion 802, 804 are recessed relative to the central portion 806. Each of the first and second support portions 802, 804 and central portion 806 may define a plurality of apertures 810 configured to receive fasteners to couple the mounting plate 800 to the frame 16 and/or portions of the third shim guide 750 and lock strike 61.

The mounting plate 800 may be configured to receive at least a portion of the third shim guide 750 thereon such that first and second guide portions 760, 762 align with the first and second support portions 802, 804. One or more of the plurality of apertures 810, including a first and second aperture 810a, 810b, may receive a screw driven through the third shim guide 750 and the one or more shims received on the third shim guide 750. A length of the screw may be selected such that the screw extends through or more of the shims, the third shim guide 750, the mounting plate 800, the frame 16, and/or a lock strike 61 (FIG. 72) of the fenestration unit 10. This provides strength and security to the fenestration unit 10.

The central portion 764 of the third shim guide 750 may also align with the central portion 806 of the mounting plate 800. In some embodiments, the mounting plate 800 defines a feature aligned with the one or more projections 799 of the third shim guide 750 to assist with alignment of the components. For example, a position of a third aperture 810c of the plurality of apertures 810 may align with a portion of the second recess 788 of the third shim guide 750. A fastener may be driven through the second recess 788 and the third aperture 810c to couple the third shim guide 750 and the mounting plate 800. The projections 799 of the third shim guide 750 may generally align with the mounting plate 800.

The mounting plate 800 defines a first lip 812 extending longitudinally along at least a portion of the third side 824. The first lip 812 defines a hooked end 814 (FIG. 71) configured to couple to features (not shown) of the frame 16 and/or the lock strike 61 and third shim guide 750. The mounting plate 800 also defines at least one hooked edge, shown as first edge 816a and second edge 816b, that are positioned along a portion of the fourth side 826. As shown, the first and second edges 816a, 816b are positioned at the end points of the fourth side 826. The first and second edges 816a, 816b define curved ends that may couple to features of the frame 16 and/or the lock strike 61 and the third shim guide 750. The mounting plate 800 may offer additional structure and support to the fenestration unit 10 during shimming. The mounting plate 800 may also reduce a bending moment of at least one of the frame 16, the lock strike 61, and third shim guide 750 during shimming.

In some examples, the third shim guide 750 and the mounting plate 800 are coupled to the frame 16 at a remote location (e.g., at a manufacturer) prior to installation of the fenestration unit 10. A feature of the frame 16 (e.g., a screw) may indicate the installation location for the third shim guide 750 along the frame 16. The manufacturer (or installer) may couple the third shim guide 706 in a stepwise process. A process similar to the process described with respect to the first shim guide 706 (FIG. 56) may be used for the third shim guide 750. For example, the outer lip 792 may first be received within the wall 64 (FIGS. 7, 68). Then, the third shim guide 750 may be pivoted downward toward the frame 16 such that second set of catches 778b engage the frame 16 and are received within groove 55. The first set of catches 778a and the second set of catches 778b may straddle the projection 63 of the second jamb 27 and may be pressed onto the projection 63 such that projection is received within both the first and second cut outs 787a, 787b. A fastener may be used to couple the third shim guide 750 to the mounting plate 800 and optionally the lock strike 61. This couples the third shim guide 750 to the frame 16 in the desired position prior to shipping to the installer.

### Fenestration Unit Installation Methods

Installation of the fenestration unit 10 can proceed in view of the various concepts described in the foregoing sections. In particular, installation of the fenestration unit 10 in the rough opening (RO) may proceed from the interior side of the rough opening (RO) and may be executed by a single installer on the interior side of the rough opening (RO).

As part of the installation process, the rough opening (RO) in the building structure should be prepared for the fenestration unit 10 installation. Generally, the rough opening (RO) is sized to be between ½ inches and ¾ inches larger than the fenestration unit 10 in both width and height, although other setups may also be suitable. Some methods also include forming the rough opening (RO), such as by cutting out the rough opening (RO) (e.g., plywood cladding covering rough opening framing). The lower rail 48 portion of the framing of the rough opening (RO) (lower framing) may be flashed (e.g., using appropriate flashing tape).

The fenestration unit 10 is then partially deployed from the stowed to the active configuration. In particular, the anchoring clips 102 are transitioned to the installation configuration by removing the coupling brackets 112, 212, or 312 from the carrier brackets 110, rotating them 180 degrees so they no longer extend inward toward the center of the fenestration unit 10, and then re-inserting the coupling brackets 112, 212, or 312 into the carrier brackets 110 such that the coupling brackets 112, 212, or 312 project radially outward from outer perimeter P of the frame 16. In both the first, stowed configuration and the second, installation configuration, the first leg 114, 214, or 314 of the respective coupling brackets 112, 212, or 312 is received by the carrier bracket 110, and the respective second legs 116, 216, or 316 project relative to the perimeter P of the frame 16. In the first, stowed configuration, the first leg 114, 214, 314 projects inward relative to the perimeter P of the frame 16 (FIG. 1). In the second, installation configuration, the first leg 114, 214, 214 project outward relative to the perimeter P of the frame 16 (FIGS. 2-3). When the coupling brackets 112, 212, or 312 are sufficiently inserted into the carrier brackets 110 the catches 150 engage the detents 174. In various examples, this engagement results in an audible “click” or noise providing a clear, audible cue to the installer that the coupling brackets 112, 212, or 312 have been properly secured and are at the desired depth of insertion. This audible cue can be augmented by adjusting the spring bias and material selection for the anchoring clips 102. The “click” or vibration may also present as tactile feedback, keying to a user that the coupling brackets 112, 212, or 312 have been properly installed. In various embodiments, the transition between the first, stowed configuration and the second, installation configuration may be referred to as a “Flip and Click” where the coupling bracket 112, 212, 312 is removed from the carrier bracket 110, flipped 180 degrees, and “clicked” back into the carrier bracket 110.

The anchoring clip 102 may be factory applied by a manufacturer. In coupling the anchoring clip 102 to the frame, the manufacturer may first engage the hook 104 of the carrier bracket 110 with the first channel 52. The manufacturer may then pivot the anchoring clip 102 downward toward the frame 16 about the hook 104 to align the one or more fastener apertures 113 with the second channel 52. The hook 104 does not penetrate the frame 16 and instead the fastening clasp 105 engages or registers with a corresponding feature of the first channel 52. The length of the anchoring clip 102 may be selected such that the fastener apertures 113 auto-aligns with the second channel 54 when the hook 104 is engaged with the first channel 52. The manufacturer may then couple the anchoring clip 102 to the frame 16 via either non-penetrating fasteners (e.g., cam 56a, 56b) or penetrating fasteners (e.g., screw 56c) loaded through the fastener apertures 113 to secure the anchoring clip 102 thereto. During this process, the coupling bracket 112 may be installed within the carrier bracket 110, or may be installed afterwards. In other embodiments, an installer may instead install the anchoring clip 102 during installation of the fenestration unit 10 into the rough opening (RO).

In coupling the coupling bracket 412 to the frame 16, the manufacturer may follow a similar stepwise coupling process. First, the manufacturer engages the hook 426 with the first channel 52 to couple the coupling bracket 412 to the frame 16 at the hook 104. The manufacturer then pivots the coupling bracket 412 downward toward the frame 16 about the hook 104, or rocks the coupling bracket in a cantilever action downward, such that the one or more catches 422 engages the groove 52 of the frame 16. After this action, the first aperture 415 is lined up with the second channel 54 (e.g., a second accessory groove). Then, the manufacturer may fasten the coupling bracket 412 to the frame 16 using the fastener 56, as described above. In such embodiments, the fastener 56 may be pre-installed onto the fenestration unit 10 by the manufacturer at the correct depth, and the installer may then place the coupling bracket 412 over the pre-installed fastener and slide the coupling bracket 412 to the side to capture the fastener 56 and couple the coupling bracket 412 to the fenestration unit 10 when installing the fenestration unit 10 into the rough opening (RO).

In some examples, once the anchoring clip 102 is engaged with the first channel 52, the anchoring clip 102 may be slid laterally along the first channel 52 to a desired location along the perimeter P of the frame 16. This allows for quick re-adjustment of a position of the anchoring clip 102 along the frame 16 without needing to remove the anchoring clip 102 from engagement with the frame 16. Additionally, the frame 16 does not require having a pre-set lateral position to align the anchoring clips 102 with during installation (e.g., the frame 16 does not have lateral markers or holes that the anchoring clip 102 is required to align with). As such, the position of the anchoring clip 102 along the frame 16 is flexible and adjustable before and during installation of the fenestration unit 10. Although this functionality is described with respect to the anchoring clip 102, the coupling bracket 412 may have substantially similar functionality.

Advantageously, in various implementations, no tools are needed for the foregoing steps. In other words, the removal, reversal, re-insertion, and coupling/assembly of the anchoring clips 102 can be accomplished by hand. As described above, non-penetrating and/or non-drilled fasteners (e.g., cam 56a, 56b) may be actuated by hand, or with the use of tools such as a screwdriver. Similarly, the non-penetrating features (e.g., hook 104) may be loaded into the first channel 52 without the use of tools. If it is desired to remove the coupling brackets 112, 212 or 312 from the carrier bracket 110 after the catches 150 have engaged the detents 174, a user may lift the catches 150 from the detents 174 using the release handle 144 (e.g., using by hand and/or by using a tool such as a screwdriver as previously described) and the coupling brackets 112, 212, or 312 may then be withdrawn. Further, the anchoring clip 102 may be coupled to the perimeter P of the frame 16 at any location along the perimeter P of the frame 16 without having a specified pre-set installation location (e.g., in the absence of pre-set holes or apertures dictating the installation location). This allows for flexible positioning of the anchoring clip 102 and/or coupling bracket 412. Additionally, the anchoring clips 102 may be adjusted after coupling to the perimeter P of the frame 16 (e.g., slid along a length of the frame 16 after engaging the hook 104) or may be re-moved and re-aligned with the frame 16 without penetrating the frame 16 or creating holes within the frame 16.

The fenestration unit 10 is inserted or pushed into the rough opening (RO) from the interior side of the rough opening (RO), for example by a single installer or fewer installers than a traditional installation process. The ability and functionality to be installed from an interior side of the unit can be an important feature of the fenestration unit 10, as traditional fenestration installations require at least one installer on the exterior side of the rough opening (RO) and/or at least one installer on the interior side of the rough opening (RO).

In some embodiments, the fenestration unit 10 is inserted into the rough opening (RO) by first inserting a bottom of the fenestration unit 10 into the rough opening (RO) and then tilting the fenestration unit 10 back toward an exterior side of the rough opening (RO) such that the retention system exerts the retention force on the fenestration unit 10 to maintain positive engagement of the fenestration unit 10 with the framing of the rough opening (RO). The installation stabilizer system 500 permits insertion of the fenestration unit 10 within the rough opening (RO) in a first, interior-to-exterior direction at a first insertion force and resist extraction of the fenestration unit from the opening in a second, exterior-to-interior direction at a second extraction force, the second extraction force being substantially greater than the first insertion force. The method includes inserting the fenestration unit 10 within the rough opening (RO) in the first direction at a force that meets or exceeds the insertion force. The retainer 502 of the installation stabilizer system 300 may engage the header H of the framing of the rough opening (RO) such that a noise is produced providing a clear, audible cue to the installer that the retainer 502 is properly engaged. In some embodiments, both the retainer 502 and the anchoring clips 102 together provide an audible cue to the installer that the fenestration unit 10 is engaged within the framing of the rough opening (RO) and properly seated within the rough opening (RO).

The fenestration unit 10 is pushed into the rough opening (RO) until the anchoring clips 102 engage the edges of the rough opening (RO), and specifically the jamb portions of the rough opening framing. The retention system 500 exerts a retention force on the fenestration unit 10 to maintain positive engagement of the fenestration unit 10 with framing of the rough opening (RO) upon insertion of the fenestration unit 10 in the rough opening (RO). The retention system exerts this retention force without use of fasteners securing the fenestration unit 10 to the rough opening framing. The anchoring clips 102 act as an engagement system that is positively engaged with the interior face of the rough opening framing from the interior side of the rough opening (RO) without the use of fasteners and the retention system 500 operates to maintain positive engagement of the engagement system with the rough opening framing upon insertion therein. The anchoring clips 102 are configured to prevent the fenestration unit 10 from falling toward the exterior side of the rough opening (RO).

The fenestration unit 10 is then centered in the rough opening (RO). The fenestration unit 10 may be centered side-to-side by inserting a screwdriver having a standard head (e.g., ¼-inch-thick head) and rotating the screwdriver to ensure a minimum desired gap is achieved at the first and second jambs 25, 27. To begin the shimming/levelling processes, a level is used to check the horizontal level of the fenestration unit 10. Then, one or more shims may be applied to any of the first shim guide 704, the second shim guide 706, and/or the third shim guide 750 as needed to achieve a desired level. Once a desired levelling and spacing is achieved screws may optionally be driven through the shims and the respective shim guide (e.g., one or more of the first, second, and third shim guides 706, 708, 750).

Once a desired levelling and spacing is achieved at the lower rail 48 portion of the fenestration unit 10, fasteners (e.g., screws or nails) are driven through the anchoring clips 102 (e.g., through the fastener apertures 180 and into the rough opening framing. The fenestration unit 10 can then continue to be plumbed, squared, and fully coupled to the framing of the rough opening (RO). For example, a user may plumb one of the first jamb 25 and the second jamb 27 to vertical level. In some embodiments, an installer may use an air bag designed for such a purpose that can be inflated to adjust the gap between the first and second jambs 25, 27 and the rough opening framing, and thus vertical level thereof, or other suitable methods may be implemented as desired. Once plumbed to be vertically level, the remaining anchoring clips 102 are fastened to the rough opening framing until all anchoring clips 102 are attached to the rough opening framing using one or more fasteners such that the fenestration unit 10 is structurally secured to the rough opening (RO).

In some embodiments, the installer adjusts the shim guide system 500 to engage the framing (jamb portions) of the rough opening (RO). The deploying or adjusting of the shim guide system 500 may be carried out to help ensure that any torsional forces on the frame 16 (e.g., during high winds, such as those encountered in a hurricane) do not twist or deform the frame 16 to the point of failure during such an event. In various examples, the adjustment of the shim guide system 700 (e.g., shimming or otherwise engaging the rough opening (RO)) using the shim guides 706, 708, 750 (such as those shown in FIGS. 54-55) proceeds from the exterior side of the fenestration unit 10. Access and adjustment from an exterior side may be facilitated as the shim guides 706, 708, 750 may be located toward the exterior side 14 of the fenestration unit 10. Although exterior installation of the shims and/or access to the rough opening frame head, depending on design, may be facilitated by an exterior approach, the installer may access from either side of the fenestration unit 10 (interior and/or exterior) according to various embodiments.

The installer may apply an air sealant (e.g., spray foam or other air seal material) around the outer perimeter P of the fenestration unit 10 in the gap between the rough opening (RO) framing and the fenestration unit 10 to create an interior air seal. This interior air seal may be continuous and substantially, or entirely, uninterrupted. An interior air seal typically is necessary for proper water management. This sealing operation is typically carried out from an interior side of the rough opening (RO). Notably, the sealant may be applied before, or after the exterior water barrier steps described below in association with the weather seal system 600.

In contrast to other methods and systems, at this point the fenestration unit 10 is entirely squared, plumbed, and securely fastened in the rough opening (RO) all from the interior side of the rough opening (RO). This can be accomplished by a single installer, rather than requiring two installers. At that time, or a later time as desired, the same installer, or another installer, may proceed to the exterior side of the rough opening (RO) to finish exterior water barrier installation for the fenestration unit 10 in the rough opening (RO). This is to be contrasted with traditional, nailing fin installations which require a second installer to be present on the exterior side of the rough opening (RO) during installation of the fenestration unit 10.

Forming an exterior water barrier for the installation unit 10 includes removing the retaining clips 680 such that the plurality of fins 620 transition from the stowed state to a radial outwardly projecting installation, or deployed configuration. In various operations, in order to ensure proper deployment of the plurality of fins 620 the first and second jamb retaining clips 680b, 680c are removed first followed by the head retaining clip 680a. This ordering can help ensure the proper overlapping of the plurality of fins 680 and the first and second corner bridge seals 630, 632.

As discussed above, removing the retaining clips 680 may also allow the corner bridge seals, such as first corner bridge seal 630 and/or second corner bridge seal 632, to be deployed to the unfolded, deployed configuration. The first corner bridge seal 630 may be transitioned from the folded, stowed configured (e.g., as shown in FIG. 44A) to the unfolded, deployed configuration (e.g., as shown in FIG. 44C). The first corner bridge seal 630 may project substantially outwardly relative to the frame 16 when transitioned from the folded, stowed to the unfolded, deployed configurations. As described above with respect to FIG. 42, one or more of the corner bridge seals 630, 632 may act as a single member or unit with the fins 620 (e.g., head fin 620a), such that when the fins 620 are deployed, the corner bridge seals 630, 632 are also deployed. Once deployed, additional processing or conditioning for folding, unfolding, and deployment (e.g., stretching, or other manipulation of a shape of the first corner bridge seal 630 and/or second corner bridge seal 632 to facilitate deployment of the fin assembly 610) may not be necessary.

Generally, no fasteners are used with the plurality of fins 620, which can be contrasted to traditional nailing fins. Though such fasteners (e.g., screws or nails) are not present in various examples, it is contemplated that such fasteners could be implemented in other embodiments. Regardless, installation proceeds by using flashing tape or another suitable flashing material to flash over the first and second jamb fins 620b, 620c, then the head fin 620a. Generally, weather resistant barrier (e.g., Tyvek® home wrap available from DuPont de Nemours, Inc.) will be present on the exterior wall of a building and will be cut with two 45-degree cuts at the rough opening head corners and folded vertically against itself. Once the first and second jamb fins 620b, 620c and the head fin 620a have been flashed, the weather resistant barrier can be folded back down over the head fin 620a and flashing (e.g., flashing tape) can be applied across the 45-degree cuts at the corners.

Various advantages may be achieved according to the foregoing example systems and methods. The various examples may be one or more of: more efficient (e.g., cycle time reduced by 50% or more); easier to learn; easier to remember; easier to train; may be less physically demanding (e.g., fenestration unit 10 is not set from the exterior side which could be on uneven ground or require a ladder); fenestration unit 10 is unable to fall out toward exterior during installation; can be installed by a single person from the interior of the building structure; interior and exterior installation tasks do not need to be done simultaneously; improved fenestration unit 10 install quality and fenestration unit 10 performance following installation; delivers an installation method that is unique to the industry and offers many benefits for the installer; faster cycle times; improved performance (water and air infiltration); adapts to wall depth variation; simplifies casing installation for finish carpenters; separates interior and exterior work so they can be done “independently”.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A fenestration unit having an interior side and an exterior side that is configured for installation in an opening in a structure defined by a rough opening framing, the fenestration unit comprising:
a frame having a perimeter including a first jamb, a second jamb, a frame head, and a lower rail, the frame head defining a first channel along a length of the frame head; and
at least one anchoring clip including a first anchoring clip coupled to the perimeter of the frame at the first channel, the first anchoring clip including,
a coupling bracket having a first leg and a second leg, and
a carrier bracket configured to receive a portion of the first leg, the coupling bracket defining at least one non-penetrating feature configured to be received by the first channel to couple the first anchoring clip to the perimeter of the frame.

2. The fenestration unit of claim 1, wherein the at least one non-penetrating feature is a hook, and optionally the hook includes a first hook and a second hook defined on opposing sides of the carrier bracket, and optionally the hook includes a curved end configured to be received within the first channel.

3. The fenestration unit of claim 1, wherein the first leg and the second leg extend at an angle to one another and, optionally, substantially orthogonal to one another.

4. The fenestration unit of claim 1, wherein the frame head defines a second channel along the length of the frame head and the first anchoring clip is configured to receive one or more fasteners to couple the first anchoring clip to the frame at the second channel.

5. The fenestration unit of claim 4, wherein the second channel is defined by a thermal break formed of a lower thermal conductivity material that is positioned between adjacent frame pieces formed of a relatively higher thermal conductivity material.

6. The fenestration unit of claim 4, wherein the thermal break defines a body, and the body defines a receiving pocket to engage a portion of the one or more fasteners.

7. The fenestration unit of claim 4, wherein the one or more fasteners includes a non-penetrating fastener, optionally including a pivotable interlocking cam.

8. The fenestration unit of claim 1, wherein the first anchoring clip is transitionable between a stowed configuration and an installation configuration, wherein in the installation configuration the second leg extends outwardly from the perimeter of the frame to engage the rough opening framing.

9. The fenestration unit of claim 8, wherein the second leg includes at least one aperture configured to receive a fastener for securing the second leg to the rough opening framing when the first anchoring clip is in the installation configuration.

10. The fenestration unit of claim 9, wherein the second leg is configured to be coupled to an interior face of the rough opening framing.

11. The fenestration unit of claim 8, wherein the first anchoring clip is configured to be gauged to a wall depth of the rough opening framing that is one of a 2×4 wall depth, a 2×6 wall depth, or a 2×8 wall depth.

12. The fenestration unit of claim 1, wherein the fenestration unit includes one of a sliding door, a bi-fold door, and a multi-slide door.

13. A fenestration unit having an interior side and an exterior side that is configured for installation in an opening in a structure defined by a rough opening framing, the fenestration unit comprising:
a frame having a perimeter including a first jamb, a second jamb, a frame head, and a lower rail, the frame head defining a first accessory groove along a length of the frame head; and
at least one anchoring clip including a coupling bracket, the coupling bracket including,
a first leg defining a hook, wherein the hook is configured to be received by the first accessory groove to couple the coupling bracket to the perimeter of the frame, and
a second leg angularly offset from the first leg and configured to engage the rough opening framing.

14. The fenestration unit of claim 13, wherein the frame defines a second accessory groove along the length of the frame head and the coupling bracket is configured to receive one or more fasteners to couple the coupling bracket to the frame at the second accessory groove.

15. The fenestration unit of claim 14, wherein the coupling bracket defines a first aperture, the first aperture having a first end, a second end, and a relatively wide portion therebetween, and the one or more fasteners is configured to be received within the first aperture.

16. The fenestration unit of claim 14, wherein the second accessory groove is defined by a thermal break.

17. The fenestration unit of claim 16, wherein the thermal break defines a body, and the body defines a receiving pocket to cover a portion of the one or more fasteners from view through a glazing of the fenestration unit.

18. The fenestration unit of claim 17, wherein the frame defines a third accessory groove along the length of the frame head, wherein the coupling bracket defines one or more catches that are configured to be received within a portion of the third accessory groove.

19. A method of installing an anchoring clip onto a fenestration unit having a frame defining a perimeter and including at least a frame head, the method comprising:
engaging a hook of an anchoring clip with a first accessory groove of a frame of the fenestration unit, wherein the first accessory groove is defined along a length of the frame head;
pivoting the anchoring clip downward toward the perimeter of the frame in a cantilever action such that one or more catches of the anchoring clip engage a third accessory groove of the frame, wherein the third accessory groove is defined along the length of the frame head;
aligning a first aperture of the anchoring clip with a second accessory groove, wherein the second accessory groove is defined along the length of the frame head; and
coupling the anchoring clip to frame at the second accessory groove via one or more fasteners.

20. A method of installing an anchoring clip onto a fenestration unit having a frame including at least a frame head, the method comprising:
engaging a hook of an anchoring clip with a first accessory groove of a frame of the fenestration unit, wherein the first accessory groove is defined along a length of the frame head;
pivoting the anchoring clip downward toward the perimeter of the frame in a cantilever action such that one or more fastener apertures defined by the anchoring clips are aligned with a second accessory groove of the frame;
transitioning the anchoring clip to a locked configuration to couple the anchoring clip to the frame at the second accessory groove.
